(19) United States
(12) Patent Application Publication
(10) Pub. No.: US 2020/0210056 A1
(43) Pub. Date: Jul. 2, 2020

(54) TECHNIQUES TO CUSTOM DESIGN PRODUCTS

(71) Applicant: Covestro LLC, Pittsburgh, PA (US)

(72) Inventors: David D. Steppan, Gibsonia, PA (US); Angela M. Beck, Monongahela, PA (US); Timothy J. Pike, Bethel Park, PA (US); Edward P. Squiller, Bridgeville, PA (US); John P. Forsythe, Allison Park, PA (US); Kurt E. Best, Wexford, PA (US); Susan B. McVey, Houston, PA (US); James R. Charron, Pittsburgh, PA (US); Currie Crookston, Pittsburgh, PA (US); Andrew Stadler, Allison Park, PA (US)

(21) Appl. No.: 16/647,095

(22) PCT Filed: Sep. 18, 2018
(86) PCT No.: PCT/US2018/051430

§ 371 Date: Mar. 13, 2020

Related U.S. Application Data
(60) Provisional application No. 62/560,262, filed on Sep. 19, 2017.
(60) Provisional application No. 62/608,627, filed on Dec. 21, 2017.

(51) Int. Cl. G06F 3/0484; G06F 3/0482; G06T 11/20

(52) U.S. Cl. CPC G06F 3/04847; H04L 67/42; G06T 11/206; G06F 3/0482

(57) ABSTRACT

Disclosed are methods of producing a graphical depiction of a predicted value of a property of a material. In accordance with the method, a processing unit generates a plot defining a geometric shape and comprising a plurality of points arranged in a matrix, each of the points defining a value for at least two variables and a predicted value of a property of the material. A visual representation of the predicted value of the property of the material for at least some of the plurality of points in a range of indicia is displayed on an output device. The range of indicia represents a range of predicted values of the property. A pointer on the visual representation is displayed on the output device.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

This disclosure is generally related to a client-server based visualization mapping techniques. More particularly, this disclosure is related to a web based graphical user interface to enable users to custom-design product configurations tailored to their unique application needs.

### BACKGROUND

Client-server based graphical user interfaces can be configured to enable users to custom-design product configurations tailored to their unique application needs. A plot may be employed to define a design space for a variety of products to reduce development time and provide self-service formulation assistance.

A ternary plot, ternary graph, triangle plot, simplex plot, or Gibbs triangle is a barycentric plot on three variables which sum to a constant. It graphically depicts the ratios of the three variables as positions in an equilateral triangle. It is used in physical chemistry, petrology, mineralogy, metallurgy, and other physical sciences to show the compositions of systems composed of three species.

In a ternary plot, the proportions of the three variables a, b, and c must sum to some constant, K. Usually, this constant is represented as 1.0 or 100%. Because a+b+c=K for all substances being graphed, any one variable is not independent of the others, so only two variables must be known to find a sample's point on the graph: for instance, c must be equal to K−a−b. Because the three proportions cannot vary independently—there are only two degrees of freedom—it is possible to graph the combinations of all three variables in only two dimensions. Ternary plots can be used for materials with n>3 components. The ternary plot then represents the three components with each of the other n−3 components held at a fixed proportion.

Design of experiments techniques may be employed to design any task that aims to describe or explain the variation of information under conditions that are hypothesized to reflect the variation. In one form, an experiment aims at predicting the outcome by introducing a change of preconditions, which is reflected in a variable called the predictor (independent). The change in the predictor is generally hypothesized to result in a change in the second variable, hence called the outcome (dependent) variable. Experimental design involves not only the selection of suitable predictors and outcomes, but planning the delivery of the experiment under statistically optimal conditions, given the constraints of available resources.

In experimental design, the predictor may be chosen to reduce the risk of measurement error. The experimental design should achieve appropriate levels of statistical power and sensitivity.

### SUMMARY

In one aspect, the present disclosure provides a method of producing a graphical depiction of a predicted value of a property of a material. The method comprises generating, by a processing unit, a plot defining a geometric shape and comprising a plurality of points arranged in a matrix, each of the points defining a value for at least two variables and a predicted value of a property of the material; displaying, on an output device, a visual representation of the predicted value of the property of the material for at least some of the plurality of points in a range of indicia, wherein the range of indicia represents a range of predicted values of the property; and displaying, on the output device, a pointer on the visual representation.

In another aspect, the present disclosure provides a method of producing a graphical depiction of a predicted value of a property of a material. The method comprises generating, by a processing unit, a plot defining a triangle and comprising a plurality of points arranged in a matrix, each of the points defining a value for three variables and a predicted value of a property of the material; displaying, on an output device, a color heat map representation of the predicted value of the property of the material for at least some of the plurality of points in a range of colors, wherein the range of colors represents a range of predicted values of the property; and displaying, on the output device, a pointer on the heat map.

In another aspect, the present disclosure provides a method of producing a graphical depiction of a predicted value of a property of a material. The method comprises generating, by a processing unit, a plot defining a four-sided polygon and comprising a plurality of points arranged in a matrix, each of the points defining a value for at least two variables and a predicted value of the property of the material; displaying, on an output device, a color heat map representation of the predicted value of the property of the material for at least some of the plurality of points in a range of colors, wherein the range of colors represents a range of predicted values of the property; and displaying, on the output device, a pointer on the heat map.

In some aspects, a digital formulation service is provided for generating optimized material configurations, both in types of materials and cost. A computerized system may be configured to provide a digital formulation service module that allows a user to generate a custom material configuration based on a specified constraint, such as cost or performance. The digital formulation service may provide a recommended material configuration that satisfies the specified constraint. The digital formulation service module may be an augmented or supplemental service with the other user interfaces described herein.

### FIGURES

FIG. 1 is a graphical depiction of a ternary plot axis A according to one aspect of this disclosure.

FIG. 2 is a graphical depiction of a ternary plot axis B according to one aspect of this disclosure.

FIG. 3 is a graphical depiction of a ternary plot axis C according to one aspect of this disclosure.

FIG. 4 is a graphical depiction of a final ternary plot according to one aspect of this disclosure.

FIG. 5 is a graphical depiction of a ternary map page according to one aspect of this disclosure.

FIG. 6 is a graphical depiction of a ternary plot for a property showing a cursor located over a selected pointer on the provided heat map according to one aspect of this disclosure.

FIG. 7 is an example display of a mixture selection slider bar and a color scheme drop down menu according to one aspect of this disclosure.

FIG. 8 is an example display of a current selection table showing the current formulation details according to one aspect of this disclosure.

FIG. 9 is a graphical depiction of ternary plot for a property showing a display of a popup window on hover property according to one aspect of this disclosure.

FIG. 10 is an example display of a property optimization graphical user interface (GUI) window chart according to one aspect of this disclosure.

FIG. 11 is a graphical depiction of an optimization property of a ternary plot according to one aspect of this disclosure.

FIG. 12 is an example display of a multiple property optimization chart according to one aspect of this disclosure.

FIG. 13 is a graphical depiction of a ternary map graphical user interface (GUI) showing optimized ternary plots for one or more properties according to one aspect of this disclosure.

FIG. 14 is a graphical depiction of ternary plots showing the relationship between current selection table and the location of pointers in heat map regions of the ternary plots according to one aspect of this disclosure.

FIG. 15 is a graphical depiction of the ternary plots shown in FIG. 14 showing the relationship between current selection table and the location of pointers in heat map regions of the ternary plots according to one aspect of this disclosure.

FIG. 16 is an example display of a stored selection table showing stored formulations according to one aspect of this disclosure.

FIG. 17 is an example display of a stored selection table showing a starting point guide formulation link according to one aspect of this disclosure.

FIG. 18 is an example display of a starting point guide formulation according to one aspect of this disclosure.

FIG. 19 is a graphical depiction of a square map graphical user interface (GUI) page according to one aspect of this disclosure.

FIG. 20 is a color scheme selection graphical user interface (GUI) window that includes a color scheme bar and dropdown menu according to one aspect of this disclosure.

FIG. 21 is a graphical depiction of the square plot shown in FIG. 19 for a property showing a cursor located over a selected pointer on the provided heat map according to one aspect of this disclosure.

FIG. 22 is an example graphical depiction of three variable selection and slider bar GUIs to select variables and enable level adjustments for various processing variables according to one aspect of the present disclosure.

FIG. 23 is an example graphical depiction of a popup bar that provides instructions for clicking to change a variable level coinciding with the location of the cursor according to one aspect of this disclosure.

FIG. 24 shows a manual entry dialog box graphical user interface (GUI) window to enable entry of the level into a manual input box and then clicking on the “OK” button according to one aspect of this disclosure.

FIG. 25 is an example display of a “Current Selection” table showing the current predicted values of properties and a base cost according to one aspect of this disclosure.

FIG. 26 is an example display of a “Current Recipe” table showing a rudimentary formulation based on the current properties selected according to one aspect of this disclosure.

FIG. 27 is a graphical depiction of square plot for a property showing a display of a popup window on hover property according to one aspect of this disclosure.

FIG. 28 is an example display of a single property optimization graphical user interface (GUI) window according to one aspect of this disclosure.

FIG. 29 is a graphical depiction of an optimization property of a square plot according to one aspect of this disclosure.

FIG. 30 is an example display of a multiple property optimization graphical user interface (GUI) window according to one aspect of this disclosure.

FIG. 31 is a graphical depiction of four square plots showing optimized regions according to one aspect of this disclosure.

FIG. 32 is a graphical depiction of square plots showing cell highlight within an optimized region according to one aspect of this disclosure.

FIG. 33 is a graphical depiction of square plots showing cell highlight outside of an optimized region according to one aspect of this disclosure.

FIG. 34 is a graphical depiction of square plot showing the base cost at one end of a gridded region according to one aspect of the present disclosure.

FIG. 35 is a graphical depiction of square plot showing the base cost at another end of the gridded region shown in FIG. 34 according to one aspect of the present disclosure.

FIG. 36 is a graphical depiction of a cost table graphical user interface (GUI) window according to one aspect of this disclosure.

FIG. 37 is an example display of a stored formulations table according to one aspect of this disclosure.

FIG. 38 is a graphical depiction of a two-dimensional perspective projection of a three-dimensional pyramid-like map according to one aspect of this disclosure.

FIG. 39 is a graphical depiction of a two-dimensional perspective projection of a three-dimensional cube-like map made of individual smaller cubes according to one aspect of this disclosure.

FIG. 40 illustrates an example computing environment wherein one or more of the provisions set forth herein may be implemented.

FIG. 41 is a logic flow diagram of a logic configuration or process of a method of producing a graphical depiction of a predicted value of a property of a material according to one aspect of this disclosure.

FIG. 42 is a logic flow diagram of a logic configuration or process of a method of producing a graphical depiction of a predicted value of a property of a material according to one aspect of this disclosure.

FIG. 43 is a logic flow diagram of a logic configuration or process 2000 of a method of producing a graphical depiction of a predicted value of a property of a material according to one aspect of this disclosure.

FIG. 44 shows a basic block diagram of a user or customer interfacing with the digital formulation service, which may be manifested in a computerized module.

FIG. 45 shows one model for how the digital formulation service may complete a custom coating order, according to some aspects.

FIG. 46 shows a second model in a variation of how the digital formulation service may complete a custom coating order, according to some aspects.

FIG. 47 shows another model in another variation of how the digital formulation service may complete a custom coating order, according to some aspects.

FIG. 48 shows how after generating a recommended material configuration that satisfies the user specified constraint(s), the digital formulation service module may be configured to interface with one or more purchasing/trade platforms that supply the ingredients needed to generate the recommended formulation, according to some aspects.

FIG. 49 shows a block diagram for the purchase mechanisms that can be extended to include convenient and more streamlined features that can automatically connect to appropriate suppliers.

### DESCRIPTION

In one aspect, the present disclosure is directed to a client-server based visualization mapping techniques that employs graphical user interfaces configured to enable users to custom-design product configurations tailored to their unique application needs. A plot may be employed to define a design space for a variety of products to reduce development time and provide self-service formulation assistance. The plot may be incorporated in a graphical user interface on a client that runs a web server in a cloud based system. Conventional techniques for determining a property of a material requires making the material based on known components and then determining the actual property of the material. If the measured property is not the desired property, a new material is formulated and the new resulting property is tested. This trial-and-error technique is time consuming, expensive, and may never lead to the desired material property due to the large number of combinations of components that can be combined to achieve a large number of material properties. It would be desirable to be able to precisely predict a material property for a large number of combinations of components and to provide immediate real-time feedback to a user of a predicted material property based on a particular combination of components. It also would be desirable to quickly update the ratios of components on a graphical user interface and provide immediate real-time feedback to the user of the new predicted material property. The disclosed client-server based visualization mapping techniques enable a user to design materials using known components, e.g., polymers, based on desired performance properties of the material that are of interest to the user. The disclosed client-server based visualization mapping techniques enable such designs by generating a plot defining a geometric shape and comprising a plurality of points arranged in a matrix, where each of the points define a value for at least two variables and a predicted value of a property of the material. The underlying plot is generated based on experimental data or data generated by computer models. A visual representation of the predicted value of the property of the material is displayed for at least some of the points in a range of indicia, where the range of indicia represents a range of predicted values of the property. A pointer positioned on the visual representation can be displayed on the output device to enable the user to visually perceive the material properties. The user may move or drag the pointer over the plot to dynamically update the material properties and dynamically updates the visual representation of the predicted value of the property.

Before describing various aspects of client-server based visualization mapping techniques, the disclosure turns briefly to a description of the design of experiment technique that may be used to build a database of data used to generate ternary maps to enable users to custom-design various products by manipulating the ratios of the three variables as positions in an equilateral triangle and providing a graphical depiction of the results on a screen or display of a computer, tablet, smartphone, or other web based client appliance. In one aspect, a statistical software application known under the trade name of Design-Expert from Stat-Ease Inc. may be employed to create and analyze a design of experiments to generate model equations that drive the ternary maps of a ternary map interface according to the present disclosure. Other statistical software applications for generating and analyzing a design of experiments include, for example, statistical software applications known under the trade name ECHIP, JMP, and Minitab.

It will be appreciated that there are many considerations when creating, executing, and analyzing a design of experiments. The methodology used to create the ternary map described herein provide an example of one way in which experimental data can be used to drive an interactive, graphical interface. In one aspect, computer generated data may be employed to drive the ternary map interface in accordance with the present disclosure. In other aspects, real measurement data may be employed to drive the ternary map interface. In yet another aspect, real measurement data may be employed to drive the ternary map interface and computer generated data may be employed to fill in any gaps in the real measurement data.

In one formulation generation example, a polyurethane coating, comprising an A and B side, is analyzed. The system is evaluated using a two-mixture design, with one mixture (Mixture 1) based on the relative amounts of three components and the other mixture (Mixture 2) based on the relative amounts of two components. A design of experiments formulation data set can be created using the DesignExpert software application. Upon specifying the design space and generating a set of formulations, the coatings are prepared and cured on appropriate test substrates. Each property is then measured and recorded in a Design-Expert data table. The formulation data set can be stored in a database.

Once the data has been accumulated, it can be analyzed to develop model equations. There are a variety of approaches to selecting the terms for the final model, for example, a threshold p-value can be chosen, an information criterion statistic can be minimized (such as the Corrected Aikake's Information Criterion or the Bayesian Information Criterion), or another statistic can be optimized, such as R-square adjusted or Mallow's Cp. Additionally, a validation set of points may be withheld from the model building process, with the final model chosen as the best fit (again, a variety of criteria can be used to determine best fit) of the validation set. These approaches can be performed in a stepwise approach with Forward selection, that is starting with a model with no terms and stepwise adding one at a time, Backward selection, starting with the full model and reducing terms one by one, or one that mixes Forward and Backward selection. The addition and reduction of terms is stopped when the chosen criteria is met. Commercially available statistical software packages support these, as well as other, approaches.

In one example, computer generated data may be employed as input to a model as an independent variable to generate dependent variables, e.g., responses. For each response, the significant model terms may be identified by starting with a full quadratic model and performing a backwards stepwise elimination with minimization of the Bayesian Information Criterion (BIC) as the stopping rule. Standard least squares regression can then be used to determine the coefficients of the significant model terms for the final model equation. The following process demonstrates at a high level the use of this approach for the first response, “Property 1,” in the Design-Expert software application.

Typical independent variables include amount of recipe components in weight or weight percent. Calculations derived from the recipe such as volume percent filler and total catalyst weight also are common. The derived quantities can be based on molar quantities as well such as moles of blowing agent gas per weight of reactive materials and the overall stoichiometric balance between reactive species. Other derived quantities can be based on chemical characteristics such as moles of benzene rings per weight of reactive material. Other calculated normalizations are valid as well, moles of tin (Sn) atoms per mole of reactive material in the recipe. These independent variables extend to processing variables, length of mixing time, cure time, cure temperature and reaction temperature to cite but a few. These independent variables can be controlled or uncontrolled. Barometric pressure and relative humidity are common uncontrolled variable examples. Any of these variables may be transformed, for example, a log or reciprocal transformation, before building and analyzing a designed set of experiments.

A “Property 1” response is selected under the analysis tree. An initial model is chosen and a response fit summary is selected. Model reduction may be done manually or using an automated method. If an auto-select model is selected, model selection criteria are entered into the automatic model selection window. Upon completion of the above process, the selected design of experiments model is accepted and the analysis of variance (ANOVA), a statistical method in which the variation in a set of observations is divided into distinct components, is selected. The application (such as the Design-Expert application) then performs an R-Squared analysis and provides the user an opportunity to review the R-Squared analysis, adjust the R-Squared, and predetermine the R-Squared values to ensure the values are within the range desired for the response being evaluated. The application (such as the Design-Expert application) calculates a variety of statistics to assess the fit of the selected model to the data, including, for example, R-Squared, Adjusted R-Squared, Predicted R-Squared, standard deviation, and PRESS (Predicted Residual Error Sum of Squares). In addition, the application provides a Diagnostics section, where the validity of the ANOVA assumptions can be evaluated, the data can be examined for outliers from the model and other such important model building concerns can be gauged. Finally, the model graphical depictions may be selected and the final equation in terms of real components may be evaluated. The final equation may be employed to populate a data table for the ternary map interface for all properties.

A model for generating predictive values of properties of materials includes, without limitation, design of experiments, regression analysis of a data set, an equation, machine learning, or artificial intelligence, and/or any combination thereof. In one aspect, the model used to generate the predicted values of the properties of a material for a ternary plot is generated from a design of experiment technique. In other aspects, models for generating predictive values of properties include a statistical analysis of unstructured data, such as that generated by a historian of a distributive control system of a chemical manufacturing plant. For example, models of the dependence of polydimethylsiloxane (PDMS) modified polyolefin (PMPO) viscosity on solids content and other variables that are reasonably accurate within small ranges may be generated from such unstructured data. In other aspects, artificial intelligence methods may be employed to mine a large number of experimental systems in a company's lab notebook system and research papers. In other aspects, an analytical model may be generated based on scientific first principles. For example, a graphical user interface (GUI) may be configured to display pressure at a given volume and temperature of mixtures of multiple gases, predicted by a non-ideal gas law, for example.

Various material properties are tabulated in Table 1 below. As described herein, graphical depictions of ternary and square maps, among others, can be used to design products having a particular material property, short or long, as described in Table 1. Properties include, without limitation, properties often associated with coatings, such as Soft Feel, 5 Finger Scratch Resistance, Diethyltoluamide (DEET) Solvent Resistance, Coefficient of Friction, and properties often associated with polyurethane foams, such as flexible polyurethane foams, such as Density, Indentation Force Deflection 25%, Indentation Force Deflection 40%, Indentation Force Deflection 65%, Tensile Strength, Elongation, Tear Strength, Maximum Temperature, Compression Strength 90%, Humid Age Compression Set 75%, Fatigue Loss, among others, for example.

TABLE 1
Material Properties

| Interface | Property (short) | Property (long) | Units | Min | Max |
|---|---|---|---|---|---|
| Ternary | Soft Feel | Soft Feel | N/A | 0.25 | 4.4 |
| Map | 5 Finger Scratch | 5 Finger Scratch | N/A | 0.73 | 6 |
| | Resistance | Resistance | | | |
| | Diethyltoluamide | Diethyltoluamide | N/A | 1.8 | 4.9 |
| | (DEET) | (DEET) | | | |
| | Solvent Resistance | Solvent Resistance | | | |
| | Coefficient of | Coefficient of | N/A | 2 | 5.5 |
| | Friction | Friction | | | |
| Square | Density | Density | pcf | 0.8 | 6 |
| Map | Indentation Force | Indentation Force | Lbs/50 | 5 | 200 |
| | Deflection 25% | Deflection 25% | in² | | |
| | Indentation Force | Indentation Force | lbs/50 | 10 | 300 |
| | Deflection 40% | Deflection 40% | in² | | |
| | Indentation Force | Indentation Force | lbs/50 | 10 | 450 |
| | Deflection 65% | Deflection 65% | in² | | |
| | Tensile Strength | Tensile Strength | psi | 0 | 40 |
| | Elongation | Elongation | % | 40 | 350 |
| | Tear Strength | Tear Strength | pli | 0 | 4 |
| | Maximum | Maximum | deg F. | 200 | 400 |
| | Temperature | Temperature | | | |
| | Compression Set, | Compression Set, | % | 0 | 95 |
| | 90% | 90% | | | |
| | Humid Age | Humid Age | % | 0 | 95 |
| | Compression | Compression | | | |
| | Set 75% | Set 75% | | | |
| | Fatigue Loss | Fatigue Loss | % | 0 | 75 |

Generally, in one aspect, the present disclosure provides a method of producing a graphical depiction of a predicted value of a property of a material. The method includes generating, by a processing unit, a plot defining a geometric shape and comprising a plurality of points arranged in a matrix, each of the points defining a value for at least two variables and a predicted value of a property of the material. The method includes displaying, on an output device, a visual representation of the predicted value of the property of the material for at least some of the plurality of points in a range of indicia, wherein the range of indicia represents a range of predicted values of the property. At least some of the plurality of points in a range of indicia means at least two of the plurality of points up to and including each of the plurality of points in a range of indicia, such as a majority of the plurality of points. The method further includes displaying, on the output device, a pointer on the visual representation. At least one of the at least two variables may be an independent variable. The visual representation may be a heat map, a color heat map, or a contour map. The material may be a foam, a coating, an adhesive, a sealant, an elastomer, a sheet, a film, a binder, or any organic polymer, for example.

In one aspect, the method includes displaying, on the output device, the value of the indicia and property of the material based on a position of a cursor on the visual representation. In one aspect, the method includes dynamically updating the location of the pointer and an element as the pointer is dragged over the visual representation. The element may include a numeric value or a descriptor of the property, for example. The element may include indicia within the range of indicia that represents the predicted value or the descriptor of the property in the visual representation, for example.

In one aspect, the geometric shape defines a closed shape in Euclidian space. The closed shape may define a polygon, for example. The polygon may be a triangle or a four-sided polygon, for example. In the case where the polygon is a triangle, each of the points may define a value for three variables, where each variable represents a value for an amount of a component in a composition, such as the relative amount of components in a composition to each other. The amounts may be expressed as a percentage and a sum of the amounts is 100%, for example. In the case where the polygon is a four-sided polygon, each of the points may define a value for two variables, where each variable is a value for an amount of a component in a composition, a value for a processing condition, or a value representing an amount of two components of the composition relative to each other. The closed shape may define an ellipse or a circle, for example. The closed shape may define either a two-dimensional space or a two-dimensional perspective projection of a three-dimensional shape, for example.

In another aspect, the method includes formulating, by the processing unit, a composition based on the visual representation of the predicted value of the property of the material for at least some of the plurality of points in the range of indicia. The composition may be formulated based on a plurality of properties for at least some of the plurality of points in the range of indicia, for example. The method may also include optimizing, by the processing unit, one or more than one property of the material within one or more than one defined range of indicia. A gridded region that represents one or more than one optimized region based on the one or more than one defined range of indicia may be displayed on the output device, for example.

In one aspect, the method includes updating, by the processing unit, a table with current values of the at least two variables and the predicted value of the property based on the location of the pointer on the visual representation. The method may also include generating, by the processing unit, a set of instructions for producing a product that exhibits the predicted value of the property of the material at one of the plurality of points in the range of indicia.

In one aspect, the method also includes generating, by the processing unit, a plurality of plots each defining a geometric shape and each including a plurality of points arranged in a matrix where each of the points defines a value for at least two variables and a predicted value of the property of the material for each of the plurality of plots. A visual representation of the predicted value of the property of the material for at least some of the plurality of points in a range of indicia may be displayed on the output device. The range of indicia may represent a range of predicted values of the property. A pointer may be displayed on each of the plurality of plots.

In one aspect, the method includes generating, by the processing unit, a plot based on a model. The model may be generated based on design of experiments, regression analysis of a data set, an equation, machine learning, or artificial intelligence, and/or any combination thereof.

In one aspect, the plot defines a triangle including a plurality of points arranged in a matrix where each of the points define a value for three variables and a predicted value of a property of the material. A color heat map representation of the predicted value of the property of the material for at least some of the plurality of points in a range of colors may be displayed on the output device. The range of colors may represent a range of predicted values of the property. A pointer may be displayed on the heat map.

In another aspect, the plot defines a four-sided polygon including a plurality of points arranged in a matrix where each of the points defines a value for at least two variables and a predicted value of the property of the material. A color heat map representation of the predicted value of the property of the material for at least some of the plurality of points in a range of colors may be displayed on the output device. The range of colors may represent a range of predicted values of the property. A pointer may be displayed on the heat map.

### Ternary Map Interface

In one aspect, the present disclosure provides a web based ternary map graphical user interface (GUI) that runs in any HTML5 compliant browser. The web based ternary map GUI may be created using web visualization software. Accordingly, the web based ternary map GUI can be used on modern cell phones, tablets, and personal computers. The interface may be accessed published to the cloud and may be made available to users via a website.

The ternary map GUI is a user-friendly interface that may be made available for self-service 24 hours per day and 7 days per week. All calculations conducted by the ternary map GUI are performed “behind” the face of the engine to protect the data used to build the models and to prevent the user from accidentally causing damage to the functionality of the ternary map GUI, as would be the case with a spreadsheet solution. The ternary map GUI user interface allows users to interact with the data table created by design of experiments techniques through graphical icons and visual indicators such as secondary notation, instead of text-based user interfaces, typed command labels or text navigation.

The ternary map GUI provides a fast, low cost solution to assist users in better understanding available products. The ternary map GUI requires unique username and password access to use. The structure of the ternary map GUI is universal, in that it can be customized to a user's wants and needs. Its dynamic nature allows the modeling of any type of product on the market.

### Reading a Ternary Plot

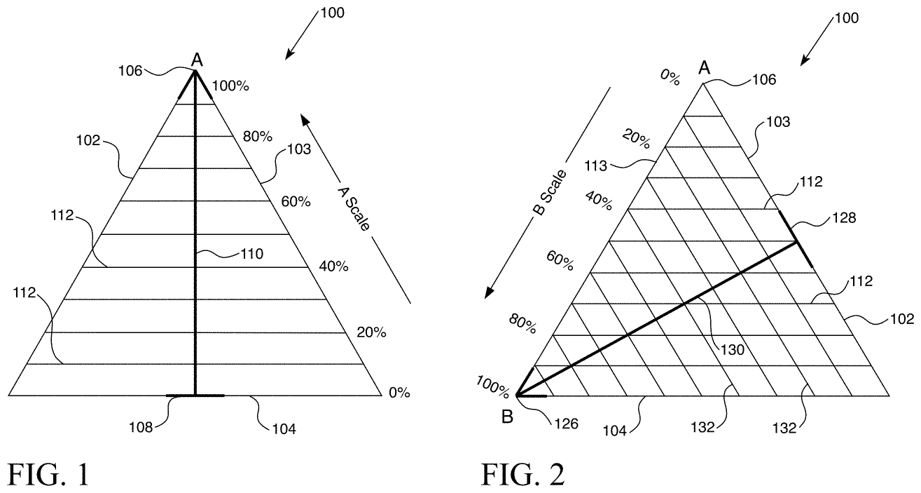

FIGS. 1-3 are graphical depictions of a ternary plot 100 according to one aspect of this disclosure. The ternary map GUI is made up of multiple ternary plots 100 that represent properties of interest. Before delving into the interface, it may be useful to review how ternary plots 100 are read. The ternary plots 100 generated by the ternary map GUI are triangles 102 with each vertex A, B, and C corresponding, for example, to a resin that may be included in a designed formulation. For conciseness and clarity of disclosure, the vertices within this section will be referred to as A, B, and C.

To understand the three axes of a ternary plot 100, each axis (A, B, and C) will be evaluated separately. As shown in FIG. 1, vertex A is located at the top 106 of the triangle 102 and its axis runs along the right edge 103 of the triangle 102, indicating the value, such as a percentage, of A and labeled as “A Scale.” The base 108 of the indicator arrow 110, farthest from vertex A, coincides with the bottom edge 104 of the triangle 102 and represents, in this example, an A value of 0%. The value of A is determined by the intersection of lines 112 drawn parallel to the bottom edge 104 and the right edge 103 of the ternary plot 100. The indicator arrow 110 shows the direction of increasing A.

As shown in FIG. 2, vertex B is the lower left corner 126 of the ternary plot 100, with, in this example, a percent scale running along the left edge 113 of the triangle 102. The percent scale is rotated 120 degrees counter clockwise relative to the ternary plot 100 shown in FIG. 1 and labeled “B Scale.” The base 128 of the indicator arrow 130, farthest from vertex B, coincides with the right edge 103 of the triangle 102 and represents, in this case, a B value of 0%. The right edge 103 of the triangle 102 represents a baseline for vertex B with a corresponding percent scale that runs along the left edge 113 of the triangle 102. As with A, the value of B is determined by the intersection of lines 132 drawn parallel to the right edge 103, which is the baseline for vertex B, and the left edge 113 of the triangle 102. The indicator arrow 130 shows the direction of increasing B.

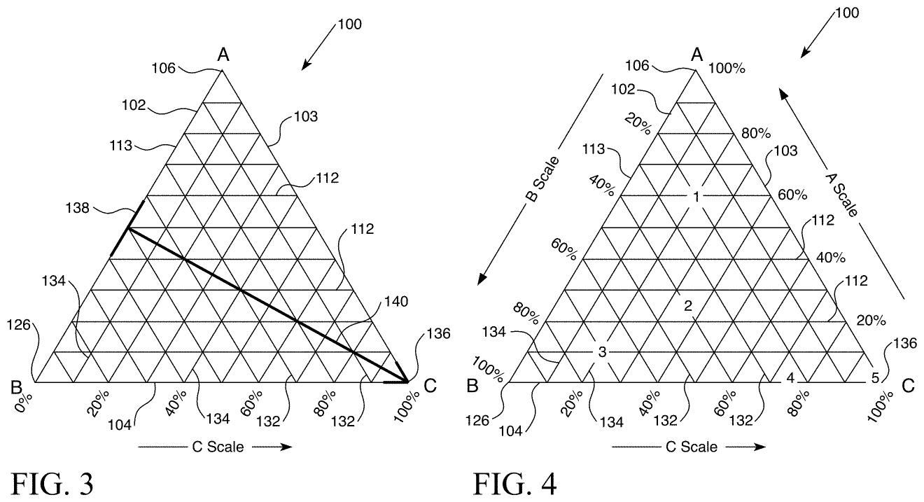

As shown in FIG. 3, vertex C is the lower right vertex 136 of the ternary plot 100, with a percent scale running along the baseline 104 rotated another 120 degrees counter clockwise relative to FIG. 2 and labeled “C Scale.” The left edge 113 of the triangle 102 represents the baseline for vertex C with a corresponding percent scale that runs along the bottom edge 104 of the triangle. The base 138 of the indicator arrow 140, farthest from vertex C, coincides with the left edge 113 of the triangle 102 and represents, in this case, a C value of 0%. As with A and B, C is determined by the intersection of lines 134 drawn parallel to the baseline 138 and the left edge 113 of the triangle 102. The indicator arrow 140 shows the direction of increasing C.

As shown in FIG. 4, combining all three axes and eliminating the indicator arrows, the resultant ternary plot 100 represents a three dimensional space. For illustration purposes, the quantity of the composition for each of the points 1-5 on the ternary plot 100 is shown in Table 2.

TABLE 2
Composition values for each point (1-5) by way of example.

| Point | A | B | C | Total |
|---|---|---|---|---|
| 1 | 60% | 20% | 20% | 100% |
| 2 | 25% | 40% | 35% | 100% |
| 3 | 10% | 70% | 20% | 100% |
| 4 | 0.0% | 25% | 75% | 100% |
| 5 | 0.0% | 0.0% | 100% | 100% |

As noted in Table 1, at any point located on the ternary plot 100, all three coordinates will total 100%. Additional information on ternary plots may be sourced from Reading a Ternary Diagram, Ternary plotting program, Power Point presentation from http://csmres.imu.edu/geollab/Fichter/SedRx/readternary.html, which is incorporated herein by reference.

### Ternary Map GUI Maps

In one aspect, a ternary map GUI may be accessed by way of a login page that serves as a gateway to accessing the ternary map GUI. Once a user has been granted access to utilize the ternary map GUI, he/she will enter the assigned username and password into the provided entry boxes. Once a user has signed in, the home screen provides a tab or other selectable item that the user may select to open a ternary map GUI. In one aspect, the ternary map GUI allows a user to design products using resins, or other products, based on properties of interest as discussed below.

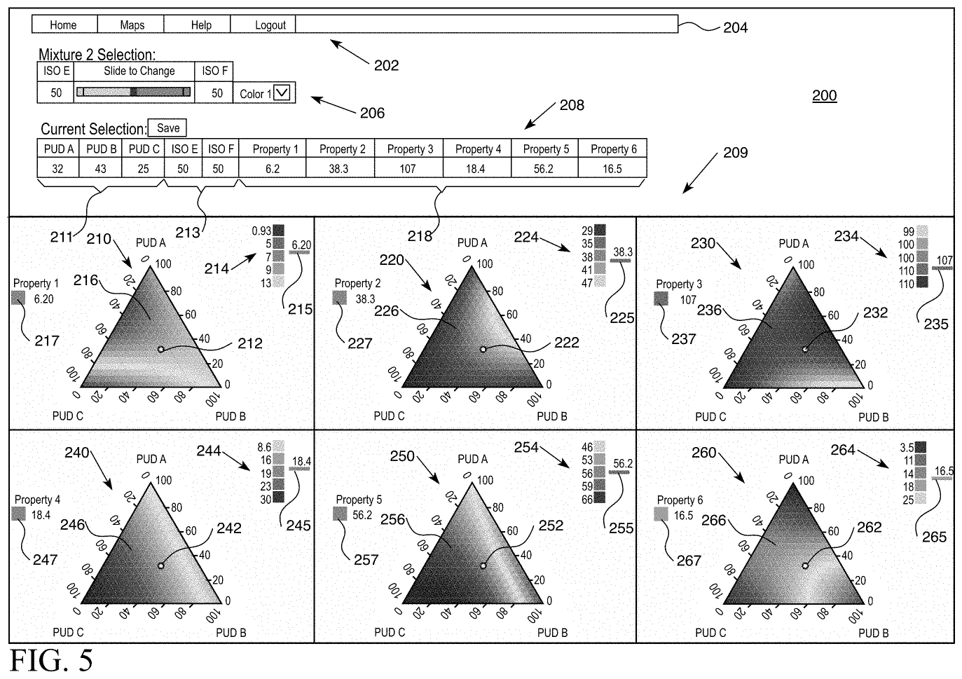

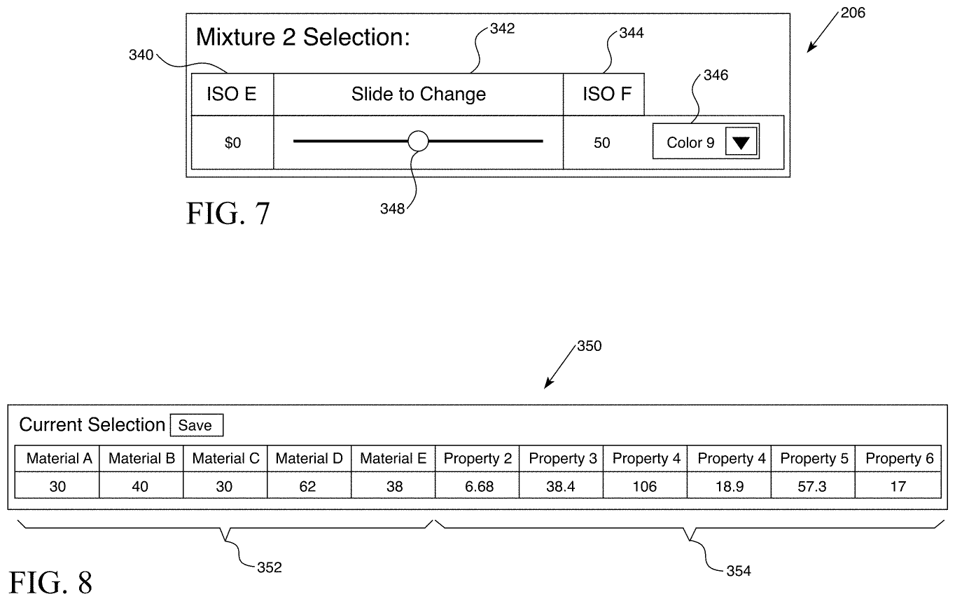

FIG. 5 is a graphical depiction of a ternary map GUI page 200 according to one aspect of this disclosure. The ternary map GUI page 200 includes a title bar 202 and a menu bar 204 that includes section tabs “Home,” “Maps,” “Help,” and “Logout,” for example. Below the menu bar 204, is a mixture 2 selection tool bar 206, which is described in more detail with reference to FIG. 7. Below the selection tool bar 206 is a current selection display table 208 that includes a first section 211 that includes the current selection values for PUD A, PUD B and PUD C, a second section 213 that includes the current selection values for isocyanate ISO E and ISO F, and a third section 218 that includes the current selection values for Property 1-Property 6, as discussed in more detail below. In this description, the acronym “PUD” refers to polyurethane dispersion and the acronym “ISO” refers to isocyanate. Polyurethane dispersions (PUDs) have recently been incorporated into a variety of products and offer several advantages over conventional technologies such as acrylics and acryl amide copolymers, polyvinyl pyrrolidone, and PVP/VA copolymers. Such advantages include water compatibility, ease of formulating low VOC sprays, water resistance and excellent film forming ability. Polyurethane dispersions (PUDs) and methods of making them may be found for example in Polyurethanes—Coatings, Adhesives and Sealants, Ulrich Meier-Westhues, Vincentz Network GmbH & Co., KG, Hannover, (2007), Ch. 3, the contents of which are incorporated herein by reference.

Polyurethane dispersions useful in the present disclosure contain: (A) at least one diol and/or polyol component (B) at least one di- and/or polyisocyanate component (C) at least one component including at least one hydrophilizing group (D) optionally mono-, di- and/or triamine-functional and/or hydroxylamine-functional compounds, and (E) optionally other isocyanate-reactive compounds.

Suitable diol- and/or polyol components (A) are compounds having at least two hydrogen atoms which are reactive with isocyanates and have an average molecular weight of preferably 62 to 18000 and particularly preferably 62 to 4000 g/mol. Examples of suitable structural components include polyethers, polyesters, polycarbonates, polylactones and polyamides. Preferred polyols (A) preferably have 2 to 4, particularly preferably 2 to 3 hydroxyl groups, and most particularly preferably 2 hydroxyl groups. Mixtures of different such compounds are also possible.

Possible polyester polyols are in particular linear polyester diols or indeed weakly branched polyester polyols, as can be prepared from aliphatic, cycloaliphatic or aromatic di- or polycarboxylic acids, such as succinic, methylsuccinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic, cyclohexane dicarboxylic, maleic, fumaric, malonic or trimellitic acid and acid anhydrides, such as o-phthalic, trimellitic or succinic acid anhydride or mixtures thereof with polyhydric alcohols such as ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12 or mixtures thereof, optionally with the use of higher-functional polyols, such as trimethylol propane, glycerine or pentaerythritol. Cycloaliphatic and/or aromatic di- and polyhydroxyl compounds are also possible as the polyhydric alcohols for preparing the polyester polyols. Instead of free polycarboxylic acid, it is also possible to use the corresponding polycarboxylic acid anhydrides or corresponding polycarboxylic acid esters of low alcohols or mixtures thereof for preparing the polyesters.

The polyester polyols may be homopolymers or mixed polymers of lactones which are preferably obtained by the addition of lactones or lactone mixtures, such as butyrolactone, ε-caprolactone and/or methyl-ε-caprolactone, to suitable di- and/or higher-functional starter molecules, such as the low-molecular-weight polyhydric alcohols mentioned above as structural components for polyester polyols. The corresponding polymers of ε-caprolactone are preferred.

Polycarbonates having hydroxyl groups are also possible as the polyhydroxyl components (A), e.g. those which can be prepared by reacting diols such as 1,4-butanediol and/or 1,6-hexanediol with diaryl carbonates, such as diphenyl carbonate, dialkyl carbonates, such as dimethyl carbonate, or phosgene. As a result of the at least partial use of polycarbonates having hydroxyl groups, the resistance of the polyurethane dispersion to hydrolysis can be improved.

Suitable polyether polyols are for example the polyaddition products of styrene oxides, ethylene oxide, propylene oxide, tetrahydrofuran, butylene oxide, epichlorohydrine, and mixed addition and grafting products thereof, and the polyether polyols obtained from condensation of polyhydric alcohols or mixtures thereof and from alkoxylation of polyhydric alcohols, amines and amino alcohols. Polyether polyols which are suitable as structural components A) are the homopolymers, mixed polymers and graft polymers of propylene oxide and ethylene oxide which are obtainable by the addition of the said epoxies to low-molecular-weight diols or triols, such as those mentioned above as structural components for polyester polyols, or to higher-functional low-molecular-weight polyols such as pentaerythritol or sugar, or to water.

Other suitable components (A) are low-molecular-weight diols, triols and/or tetraols such as ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12, neopentyl glycol, 1,4-cyclohexane diol, 1,4-cyclohexane dimethanol, 1,4-, 1,3-, 1,2-dihydroxybenzene or 2,2-bis-(4-hydroxyphenyl)-propane (bisphenol A), TCD-diol, trimethylol propane, glycerine, pentaerythritol, dipentaerythritol or mixtures thereof, optionally also using further diols or triols which are not mentioned.

Suitable polyols are reaction products of the said polyols, in particular low-molecular-weight polyols, with ethylene and/or propylene oxide.

The low-molecular-weight components (A) preferably have a molecular weight of 62 to 400 g/mol and are preferably used in combination with the polyester polyols, polylactones, polyethers and/or polycarbonates mentioned above.

Preferably, the content of polyol component (A) in the polyurethane according to this disclosure is 20 to 95, particularly preferably 30 to 90, and most particularly preferably 65 to 90 wt. %.

Suitable as component (B) are any organic compounds which have at least two free isocyanate groups in each molecule. Preferably, diisocyanates Y(NCO)2 are used, wherein Y represents a divalent aliphatic hydrocarbon radical having 4 to 12 carbon atoms, a divalent cycloaliphatic hydrocarbon radical having 6 to 15 carbon atoms, a divalent aromatic carbon radical having 6 to 15 carbon atoms or a divalent araliphatic hydrocarbon radical having 7 to 15 carbon atoms. Examples of such diisocyanates which are preferably used are tetramethylene diisocyanate, methylpentamethylene diisocyanate, hexamethylene diisocyanate, dodecamethylene diisocyanate, 1,4-diisocyanato-cyclohexane, 1-isocyanato-3,3,5-trimethyl-5-isocyanatomethyl-cyclohexane (IPDI, isophorone diisocyanate), 4,4′-diisocyanato-dicyclohexyl-methane, 4,4′-diisocyanato-dicyclohexylpropane-(2,2), 1,4-diisocyanatobenzene, 2,4-diisocyanatotoluene, 2,6-diisocyanatotoluene, 4,4′-diisocyanato-diphenylmethane, 2,2′- and 2,4′-diisocyanato-diphenylmethane, tetramethyl xylylene diisocyanate, p-xylylene diisocyanate, p-isopropylidene diisocyanate and mixtures of these compounds.

In addition to these simple diisocyanates, also suitable are those polyisocyanates which contain hetero atoms in the radical linking the isocyanate groups and/or have a functionality of more than 2 isocyanate groups in each molecule. The first are for example polyisocyanates which are obtained by modifying simple aliphatic, cycloaliphatic, araliphatic and/or aromatic diisocyanates and which comprise at least two diisocyanates with a uretdione, isocyanurate, urethane, allophanate, biuret, carbodiimide, iminooxadiazinedione and/or oxadiazinetrione structure. As an example of a non-modified polyisocyanate having more than 2 isocyanate groups in each molecule there may, for example, be mentioned 4-isocyanatomethyl-1,8-octane diisocyanate (nonane triisocyanate).

Preferred diisocyanates (B) are hexamethylene diisocyanate (HDI), dodecamethylene diisocyanate, 1,4-diisocyanato-cyclohexane, 1-isocyanato-3,3,5-trimethyl-5-isocyanatomethyl-cyclohexane (IPDI), 4,4′-diisocyanato-dicyclohexyl-methane, 2,4-diisocyanatotoluene, 2,6-diisocyanatotoluene, 4,4′-diisocyanato-diphenylmethane, 2,2′- and 2,4′-diisocyanato-diphenylmethane and mixtures of these compounds.

The content of component (B) in the polyurethane according to this disclosure is from 5 to 60, preferably from 6 to 45, and particularly preferably from 7 to 25 wt. %.

Suitable polyisocyanates are available under the DESMODUR and BAYHYDUR names from Covestro.

Suitable components (C) are for example components containing sulfonate or carboxylate groups, such as diamine compounds or dihydroxyl compounds which additionally contain sulfonate and/or carboxylate groups, such as the sodium, lithium, potassium, t-amine salts of N-(2-aminoethyl)-2-aminoethane sulfonic acid, N-(3-aminopropyl)-2-aminoethane sulfonic acid, N-(3-aminopropyl)-3-aminopropane sulfonic acid, N-(2-aminoethyl)-3-aminopropane sulfonic acid, analogous carboxylic acids, dimethylol propionic acid, dimethylol butyric acid, the reaction products from a Michael addition of 1 mol of diamine such as 1,2-ethane diamine or isophorone diamine with 2 mol of acrylic acid or maleic acid.

The acids are frequently used directly in the form of their salt as a sulfonate or carboxylate. However, it is also possible to add the neutralizing agent needed for formation of the salt in portions or in its entirety only during or after the polyurethanes have been prepared.

For forming salts, particularly suitable and preferred tert. amines are for example triethylamine, dimethyl cyclohexylamine and ethyl diisopropylamine. It is also possible to use other amines for the salt formation, such as ammonia, diethanolamine, triethanolamine, dimethylethanolamine, methyldiethanolamine, aminomethyl propanol, and also mixtures of the said and indeed other amines. It is sensible to add these amines only after the prepolymer has been formed.

It is also possible to use other neutralizing agents, such as sodium, potassium, lithium or calcium hydroxide for neutralizing purposes.

Other suitable components (C) are mono- or difunctional polyethers which have a non-ionic hydophilising action and are based on ethylene oxide polymers or ethylene oxide/propylene oxide copolymers which are started on alcohols or amines, such as POLYETHER LB 25 (Covestro AG) or MPEG 750: methoxypolyethylene glycol, molecular weight 750 g/mol (e.g. PLURIOL 750, BASF AG).

Preferably, components (C) are N-(2-aminoethyl)-2-aminoethane sulfonate and the salts of or dimethylol propionic acid and dimethylol butyric acid.

Preferably, the content of component (C) in the polyurethane according to this disclosure is 0.1 to 15 wt. %, particularly preferably 0.5 to 10 wt. %, very particularly preferably 0.8 to 5 wt. % and even more particularly preferably 0.9 to 3.0 wt. %.

Suitable components (D) are mono-, di-, trifunctional amines and/or mono-, di-, trifunctional hydroxylamines, such as aliphatic and/or alicyclic primary and/or secondary monoamines such as ethylamine, diethylamine, isomeric propyl and butyl amines, higher linear aliphatic monoamines and cycloaliphatic monoamines such as cyclohexylamine. Further examples are amino alcohols, that is compounds which contain amino and hydroxyl groups in one molecule, such as ethanolamine, N-methyl ethanolamine, diethanolamine, diisopropanolamine, 1,3-diamino-2-propanol, N-(2-hydroxyethyl)-ethylene diamine, N,N-bis(2-hydroxyethyl)-ethylene diamine and 2-propanolamine. Further examples are diamines and triamines, such as 1,2-ethane diamine, 1,6-hexamethylene diamine, 1-amino-3,3,5-trimethyl-5-aminomethyl cyclohexane (isophorone diamine), piperazine, 1,4-diamino cyclohexane, bis-(4-aminocyclohexyl)-methane and diethylene triamine. Also possible are adipic acid dihydrazide, hydrazine and hydrazine hydrate. Mixtures of a plurality of the compounds (D), optionally also those with compounds that are not mentioned, may also be used.

Preferred components (D) are 1,2-ethane diamine, 1-amino-3,3,5-trimethyl-5-aminomethyl cyclohexane, diethylene triamine, diethanolamine, ethanolamine, N-(2-hydroxyethyl)-ethylene diamine and N,N-bis(2-hydroxyethyl)-ethylene diamine.

Compounds (D) preferably serve as chain extenders for creating higher molecular weights or as monofunctional compounds for limiting molecular weights and/or optionally additionally for incorporating further reactive groups, such as free hydroxyl groups as further crosslink points.

Preferably, the content of component (D) in the polyurethane according to this disclosure is from 0 to 10, particularly preferably from 0 to 5, and most particularly preferably from 0.2 to 3 wt. %.

Component (E) which may optionally also be used may for example be aliphatic, cycloaliphatic or aromatic monoalcohols having 2 to 22 C atoms, such as ethanol, butanol, hexanol, cyclohexanol, isobutanol, benzyl alcohol, stearyl alcohol, 2-ethyl ethanol, cyclohexanol; blocking agents which are conventional for isocyanate groups and may be split again at elevated temperature, such as butanone oxime, dimethylpyrazole, caprolactam, malonic esters, triazole, dimethyl triazole, t-butyl-benzyl amine, cyclopentanone carboxyethyl ester.

Preferably, the content of components (E) in the polyurethane according to this disclosure may be in quantities from 0 to 20, most preferably from 0 to 10 wt. %.

The polyurethane polymers used according to this disclosure may contain di- or higher-functional polyester polyols (A), based on linear dicarboxylic acids and/or derivatives thereof, such as anhydrides, esters or acid chlorides and aliphatic or cycloaliphatic, linear or branched polyols. These are used in quantities of at least 80 mol %, preferably from 85 to 100 mol %, particularly preferably from 90 to 100 mol %, in relation to the total quantity of all carboxylic acids.

Optionally, other aliphatic, cycloaliphatic or aromatic dicarboxylic acids may also be used. Examples of such dicarboxylic acids are glutaric acid, azelaic acid, 1,4-, 1,3- or 1,2-cyclohexane dicarboxylic acid, terephthalic acid or isophthalic acid. These are used in quantities of at most 20 mol %, preferably from 0 to 15 mol %, particularly preferably from 0 to 10 mol %, in relation to the total quantity of all carboxylic acids.

Preferred polyol components for the polyesters (A) are selected from the group comprising monoethylene glycol, propanediol-1,3, butanediol-1,4, pentanediol-1,5, hexanediol-1,6 and neopentyl glycol, and particularly preferred as the polyol component are butanediol-1,4 and hexanediol-1,6, and most particularly preferred is butanediol-1,4. These are preferably used in quantities of at least 80 mol %, particularly preferably from 90 to 100 mol %, in relation to the total quantity of all polyols.

Optionally, other aliphatic or cycloaliphatic, linear or branched polyols may also be used. Examples of polyols of this kind are diethylene glycol, hydroxypivalic acid neopentyl glycol, cyclohexane dimethanol, pentanediol-1,5, pentanediol-1,2, nonanediol-1,9, trimethylol propane, glycerine or pentaerythritol. These are used in quantities of preferably at most 20 mol %, particularly preferably from 0 to 10 mol %, in relation to the total quantity of all polyols.

Mixtures of two or more polyesters (A) of this kind are also possible.

The polyurethane dispersions according to this disclosure preferably have solids contents of preferably from 15 to 70 wt. %, particularly preferably from 25 to 60 wt. %, and most particularly preferably from 30 to 50 wt. %. The pH is preferably in the range from 4 to 11, particularly preferably from 6 to 10.

The waterborne polyurethane dispersions useful in this disclosure may be prepared such that the components (A), (B) optionally (C) and optionally (E) are reacted in a single-stage or multi-stage reaction to give an isocyanate-functional prepolymer which is then, optionally with component (C) and optionally (D), reacted in a single-stage or two-stage reaction and then dispersed in or using water, wherein solvent used therein may optionally be removed, partially or entirely, by distillation during or after the dispersion.

The waterborne polyurethane or polyurethane urea dispersions according to this disclosure may be prepared in one or more stages in a homogeneous or, in the case of a multi-stage reaction, partly in a disperse phase. After the polyaddition has been partially or entirely performed, a step of dispersion, emulsification or solution is carried out. Then a further polyaddition or modification in a disperse phase is optionally carried out. For the preparation, any methods known from the prior art may be used, such as the emulsifier/shear force method, acetone method, prepolymer mixing method, melting/emulsifying method, ketimine method and spontaneous dispersion of solids method, or derivatives thereof. A summary of these methods can be found in Methoden der organischen Chemie (Houben-Weyl, supplemental volumes to the 4th edition, Volume E20, H. Bartl and J. Falbe, Stuttgart, N.Y., Thieme 1987, pp. 1671-1682). The melting/emulsifying method, prepolymer mixing method and acetone method are preferred. The acetone method is particularly preferred.

In principle, it is possible to measure out all the components—all the hydroxy-functional components—together, and then to add all the isocyanate-functional components and react them to give an isocyanate-functional polyurethane, which is then reacted with the amino-functional components. Preparation is also possible the other way around, that is taking the isocyanate component, adding the hydroxy-functional components, reacting to give polyurethane and then reacting with the amino-functional components to give the end product.

Conventionally, all or some of the hydroxy-functional components (A), optionally (C) and optionally (E) for preparing a polyurethane prepolymer are put into the reactor, optionally diluted with a water-miscible solvent which is, however, inert to isocyanate groups, and then homogenised. Then the component (B) is added at room temperature to 120° C. and an isocyanate-functional polyurethane is prepared. This reaction may be performed in a single stage or in multiple stages. A multi-stage reaction may be carried out for example in that a component (C) and/or (E) is reacted with the isocyanate-functional component (B) and then a component (A) is added thereto and can then be reacted with some of the isocyanate groups that are still present.

Suitable solvents are for example acetone, methyl isobutyl ketone, butanone, tetrahydrofuran, dioxan, acetonitrile, dipropylene glycol dimethyl ether and 1-methyl-2-pyrrolidone, which may be added not only at the start of preparation but optionally also later in portions. Acetone and butanone are preferred. It is possible to perform the reaction at standard pressure or under elevated pressure.

To prepare the prepolymer, the quantities of hydroxyl-functional and, optionally, amino-functional components that are used are such that a ratio of isocyanate of preferably 1.05 to 2.5, particularly preferably 1.15 to 1.95, most particularly preferably 1.2 to 1.7 is produced.

The further reaction, the so-called chain extension, of the isocyanate-functional prepolymer with further hydroxy- and/or amino-functional, preferably only amino-functional components (D) and optionally (C) is performed such that a degree of conversion of preferably 25 to 150%, particularly preferably 40 to 85%, of hydroxyl and/or amino groups in relation to 100% isocyanate groups is selected.

In the case of degrees of conversion greater than 100%, which are possible but less preferred, it is appropriate first to react all the components which are monofunctional for the isocyanate addition reaction with the prepolymer, and then to use the di- or higher-functional chain-extending components to obtain the greatest possible degree of incorporation of all the chain-extending molecules.

Conventionally, the degree of conversion is monitored by tracking the NCO content of the reaction mixture. For this, both spectroscopic measurements, such as infrared or near infrared spectra or determination of the refractive index, and chemical analyses such as the titration of samples may be carried out.

To accelerate the isocyanate addition reaction, conventional catalysts such as those known to those skilled in the art for acceleration of NCO—OH reactions may be used. Examples are triethylamine, 1,4-diazabicyclo-[2,2,2]octane, dibutyltin oxide, tin dioctoate or dibutyltin dilaurate, tin-bis-(2-ethyl hexanoate), zinc dioctoate, zinc-bis-(2-ethyl hexanoate) or other organo-metallic compounds.

The chain of the isocyanate-functional prepolymer may be extended with the component (D) and optionally (C) before, during or after dispersion. Preferably, the chain extension is carried out before dispersion. If component (C) is used as the chain-extending component, then it is imperative that chain extension with this component be carried out before the dispersion step. Conventionally, the chain extension is carried out at temperatures of 10 to 100° C., preferably from 25 to 60° C.

The term “chain extension”, in the context of the present disclosure, also includes the reactions of optionally monofunctional components (D) which, as a result of their monofunctionality, act as chain terminators and thus result not in an increase but a limitation of the molecular weight.

The components of chain extension may be added to the reaction mixture diluted with organic solvents and/or water. They may be added successively, in any order, or at the same time by adding a mixture.

For the purpose of preparing the polyurethane dispersion, the prepolymer may either be added to the dispersion liquid, optionally under pronounced shear, such as vigorous stirring, or conversely the dispersion liquid is stirred into the prepolymer. Then the chain extension step is carried out, unless this has already been done in the homogeneous phase.

During and/or after dispersion, the organic solvent which is optionally used, such as acetone, is distilled off.

Polyurethane dispersions useful in the practice of the present disclosure may be found under the BAYHYDROL, DISPERCOLL and IMPRANIL tradenames from Covestro.

A plurality of plots 210, 220, 230, 240, 250, 260 may be generated and displayed on the ternary map GUI page 200. The plurality of plots 210, 220, 230, 240, 250, 260 each may define a geometric shape and include a plurality of points arranged in a matrix. Each of the points may define a value for at least two variables and a predicted value of the property of the material for each of the plurality of plots. A visual representation of the predicted value of the property of the material for at least some of the plurality of points in a range of indicia, wherein the range of indicia represents a range of predicted values of the property may be displayed on the ternary map GUI page 200. A pointer 212, 222, 232, 242, 252, 262 is displayed on each of the plurality of plots, such as the heat maps 216, 226, 236, 246, 256, 266, for example.

As shown in the example of FIG. 5, the ternary map GUI page 200 may include a ternary map GUI 209 that presents, in one aspect, a plot defining a geometric shape such as six ternary plots 210, 220, 230, 240, 250, 260 for six properties (Property 1-Property 6). Each of the ternary plots 210, 220, 230, 240, 250, 260 includes a plurality of points arranged in a matrix where each point defines a value for at least two variables and a predicted value of a property of the material. A visual representation of the predicted value of the property of the material for at least some of the plurality of points in a range of indicia is displayed on the ternary map GUI page 200. The range of indicia represents a range of predicted values of the property. In one aspect, at least one of the at least two variables is an independent variable.

In one aspect, the ternary plots 210, 220, 230, 240, 250, 260 may be generated by a model. The model may be generated, for example, based on design of experiments, regression analysis of a data set, an equation, machine learning, or artificial intelligence, and/or any combination thereof.

In the example illustrated in FIG. 5, each ternary plot 210, 220, 230, 240, 250, 260 represents a heat map 216, 226, 236, 246, 256, 266, respectively, showing the distribution of the property depicted by the heat map 216, 226, 236, 246, 256, 266 for all possible combinations of resins PUD A, PUD B, PUD C corresponding to vertices of the ternary plot 210, 220, 230, 240, 250, 260. In other aspects, the ternary map GUI 209 may present ternary plots for additional or fewer properties, without limitation. By way of example, the first ternary plot 210 represents a heat map 216 for Property 1, the second ternary plot 220 represents a heat map 226 for Property 2, the third ternary plot 230 represents a heat map 236 for Property 3, the fourth ternary plot 240 represents a heat map 246 for Property 4, the fifth ternary plot 250 represents a heat map 256 for Property 5, and the sixth ternary plot 260 represents a heat map 266 for Property 6.

In one aspect, the geometric shape defines a closed shape in Euclidian space. In one aspect, the closed shape defines a polygon. In the example illustrated in FIG. 5, the ternary plots 210, 220, 230, 240, 250, 260 generated by the ternary map GUI 209 are triangles, with each vertex corresponding to a particular PUD of interest. In the ternary map GUI, the top vertex corresponds to PUD A, the bottom right vertex corresponds to PUD B, and the bottom left vertex PUD C. Each PUD represents an available resin. Where the polygon is a triangle as shown in FIG. 5, each of the points defines a value for three variables, where each variable is, for example, a value representing an amount of a component a composition, such as the relative amounts of PUD A, PUD B, and PUD C to each other. In one aspect, the amounts are expressed as a percentage and a sum of the amounts is 100%.

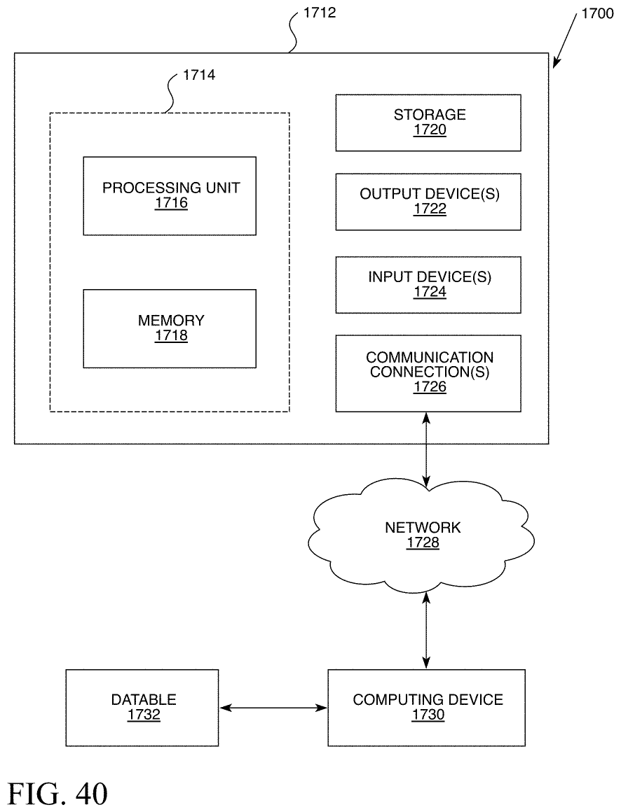

A heat map 216, 226, 236, 246, 256, 266 is a graphical representation of data, where the individual values contained in a matrix are represented as colors as shown, for example, in the corresponding color scales 214, 224, 234, 244, 254, 264. A unique color scale 214, 224, 234, 244, 254, 264 may be provided for each Property 1-Property 6 represented by the ternary plots 210, 220, 230, 240, 250, 260. With respect to the ternary map GUI 209 the various colors represent a range of measured values of the property described by the heat map 216, 226, 236, 246, 256, 266. The measured values may be stored in a data table 1732 as shown in FIG. 40, for example. The user may select a color scheme of choice by choosing one of nine options, for example, provided in a color scheme dropdown menu 346 shown in FIG. 7. As shown, Color 9 is the current selection.

Turning back to FIG. 5, the position of the chosen point is displayed as a pointer 212, 222, 232, 242, 252, 262 on the heat map 216, 226, 236, 246, 256, 266. The pointer 212, 222, 232, 242, 252, 262 provides the values for the relative amount of the corresponding PUD A, PUD B, and PUD C shown in the first section 211 of the current selection table 208, the values for the relative amount of isocyanate ISO E and ISO F in the second section 213 of the current selection table 208, and the properties represented in Property 1-Property 6 in the third section 218 of the current selection table 208. As described in more detail below, as the position of any one of the pointers 212, 222, 232, 242, 252, 262 is moved within the heat map 216, 226, 236, 246, 256, 266 section of any one of the ternary plots 210, 220, 230, 240, 250, 260 causes the values in the current selection table 208 to change accordingly.

Based on the position of the pointer 212, 222, 232, 242, 252, 262 on the heat map 216, 226, 236, 246, 256, 266, the ternary map GUI 209 provides a graphical display of the corresponding property of the material for that point. As shown in FIG. 5, the first ternary plot 210 displays the property above a horizontal bar 215, 225, 235, 245, 255, 265 in the color scale 214, 224, 234, 244, 254, 264 area and next to a box element 217, 227, 237, 247, 257, 267 where the color of the horizontal bar 215, 225, 235, 245, 255, 265 and the box element 217, 227, 237, 247, 257, 267 corresponds to the color of the property for the material as determined by the underlying software based on the position of the pointer 212, 222, 232, 242, 252, 262. As illustrated in the example of FIG. 5, based on the current position of the pointer 212, 222, 232, 242, 252, 262, the value of Property 1 is 6.2, the value of Property 2 is 38.2, the value of Property 3 is 107, the value of Property 4 is 18.4, the value of Property 5 is 56.2, and the value of Property 6 is 16.5. The color of the box element 217, 227, 237, 247, 257, 267 and the horizontal bar 215, 225, 235, 245, 255, 265 is dynamically updated based on the position of the pointer 212, 222, 232, 242, 252, 262 as the pointer 212, 222, 232, 242, 252, 262 is dragged over the heat map 216, 226, 236, 246, 256, 266.

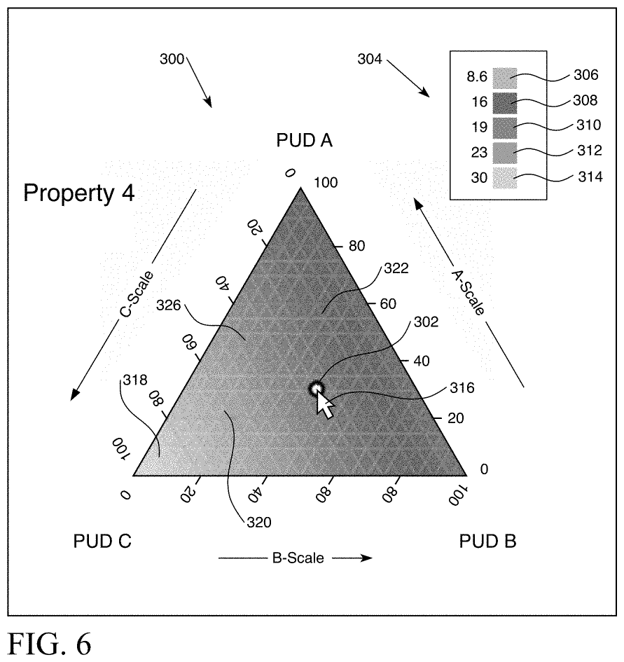

FIG. 6 is a graphical depiction of a ternary plot 300 for a property showing the location of a pointer 302 on the provided heat map 326 according to one aspect of this disclosure. The ternary plot 300 represents a heat map 326 for Property 4 and is similar to the ternary plot 240 shown in FIG. 5. As previously discussed, the ternary plot 300 includes three vertices PUD A, PUD B, PUD C and defines three scales A-Scale, B-Scale, C-Scale. An element such as a color scale 304 represents a color for each predicted value of Property 4. While the scale 304 values vary for each predicted property value, each scale begins with a light blue 306 color and progresses to green 308, 310, orange 312, and then yellow 314 as the value of that property changes. For example, when looking at the Property 4 ternary plot 300, all PUD combinations that result in a point located within the yellow region 318 in the bottom left corner near vertex PUD C represent a value of approximately 30 for Property 4. As the pointer 302 migrates toward the top vertex PUD A and right vertex PUD B, the plot changes in color to orange 320 and then green 322. These color changes signify a decrease in the predicted value of Property 4. From this information, it can be concluded that as a formulation increases in amount of PUD A and/or PUD B, the resultant product will be predicted to have a lower Property 4 value, compared to products containing a higher relative amount of PUD C as compared to the amount of PUD A and PUD B. The selected point 302 may be moved within the heat map 326 by clicking a curser on the pointer 302 and dragging the pointer 302 with a curser 316 to a desired location within the heat map 326. Clicking and dragging the pointer 302 dynamically updates the location of the pointer 302 and an element as the pointer 302 is dragged over the visual representation such as the heat map 326. The element such as the scale 304 may include a numeric value or a descriptor of the property. In one aspect, the element includes indicia, such as the range of colors that represents the predicted value or the descriptor of the property in the visual representation. Examples of suitable descriptors include, but are not limited to, silky, velvety, soft, hard, suede, rubbery, drag (e.g., hand), slippery, lubricious, tough, dead, prickly, wetness, dryness, powdery, supple.

### Ternary Map GUI Formulating

In one aspect, the present disclosure provides formulating a composition based on a plurality of properties for at least some of the plurality of points in the range of indicia. Accordingly, once the presented ternary plots 210, 220, 230, 240, 250, 260 shown in FIG. 5 have been identified, the formulating can begin. It should be noted that use of the ternary map GUI 209 can be, and often is, an iterative process that may require some time to understand how the formulating works and to determine which component combinations produce materials, such as coatings, with predicted properties closest to the desired properties.

For example, using the provided pointer, the user can change the ratio of amounts of components, such as resins, used in a formulation. To change the amounts of each component, such as a resin (such as a PUD), the curser 316 is used to click and drag the pointer 302 on the heat map 216, 226, 236, 246, 256, 266 on any of the provided ternary plots 210, 220, 230, 240, 250, 260. No matter the ternary plot 210, 220, 230, 240, 250, 260 on which the pointer was moved, the corresponding pointer 212, 222, 232, 242, 252, 262 on each of the remaining ternary plots 210, 220, 230, 240, 250, 260 moves to the same location. Turning back to FIG. 6, the formulating is shown with reference to the ternary plot 300 for Property 4.

Turning to FIG. 7, there is shown a detailed view of the “Mixture 2 Selection” tool bar 206 and color scheme drop down menu 346 according to one aspect of the present disclosure. The “Mixture 2 Selection” tool bar 206 includes a slide to change bar 342 to change the relative amounts of ISO E 340 and ISO F 344 by sliding the slider 348 left to decrease the relative amount of ISO E (and increase the relative amount of ISO F) and to the right to increase the relative amount of ISO E (and decrease the relative amount of ISO F). The color scheme dropdown menu 346 enables the user to select a color scheme for the ternary map GUI 209.

Using the slider 348 in “Mixture 2 Selection” tool bar 206, the user can specify the ratio of the amounts of isocyanates (e.g., ISO E, ISO F) used in a formulation. Upon changing the isocyanate ratio, the color distribution of the heat maps 216, 226, 236, 246, 256, 266 in the provided ternary plots 210, 220, 230, 240, 250, 260 for each Property 1-Property 6 will update accordingly. Ternary plots 210, 220, 230, 240, 250, 260 that do not change in color distribution, if any, are independent of the type and amount of isocyanate used in the formulation.

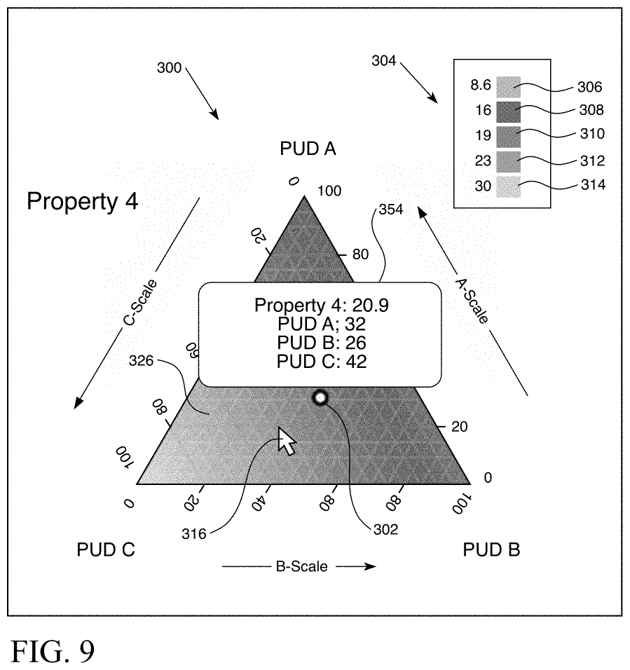

FIG. 8 is an example of a “Current Selection” table 350 showing the current formulation details according to one aspect of this disclosure. The current selection table 350 example shown in FIG. 8 includes a first section 352 that lists the values for Materials A, B, C, E, F and a second section 354 that lists the values of Property 1-Property 6. As the resin pointers 212, 222, 232, 242, 252, 262 are moved, the values in the “Current Selection” table 350 update. This table 350 can be referenced at any time to view the formulation and predicted property values of the current selection. The values of each component amount and predicted property also can be viewed by hovering over any of the provided ternary plots 210, 220, 230, 240, 250, 260. In one aspect, the value of the indicia and property of the material may be based on a position of the curser 316 on the visual representation. For example, as shown in FIG. 9, hovering the curser 316 over the ternary plot 300 for Property 4 causes a popup window 354 to display over the ternary plot 300. The popup window 354 displays the predicted value of Property 4: 20.9 and each value for the relative amount of PUD A: 32, PUD B: 26, and PUD C: 42. In one aspect, the table 350 is updated with current values of the at least two variables and the predicted value of the property based on the location of the pointer 212, 222, 232, 242, 252, 262 on the visual representation. In one aspect, a set of instructions is generated for producing a product that exhibits the predicted value of the property of the material at one of the plurality of points in the range of indicia.

### Ternary Map GUI—Formulation Optimization

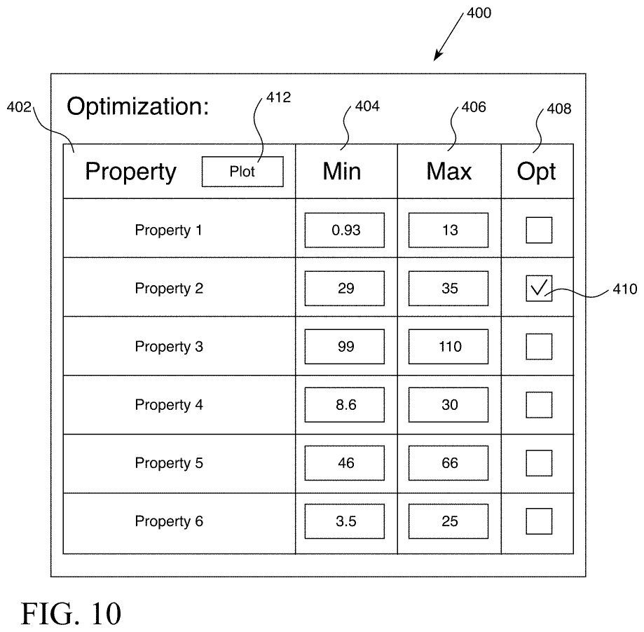

Further, the present disclosure provides optimizing one or more than one property of the material within one or more than one defined range of indicia. A gridded region that represents one or more than one optimized region based on the one or more than one defined range of indicia may be displayed on the ternary map GUI page 200. FIG. 10 is an example of a property optimization GUI window 400 according to one aspect of this disclosure. The optimization GUI window 400 includes a property 402 column, a range minimum 404 column and a range maximum 406 column for each Property 1-Property 6 and an optimization column 408 with selection checkboxes. The optimization GUI window 400 may be utilized to isolate products that have a specific set of desired properties. For instance, if the user is looking for a product that has a low Property 2 value and a high Property 5 value, the user will first specify the Property 2 constraint by looking at a range of 29 to 35. After inputting the minimum and maximum values, the user can click the “Opt” checkbox 410 to optimize this property with respect to the other properties. Then, the user can click the “Plot” button 412 and the ternary plots 210, 220, 230, 240, 250, 260 will update accordingly.

By specifying the range minimum 404 and range maximum 406 values of the Property 2, the color gradient is forced to be contained within the specified range for that property ternary plot. Clicking the “Opt” checkbox 410 outputs a grid on each map over the area to which Property 2 is within the specified range on each of the property ternary plots.

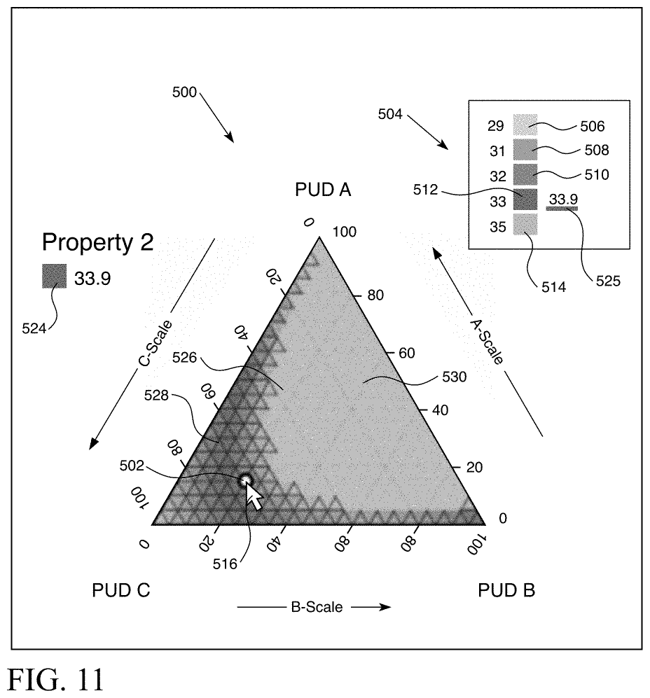

An example of an optimized ternary plot 500 is shown in FIG. 11, which is a graphical depiction of an optimization property of a ternary plot 500 according to one aspect of this disclosure. The ternary plot 500 includes a heat map 526 and a gridded region 528 superimposed on the heat map 526. A non-optimized region 530 is shown outside the gridded region 528. A color scale 504 displays the relevant color scheme for, in this case, Property 2, for example, yellow 506, orange 508, green-1 510, green-2 512, and light blue 514. A pointer 502 is located over the gridded region 528 region causing the value 33.9 to be displayed next to a box element 524 and next a horizontal bar 525. The pointer 502 can be moved over the heat map 526 by clicking and dragging the pointer 502 with the curser 516. The box element 524 and the horizontal bar 525 appears as the pointer 502 is dragged over the heat map 526. The color of the box element 524 and the horizontal bar 525 is equal to the property color based on the position of the pointer 502 on the heat map 526. The color of the box element 524 and the horizontal bar 525 is dynamically updated based on the position of the pointer 502 as the pointer 502 is dragged over the heat map 526.

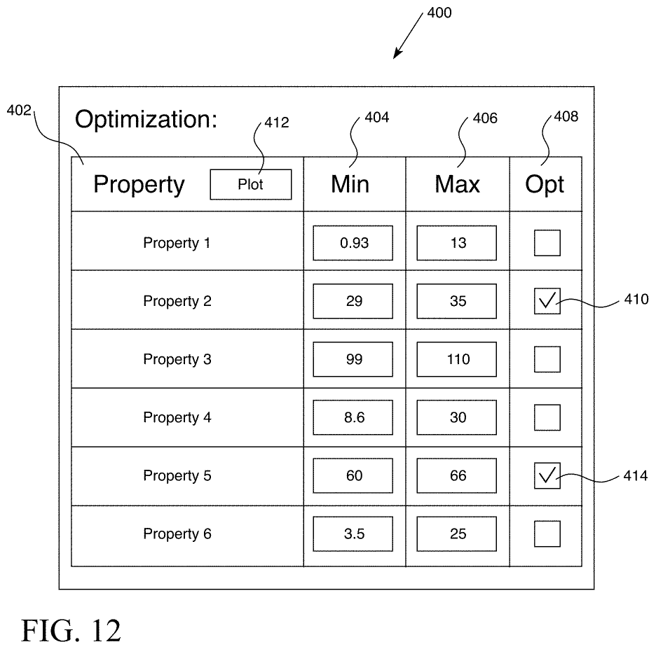

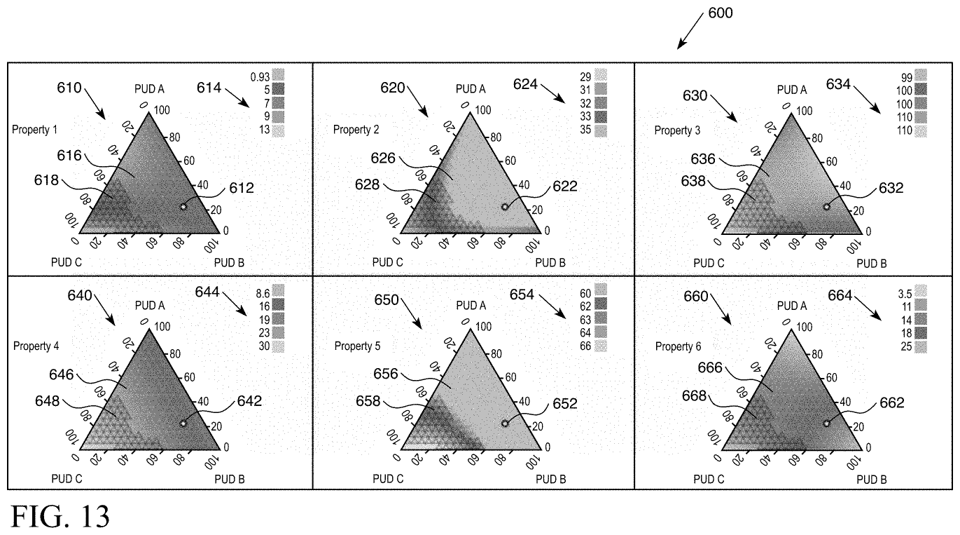

To further optimize the ternary plots 210, 220, 230, 240, 250, 260 with a second desired characteristic, the user can change the Property 5 range to be from 60 to 66 as shown in FIG. 12, check the Property 5 optimization checkbox 414, and click the plot button 412. As shown in FIG. 13, the optimization region shrinks due to the added constraint.

FIG. 13 is a graphical depiction of a ternary map GUI 600 showing optimized ternary plots 620, 650 for one or more properties according to one aspect of this disclosure. The ternary map GUI 600 shows ternary plots 610, 620, 630, 640, 650, 660 each representing a heat map 616, 626,636, 646, 656, 666, respectively, with a color scheme illustrated by corresponding color scheme scales 614, 624, 634, 644, 654, 664. A pointer 612, 622, 632, 642, 652, 662 is positioned in a non-optimized region of the heat maps 616, 626, 636, 646, 656, 666. Gridded regions 618, 628, 638, 648, 658, 668 include a grid superimposed on the heat map region to indicate that that area of the heat map has been optimized as discussed in connection with FIGS. 10 and 12, for example.

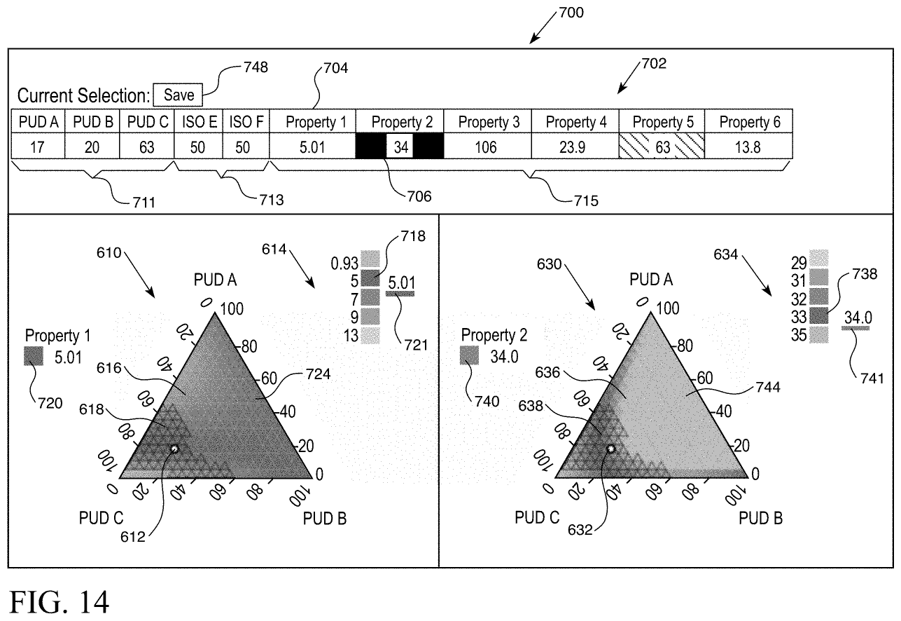

FIG. 14 is a graphical depiction 700 of ternary plots 610, 630 showing the relationship between a current selection table 702 and the location of the pointers 612, 632 in the heat map gridded regions 618, 638 of the ternary plots 610, 630 according to one aspect of this disclosure. The current selection table 702 includes three sections. The first section 711 includes the PUD A, PUD B, and PUD C values. The second section 713 includes the ISO E and ISO F values. The first ternary plot 610 includes a heat map 616 colored according to the color scheme scale 614. The value 5.01 at the location of the pointer 612 is shown next to a horizontal bar 721 and box element 718 in the scale 614 section of the ternary map and next to a box element 720 below the Property 1 label of the ternary map 610. The color of the box element 720 and the horizontal bar 721 is equal to the color representing the predicted property value based on the location of the pointer 612 on the heat map 616. The color of the box element 720 and the horizontal bar 721 is dynamically updated based on the position of the pointer 612 as the pointer 612 is dragged over the heat map 616. The value 5.01 is also shown in a Property 1 cell 704 of the current selection table 702. A gridded region 618 is provided over the optimized portion of the heat map 616 for Property 1. A non-optimized region 724 is defined outside the gridded region 618.

The second ternary plot 630 includes a heat map 636 colored according to the color scheme scale 634. The value 34.0 at the location of the pointer 632 is shown next to a horizontal bar 741 and box element 741 in the scale 634 section of the ternary map and next to a box element 740 below the Property 2 label of the ternary map. The color of the box element 740 and the horizontal bar 741 is equal to the color representing the predicted property value based on the location of the pointer 632 on the heat map 636. The color of the box element 740 and the horizontal bar 741 is dynamically updated based on the position of the pointer 632 as the pointer 632 is dragged over the heat map 636. The value 34.0 is also shown in a Property 2 cell 706 of the current selection table 702. The cell 706 is highlighted in a first color because the pointer 632 is located in an optimized region of the ternary plot 630. A gridded region 638 is provided over the optimized portion of the heat map 636 for Property 2. A non-optimized region 744 is defined outside the gridded region 638 region. The third section 715 of the current selection table 702 shows the predicted property values for each Property 1-Property 6.

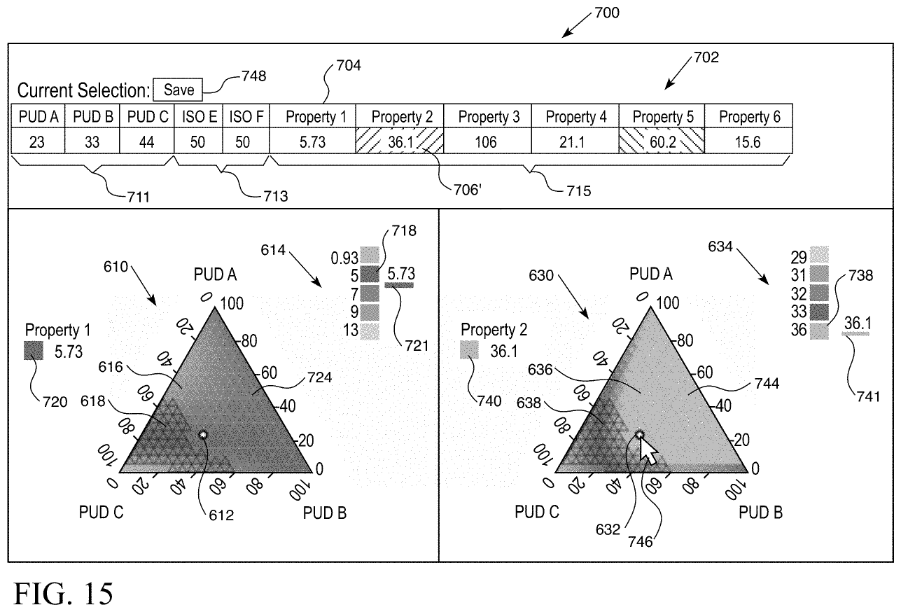

FIG. 15 is a graphical depiction of the ternary plots 610, 630 shown in FIG. 14 showing the relationship between a current selection table 702 and the location of the pointers 612, 632 in the heat map regions 616, 636 of the ternary plots 610, 630 according to one aspect of this disclosure. As shown in FIG. 15, the pointers 612, 632 have been moved out of the gridded regions 618, 638 by clicking and dragging the pointer 632 using the cursor 746. As discussed above in connection with FIG. 14, as the pointer 632 is moved within the gridded region 638, the optimized property cell 706 is highlighted in the first color within the “Current Selection” table 702. Based on the current position of the pointer 612, the value in the highlighted cell 706 is 34. However, as shown in FIG. 15, when the pointer 632 is moved outside of the isolated gridded region 638 the optimized property cell 706′ is highlighted in a second color. Based on the current position of the pointer 632, the value in the cell 706′ is 36.1. This feature helps a user to quickly see the tradeoffs that must be made if a formulation outside of the specified constraints is evaluated.

### Ternary Map GUI—Formulation Storage And Export

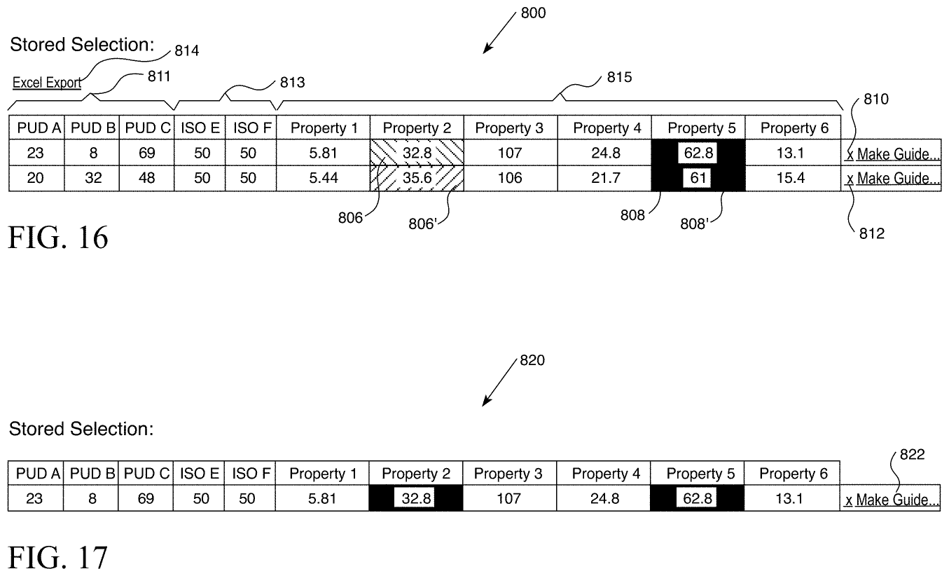

FIG. 16 is an example of a stored selection table 800 showing stored formulations according to one aspect of this disclosure. Once a formulation of interest has been discovered, the user may double click on the pointer or select the “Save” button 748 located within the first cell of the “Current Selection” table 702 (see FIG. 16) to store the component details and their predicted property values for future use/reference. Stored formulations can be displayed in table form below the ternary plots. If a user is no longer interested in keeping a formulation, the stored formulation can be deleted by clicking the blue “x” located at the far right end of the row 810, 812. The user also has the option of exporting the component and predicted property values to Excel by selecting the “Excel Export” link 814.

In the example depicted in FIG. 16, the stored selection table 800 includes a first section 811 for displaying stored values for PUD A, PUD B, and PUD C. A second section 813 of the stored selection table 800 includes stored values for the relative amounts of ISO E and ISO F. In a third section 815 of the stored selection table 800, the values of each Property 1-Property 6 are stored. As discussed in connection with FIGS. 13-15, optimization cells in the table are highlighted in a first color when the pointer is located in the gridded region and is highlighted in a second color when the pointer is moved to a location outside the gridded region. In FIG. 16, the optimization cells 806, 808 for Property 2 and Property 5 store highlighted values 32.8 and 62.8 in a first color meaning that the pointer is located within a gridded region. The optimization cell 806′ for Property 2 stores the highlighted value 35.6 in a second color meaning that the pointer has moved outside the gridded region. The optimization cell 808′ for Property 5 stores the value 61 in the first color meaning that the pointer is still located within the gridded region.

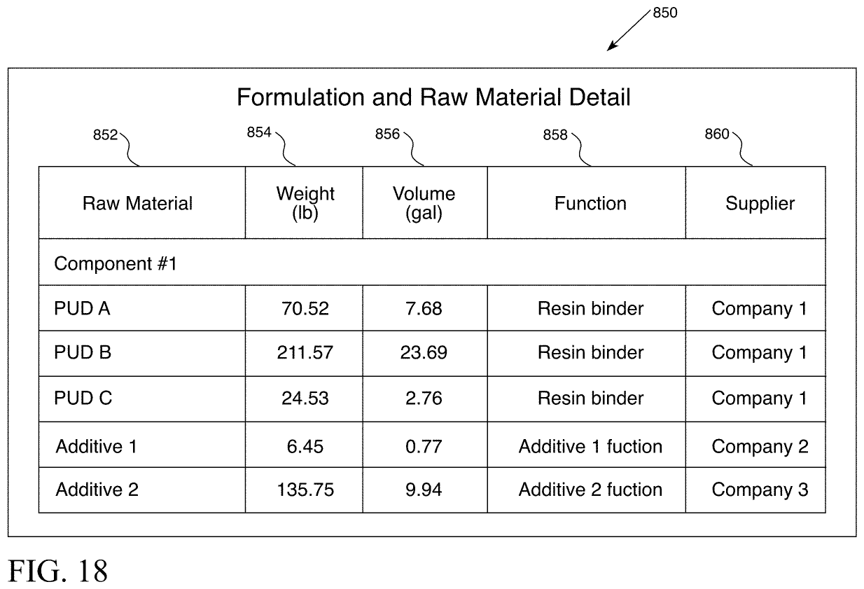

FIG. 17 is an example of a stored selection table 820 showing a starting point formulation link according to one aspect of this disclosure. Once a user has finished exploring potential formulations and has found one (or more) that he/she would like to test first-hand, the user can select the “MakeGuide” link 822. This link 822 will then send the user to a separate web page that displays a detailed starting point guide formulation 850 as shown in FIG. 18.

FIG. 18 is an example display of a starting point guide formulation 850 according to one aspect of this disclosure. The starting point guide formulation 850 includes a raw material 852 column, a weight 854 column, a volume 856 column, a function 858 column, and a supplier 860 column. In addition to the starting point guide formulation 850, other information may also be provided, such as, in the case of a coating guide formulation: a general coating description, a description of key features of the coating, a description of suggested uses of the coating, mixing instructions, application and cure property details, troubleshooting recommendations, performance data, pigment paste preparation instructions, and/or a test description key.

The user may generate a starting point formulation guide 850 for any stored resin combination and may print the guide by right clicking the web-page and selecting “Print.”

### Square Map Interface

### Square Map GUI Maps

In one aspect, the geometric shape defines a closed shape in Euclidian space such as a four-sided polygon, for example. In the four-sided polygon example, each of the points may define a value for two variables, wherein each variable is, for example, a value for an amount of a component in a composition, a processing condition, or a value representing an amount of two components of the composition relative to each other. In one aspect, a square map graphical user interface (GUI) allows a user to design products using resins, or other products, based on properties of interest. Many degrees of freedom can be embedded in the software, allowing the user to explore an entire design space of available products. In one aspect, such as in the case where the material is a polyurethane foam, the square maps can plot water versus Isocyanate Index. If desired, however, the user may change an axis by selecting the radio button next to the variable of interest. For conciseness and clarity of disclosure, the default setting will be utilized in the following description.

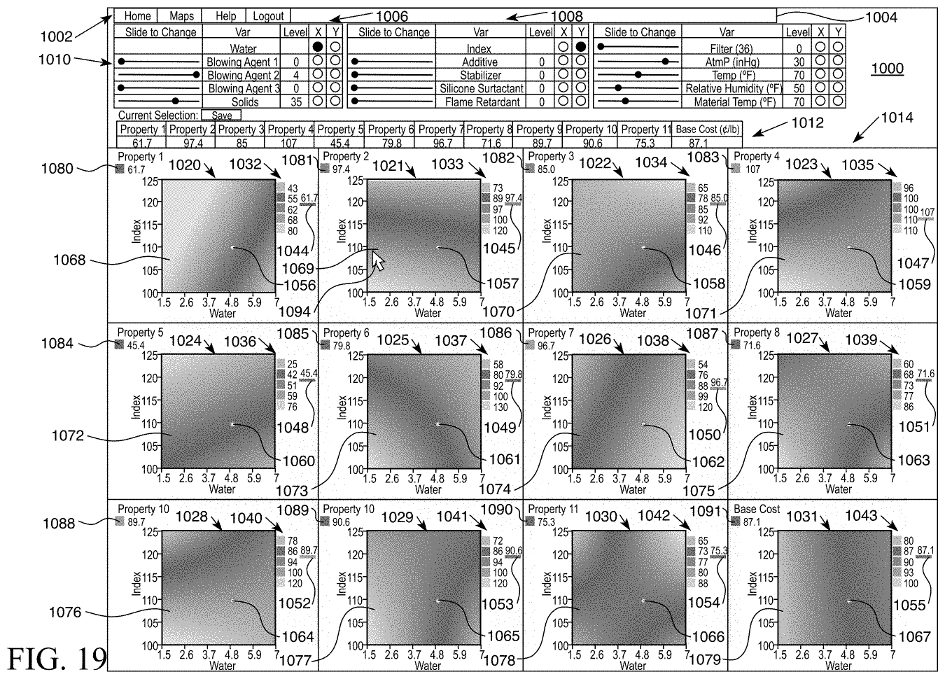

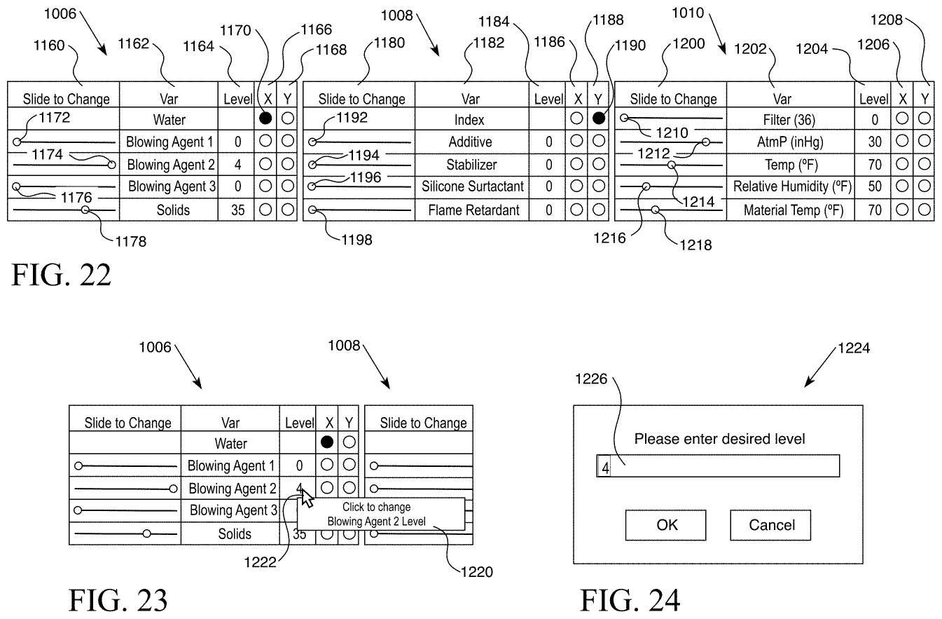

FIG. 19 is a graphical depiction of a square map GUI page 1000 according to one aspect of this disclosure. The square map GUI page 1000 includes a title bar 1002 and a menu bar 1004 that includes section tabs “Home,” “Maps,” “Help,” and “Logout,” for example. Below the menu bar 1004 are three slider bar GUIs 1006, 1008, 1010 configured to enable a user to change values for several variables listed in each of the three slider bar GUIs 1006, 1008, 1010, which are described in more detail with reference to FIG. 22. A table 1012 provides a place to store and update current variables.

In the example illustrated in FIG. 19, a plurality of square plots 1020, 1021, 1022, 1023, 1024, 1025, 1026, 1027, 1028, 1029, 1030, 1031 are displayed for eleven properties, as well as base cost. Each of the square plots 1020-1031 represents a heat map 1068, 1069, 1070, 1071, 1072, 1073, 1074, 1075, 1076, 1077, 1078, 1079, respectively, showing the distribution of the property (or cost) it depicts for all possible combinations of variables. In other aspects, the square map GUI 1014 may present square plots for additional or fewer formulation variables, without limitation. The plurality of square plots 1020-1031 may be generated and displayed on the ternary map GUI page 1000. The plurality of square plots 1020-1031 each may define a geometric shape and include a plurality of points arranged in a matrix. Each of the points may define a value for at least two variables and a predicted value of the property of the material for each of the plurality of plots. A visual representation of the predicted value of the property of the material for at least some of the plurality of points in a range of indicia, wherein the range of indicia represents a range of predicted values of the property may be displayed on the ternary map GUI page 1000. A pointer 1056, 1057, 1058, 1059, 1060, 1061, 1062, 1063, 1064, 1065, 1066, 1067 is displayed on each of the plurality of square plots, such as the heat maps 1068-1079, for example.

As shown in the example of FIG. 19, the square map GUI page 1000 also includes a square map GUI 1014 that presents, in one aspect, a plot defining a geometric shape such as twelve square plots 1020-1031. Each of the square plots 1020-1031 includes a plurality of points arranged in a matrix where each point defines a value for at least two variables and a predicted value of a property of the material. A visual representation of the predicted value of the property of the material for at least some of the plurality of points in a range of indicia is displayed on the ternary map GUI page 1000. The range of indicia represents a range of predicted values of the property. In one aspect, at least one of the at least two variables is an independent variable.

In one aspect, the square plots 1020-1031 may be generated by a model. The model may be generated based on, for example, design of experiments, regression analysis of a data set, an equation, machine learning, or artificial intelligence, and/or any combination thereof.

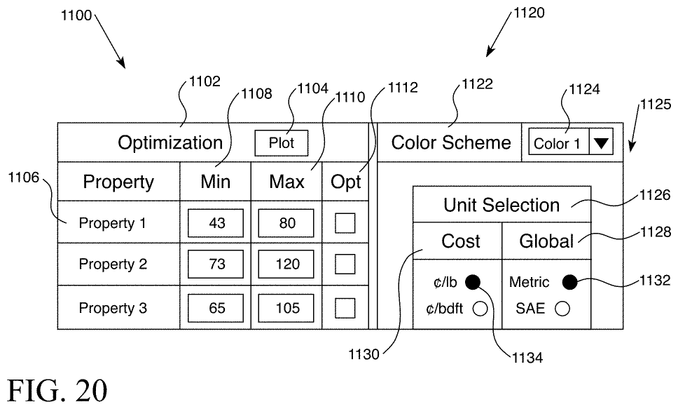

As previously discussed, the heat maps 1068-1079 are graphical representations of data, where the individual values contained in a matrix are represented as colors based on a color scheme scale 1032, 1033, 1034, 1035, 1036, 1037, 1038, 1039, 1040, 1041, 1042, 1043, respectively. With respect to the square map GUI 1014, the various colors represent a range of predicted values of the property it describes. As shown in FIG. 20, a color scheme selection GUI window 1120 includes a color scheme bar 1122 and dropdown menu 1124. A color scheme of choice may be selected by choosing one of nine options, for example, provided in the color scheme dropdown menu 1124. For demonstration purposes, Color 1 has been selected in FIG. 20.

Once the color scheme is selected, each of the heat maps 1068-1079 includes a pointer 1056-1067, respectively, which provides current selection data values based on its position within the heat map. The pointer 1056-1067 can be moved within the heat map 1068-1079 by clicking and dragging using the cursor 1094. As one pointer is moved within a particular heat map, all pointers 1056-1067 will move at the same time in the same manner. As the pointers 1056-1067 are moved within the heat maps 1068-1079 the values of the variables are simultaneously updated in a table that can be displayed simultaneously with the square map GUI 1014. In the illustrated example, each of the heat maps represents “Water” along the horizontal axis and “Index” (i.e., Isocyanate Index) along the vertical axis as discussed in more detail hereinbelow. In the example illustrated in FIG. 19, a point in the heat map 1068-1079 matrix represents a value representing an amount of water in the composition and an Isocyanate Index for the composition. In other aspects, the horizontal or vertical variables may include variables for composition components, such as water, blowing agent(s), solids content, additive(s), foam stabilizer(s), silicone surfactant(s), flame retardant(s), filler(s), or variables for processing conditions, such as atmospheric pressure, temperature, relative humidity, and/or material temperature as indicated in the slider bar GUI 1006, 1008, 1010 region of the square map GUI page 1000. As previously discussed, the variables may be adjusted with the slider bar GUI 1006, 1008, 1010.

The illustrated example of FIG. 19 describes components and processing conditions often utilized in the production of flexible polyurethane foams. Such flexible foams may be molded or free rise (i.e., slabstock) using conventional processing techniques at an Isocyanate Index of, for example, 75 to 140, such as 85 to 130. The term “Isocyanate Index” (also commonly referred to as “NCO Index”) is defined herein as the equivalents of isocyanate, divided by the total equivalents of isocyanate-reactive hydrogen containing materials, multiplied by 100. In calculating the Isocyanate Index, all NCO-reactive components (including water) are taken into consideration. In practice, the flexible foams are prepared by mixing the aforementioned components in standard foam processing equipment in accordance with techniques known to those skilled in the art. In preparing the flexible foam, the isocyanate-reactive and polyisocyanate reactants, the catalysts, blowing agents, surfactants and other optional ingredients, are typically mixed together and then the mixture continuously poured onto a moving conveyer to create a continuous flexible polyurethane foam slab.

As the pointer 1056-1067 is moved over the heat map 1068-1079, predicted property values (and base cost) for the material is displayed in two locations. First, a predicted property value (and base cost) is displayed above a horizontal bar 1044, 1045, 1046, 1047, 1048, 1049, 1050, 1051, 1052, 1053 1054, 1055 in the color scale 1032-1043 region of the square plot 1020-1031. Second, a predicted property value is displayed next to a box element 1080, 1081, 1082, 1083, 1084, 1085, 1086, 1087, 1088, 1089, 1090, 1091 located below the “Property” label on the square plot 1020-1031. The color of the horizontal bar 1044-1055 and the box element 1080-1091 is the same color as the corresponding color associated with the property of the material as determined by the underlying software based on the current location of the pointer 1056-1067. As illustrated in the example of FIG. 19, based on the current position of the pointer 1056-1067, the value of Property 1 is 61.7, the value of Property 2 is 97.4, the value of Property 3 is 85.0, the value of Property 4 is 107, the value of Property 5 is 45.4, the value of Property 6 is 79.8, the value of Property 7 is 96.7, the value of Property 8 is 71.6, the value of Property 9 is 89.7, the value of Property 10 is 90.6, the value of Property 11 is 79.8, and the Base Cost is 87.1. The color of the box element 1080-1091 and the horizontal bar 1044-1055 is dynamically updated based on the position of the pointer 1056-1067 as the pointer 1056-1067 is dragged over the heat map 1068-1069.

FIG. 20 is an example display of an optimization GUI window 1100, a color scheme selection GUI window 1120, and a unit selection GUI window 1125 according to one aspect of this disclosure. The optimization GUI window 1100 includes an optimization bar 1102 with a plot button 1104 embedded therein. Below the optimization bar 1102 are a property 1106 column, a range minimum 1108 column and a range maximum 1110 column for each Property 1-Property 11 (only Property 1-Property 3 shown in FIG. 20) and an optimization column 1112 with selection checkboxes. The optimization GUI window 1100 may be utilized to isolate products that have a specific set of desired properties. For instance, in the illustrated example, Property 1 is constrained between 43 and 80 and is not selected for optimization as indicated by the blank checkboxes in the optimization column 1112. Property 2 is constrained between 73 and 120 and Property 3 is constrained between 65 and 105, and neither is selected for optimization as indicated by the blank checkboxes in the optimization column 1112. After inputting the minimum and maximum values, the user can click the appropriate “Opt” checkbox to optimize a property with respect to the other properties. Then, the user can click the “Plot” button 1104 and the square plots 1016, 1026, 1036, 1046, 1056, 1066, 1076, 1086 (FIG. 19) will update accordingly.

The unit selection GUI window 1125 includes a unit selection bar 1126. Below the unit selection bar 1126, there is radio button selection area that includes global units 1128 and cost 1130 radio buttons. Units for the displayed property (Property 1-Property 11 in FIG. 19) and cost estimations can be selected by using the provided radio button 1134 for the cost 1130 and radio button 1132 for the global units 1128 and radio button. Upon selecting a different cost/global unit, the “plot” button 1104 is selected to execute the change.

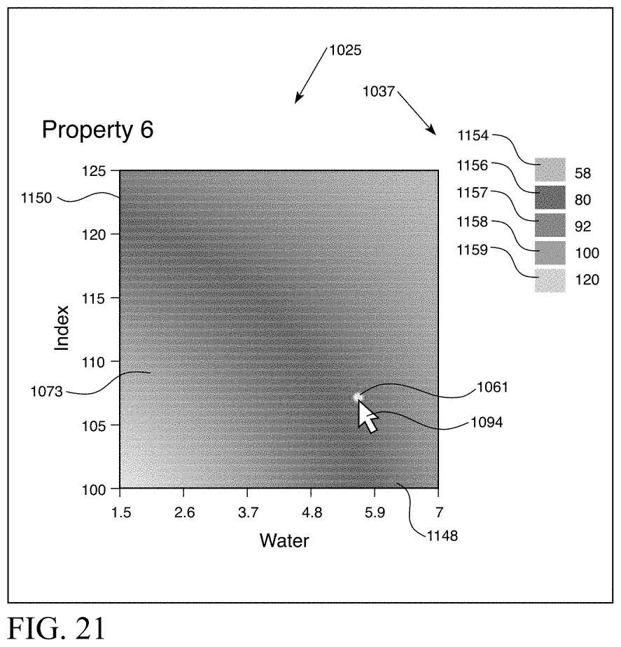

FIG. 21 is a graphical depiction of the square plot 1025 shown in FIG. 19 for a property showing a cursor 1094 located over a selected pointer 1061 on the provided heat map 1073 according to one aspect of this disclosure. While the color scheme scale 1037 values may vary for each property type, each scale may begin with a light blue color 1154, progresses to green-1 1156, green-2 1157, orange 1158, and then yellow 1159 as the value of that property changes. By looking at the provided representative heat map 1073, it is easy to note trends in how properties change as formulation variables change. For instance, it is seen that, in this example, at lower water content 1148 and NCO Index 1150 levels, the foam is high in Property 6. However, as water content 1148 and NCO Index 1150 levels increase, the value of Property 6 decreases. With variable property interests, the engine allows a user to move any of the square plots 1020-1031 (FIG. 19) to group desired properties together. Shift+clicking a square plot moves it to the right, while CTRL+clicking a square plot moves it downward.

Using the provided pointer 1061, a user can change the amount of water and the NCO Index of a proposed formulation, by clicking and dragging the pointer 1061 with the cursor 1094 on the heat map 1073 or any of the other provided heat maps 1068-1079 (FIG. 19). No matter the contour plot on which the pointer 1061 was moved, the corresponding pointer on each of the remaining heat maps also moves to the same location. For example, as shown in FIG. 19, the pointers 1056-1067 are located in the same location of the corresponding heat maps 1068-1079 as the pointer 1061 in the heat map 1073 for Property 6. The pointer 1061 can be moved to a location within the heat map 1073 by placing the cursor 1094 over the pointer 1061 and clicking and dragging the pointer 1061 to a desired location. Accordingly, as the pointer 1061 is moved within the heat map 1073, the rest of the pointers 1056-1067 will move to the same location of the corresponding heat maps 1068-1079.

### Square Map GUI Formulating Process

Now that the presented square plots have been identified, the formulating process can begin. It should be noted that use of the square map GUI 1014 (FIG. 19) can be, and often is, an iterative process that may require some time to understand how the formulating works and to determine which component combinations produce materials, such as flexible polyurethane foams, with properties closest to the desired properties. To evaluate the effects of amounts of formulation ingredients and processing variables, a level may be changed by clicking and dragging any of the provided slider bars as shown, for example, in FIG. 22. The square map GUI 1014 may be employed for any products which have recipe/performance relationships such as foams, elastomers, coatings with solids, water, and blowing agents as named variables.

FIG. 22 is an example graphical depiction of three variable selection and slider bar GUIs 1006, 1008, 1010 to select variables and enable level adjustments for various processing variables according to one aspect of the present disclosure. The first variable selection and slider bar GUI window 1006 displays a slide to change bar 1160, a variable bar 1162, a level bar 1164, and x-axis bar 1166, and a y-axis bar 1168. The first variable displayed below the variable bar 1162 is “Water.” A radio button selects whether a variable is displayed along the x-axis or the y-axis. In the illustrated example, the variable “Water” is displayed along the x-axis as indicated by the selected radio button 1170. As shown in the examples illustrated in FIGS. 19 and 21, the variable “Water” is shown along the x-axis. The next variable is “Blowing Agent 1” and its level is controlled with the slider bar 1172. As shown, the “Blowing Agent 1” level is currently set to minimum or zero (0). The next variable is “Blowing Agent 2” and its level is controlled with the slider bar 1174. As shown, the “Blowing Agent 2” level is currently set to maximum or 4. The next variable is “Blowing Agent 3” and its level is controlled with the slider bar 1176. As shown, the “Blowing Agent 3” level is currently set to minimum or zero (0). The final variable is “Solids” and its level is controlled with the slider bar 1178. As shown, the “Solids” level is currently set to 35. For all the slider bars 1172, 1174, 1176, 1178 sliding to the left decreases the level and sliding to the right increases the level.

The second variable selection and slider bar GUI window 1008 displays a slide to change bar 1180, a variable bar 1182, a level bar 1184, and x-axis bar 1186, and a y-axis bar 1188. The first variable displayed below the variable bar 1182 is “Index.” A radio button selects whether a variable is displayed along the x-axis or the y-axis. In the illustrated example, the variable “Index” is displayed along the y-axis as indicated by the selected radio button 1190. As shown in the examples illustrated in FIGS. 19 and 21, the variable “Index” is shown along the y-axis. The next variable is “Additive” and its level is controlled with the slider bar 1192. As shown, the “Additive” level is currently set to minimum or zero (0). The next variable is “Stabilizer” and its level is controlled with the slider bar 1194. As shown, the “Stabilizer” level is currently set to minimum zero (0). The next variable is “Silicone Surfactant” and its level is controlled with the slider bar 1196. As shown, the “Silicone Surfactant” level is currently set to minimum or zero (0). The final variable is “Flame Retardant” and its level is controlled with the slider bar 1198. As shown, the “Flame Retardant” level is currently set to minimum zero (0). For all the slider bars 1192, 1194, 1196, 1198 sliding to the left decreases the level and sliding to the right increases the level.

The third variable selection and slider bar GUI window 1010 displays a slide to change bar 1200, a variable bar 1202, a level bar 1204, and x-axis bar 1206, and a y-axis bar 1208. The first variable displayed below the variable bar 1202 is “Filler (%).” A radio button selects whether the variable is displayed along the x-axis or the y-axis. In the illustrated example, none of the variables are displayed along the x-axis or y-axis as indicated by the unselected radio buttons. The level for the “Filler (%)” variable is controlled with the slider 1210. As shown, the “Filler (%)” level is currently set to minimum or zero (0). The next variable is “AtmP (mmHg)” (atmospheric pressure in mm of Hg) and its level is controlled with the slider bar 1212. As shown, the “AtmP (mmHg)” level is currently set to 30 mmHg. The next variable is “Temp (° F.)” (temperature) and its level is controlled with the slider bar 1214. As shown, the “Temp (° F.)” level is currently set to 70° F. The next variable is “Relative Humidity (%)” and its level is controlled with the slider bar 1216. As shown, the “Relative Humidity (%)” level is currently set to 50%. The final variable is “Material Temp (° F.)” and its level is controlled with the slider bar 1218. As shown, the “Material Temp (° F.)” level is currently set to 70° F. For all the slider bars 1210, 1212, 1214, 1216, 1218 sliding to the left decreases the level and sliding to the right increases the level.

Upon changing a value, the plots temporarily disappear. This occurs so that all of the background equations can recalculate to update the plots, based on the new selected value. FIG. 23 is an example graphical depiction of popup bar 1220 that provides instructions for clicking to change a variable level coinciding with the location of the cursor 1222 and FIG. 24 shows a manual entry dialog box GUI window 1224 to enable entry of the level into a manual input box 1226 and then clicking on the “OK” button.

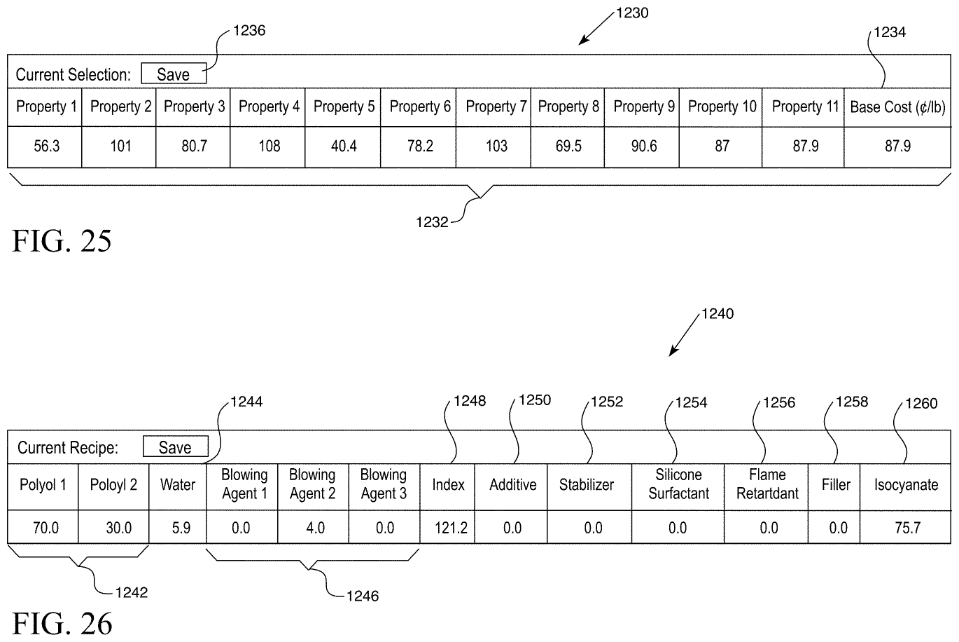

FIG. 25 is an example display of a “Current Selection” table 1230 showing values of predicted properties, listed as properties in the table, according to one aspect of this disclosure. The “Current Selection” table 1230 includes a first section 1232 for storing and updating values of Property 1-Property 11 and a second section 1234 for storing and updating base cost. With reference now also to FIG. 21, as the pointer 1061 is moved within the heat map 1073, the values in the “Current Selection” table 1230 update in real time. This table can be referenced at any time to view the formulation and predicted property values of the current selection.

FIG. 26 is an example display of a “Current Recipe” table 1240 showing a rudimentary formula based on the current properties selected according to one aspect of this disclosure. The “Current Recipe” table 1240 is located under the provided maps. In the illustrated example, the “Current Recipe” table 1240 includes the current recipe Polyol 1 and Polyol 2 values 1242, a Water value 1244, Blowing Agent 1-Blowing Agent 3 values 1246, an Index value 1248, an Additive value 1250, a Stabilizer value 1252, a Silicone Surfactant value 1254, a Flame Retardant value 1256, a Filler value 1258, and an Isocyanate value 1260. As discussed in connection with FIG. 22, the values in the “Current Recipe” table 1240 are updated with the variable selection and slider bar GUIs 1006, 1008, 1010.

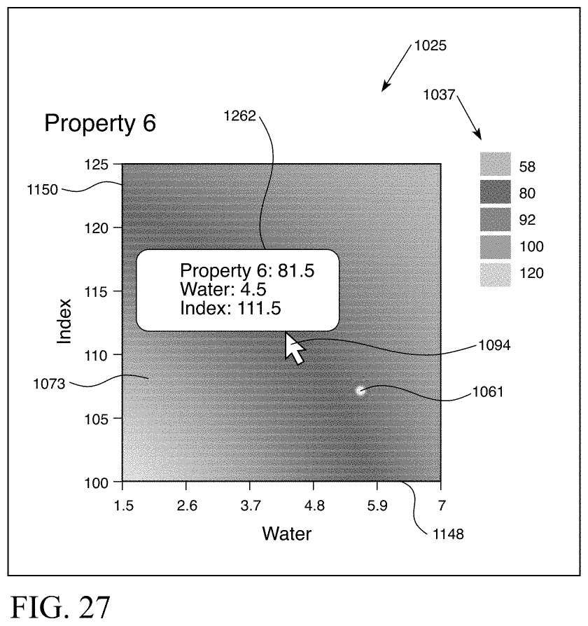

FIG. 27 is a graphical depiction of square plot 1025 for a property showing a display of a popup window 1262 on hover property according to one aspect of this disclosure. The popup window 1262 on hover enables a user to view the values of the x-axis and y-axis variables and predicted property value by hovering over any of the provided square plots to see the values corresponding to that point. The popup window 1262 on hover displays the values based on the location of the curser 1094. In the illustrated example, the popup window 1262 displays the value for Property 6: 81.5, Water: 4.5, and Index: 111.5.

### Square Map GUI—Formulation Optimization

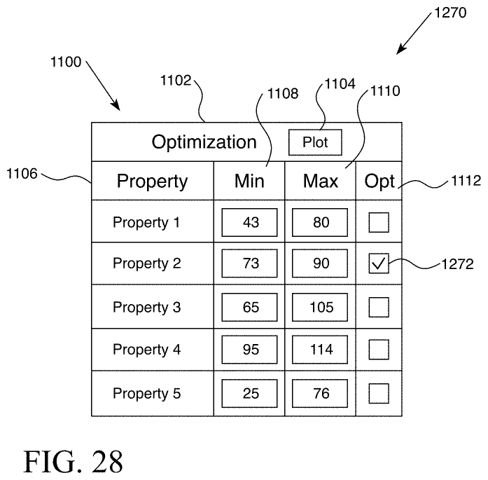

FIG. 28 is an example display of a single property optimization GUI window 1270 according to one aspect of this disclosure. To isolate products that have a specific set of desired properties, the optimization feature may be utilized. For instance, if a product has a low Property 2 value and a high Property 5 value, the user can specify the Property 2 constraint by looking at a range of 73 to 90. After inputting the minimum and maximum values, the user will click the “Opt” checkbox 1272 to optimize this property with respect to the other properties and click the “Plot” button 1104 and the graphs will update accordingly.

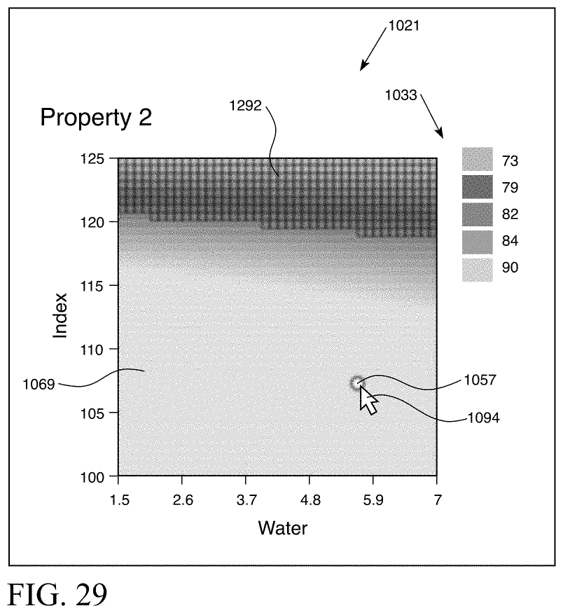

FIG. 29 is a graphical depiction of an optimization property of a square plot 1021 according to one aspect of this disclosure. By specifying the minimum and maximum range values of the Property 2, the color gradient is forced to be contained within the specified range for that property in heat map 1069. Clicking the “Opt” checkbox 1272 (FIG. 28) outputs a grid 1292 on each heat map 1069 over the area to which Property 2 is within the specified range on each of the property maps.

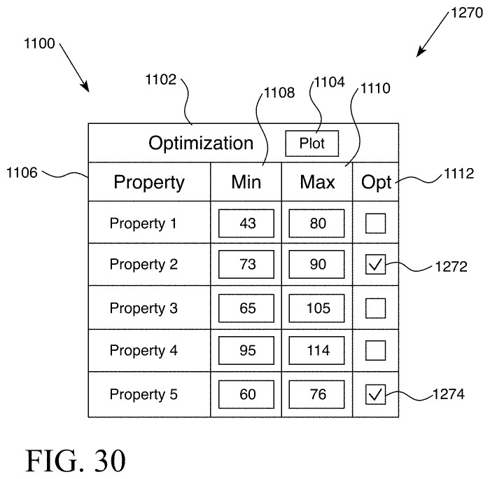

FIG. 30 is an example display of a multiple property optimization GUI window 1270 according to one aspect of this disclosure. To further optimize the square plots with a second desired characteristic, the user can change the Property 5 range to be from 60 to 76 by clicking on the “Opt” checkbox 1274 as shown in FIG. 30 and then click on the “Plot” button 1104 to update the graphs.

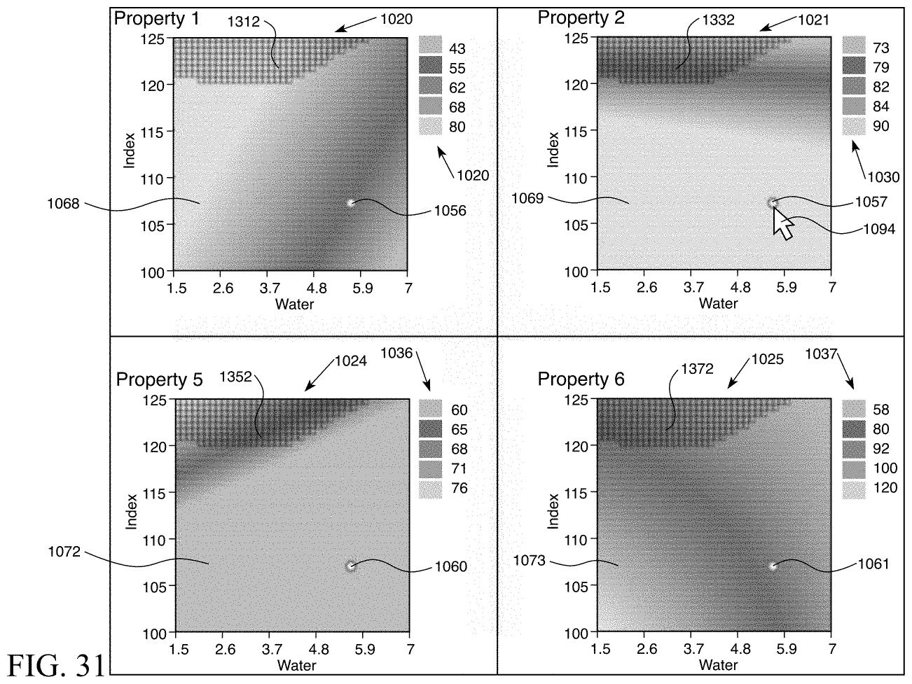

FIG. 31 is a graphical depiction of four square plots 1020, 1021, 1024, 1025 showing optimized regions according to one aspect of this disclosure. The square plots 1020, 1021, 1024, 1025 included gridded regions 1312, 1332, 1352, 1372, respectively, to show the optimization regions of heat maps 1068, 1069, 1072, 1073 of Property 2 and Property 5. Due to the added constraint, the optimization regions represented as the gridded regions 1312, 1332, 1352, 1372 shrink in size.

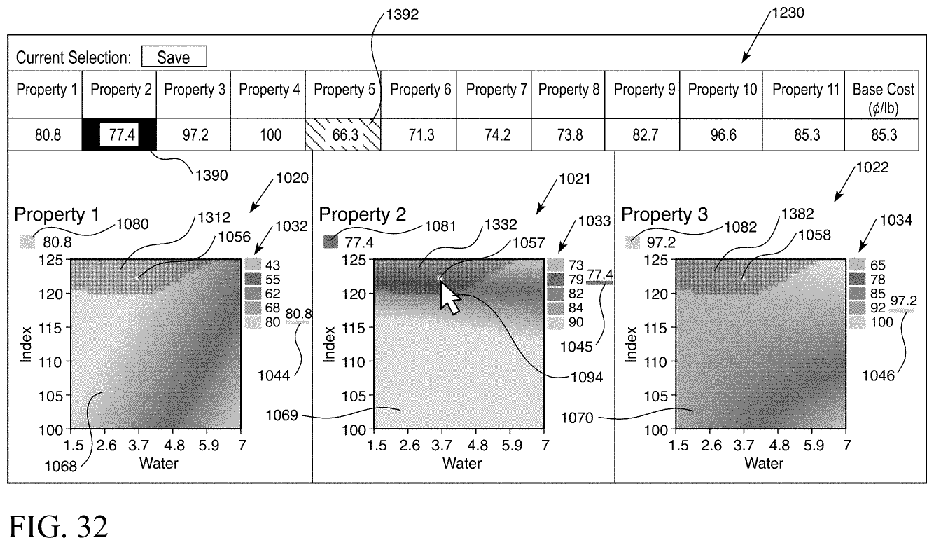

FIG. 32 is a graphical depiction of square plots 1020, 1021, 1022 showing cell highlight within the optimized region according to one aspect of this disclosure. As the pointer 1057 is moved within the gridded region 1332 using the curser 1094, the corresponding optimized property cells 1390 for Property 2 and 1392 for Property 5 (square plot 1024 not shown in this view, but is shown in FIG. 31) are highlighted in a first color within the “Current Selection” table 1230.

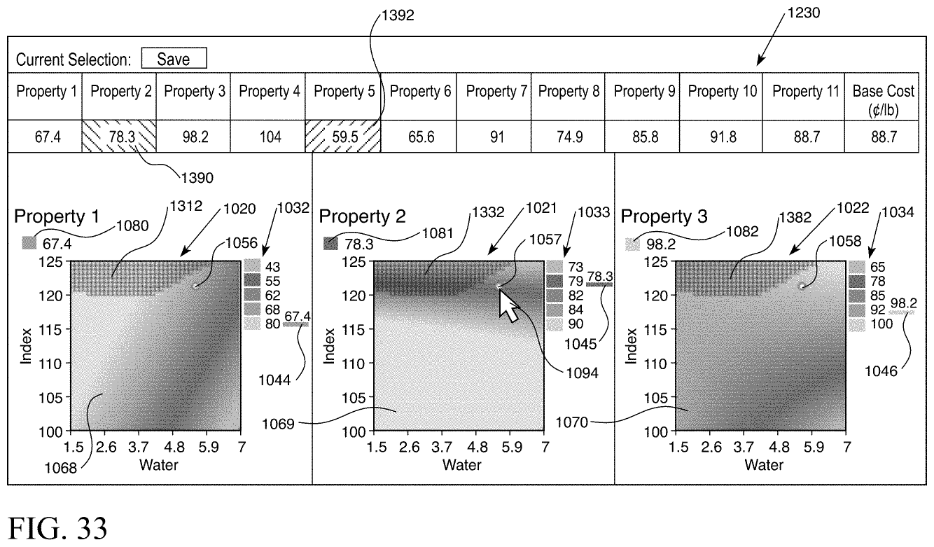

FIG. 33 is a graphical depiction of square plots 1020, 1021, 1022 showing cell highlight outside of optimized region according to one aspect of this disclosure. As the pointer 1057 is moved outside the gridded region 1332 using the curser 1094, the corresponding optimized property cell 1392 for Property 5 (square plot 1024 not shown in this view, but is shown in FIG. 31) is highlighted in a second color within the “Current Selection” table 1230. This feature helps a user to quickly see the tradeoffs that must be made if a formulation outside of the specified constraints is evaluated.

### Square Map GUI—Cost Estimation

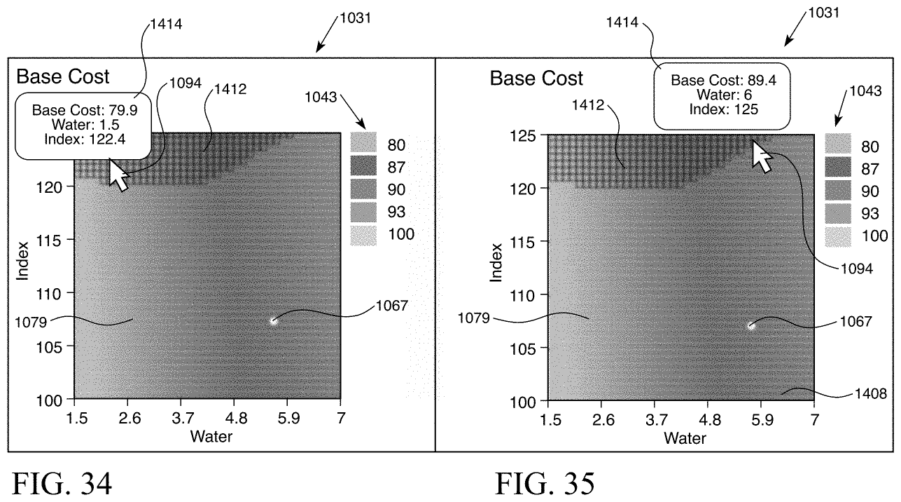

FIGS. 34 and 35 are graphical depictions of a base cost square plot 1031 showing product cost estimations within an optimized region according to one aspect of this disclosure. The base cost square plot includes similar elements as the square plot previously described. In the example illustrated in FIGS. 34 and 35, the base cost square plot 1031 includes a heat map 1079 region according to the color scale 1043 and a gridded region 1412 to signify an optimized area. A pointer 1067 is used to view different points within the heat map 1079 inside and outside the gridded region 1412. In addition to properties, cost optimizations and analyses can also be assessed with the base cost square plot 1031. Cost can be viewed in units of cents per pound or cents per board foot, using the provided radio button 1134 selection made in the Unit Selection GUI window 1125 shown in FIG. 20. A base cost popup window 1414 is displayed by hovering the cursor 1094 in a desired region of the heat map 1079. Looking at the base cost square plot 1400, the product increases in price moving from left to right. Notice the cost difference within the constrained region of interest. At the left side of the gridded region 1412 shown in FIG. 34 the base cost is approximately 80 cents per pound while at the right edge of the gridded region 1412 shown in FIG. 35, the cost is almost 90 cents per pound. This indicates possible formulations of lower cost that still provide the desired properties.

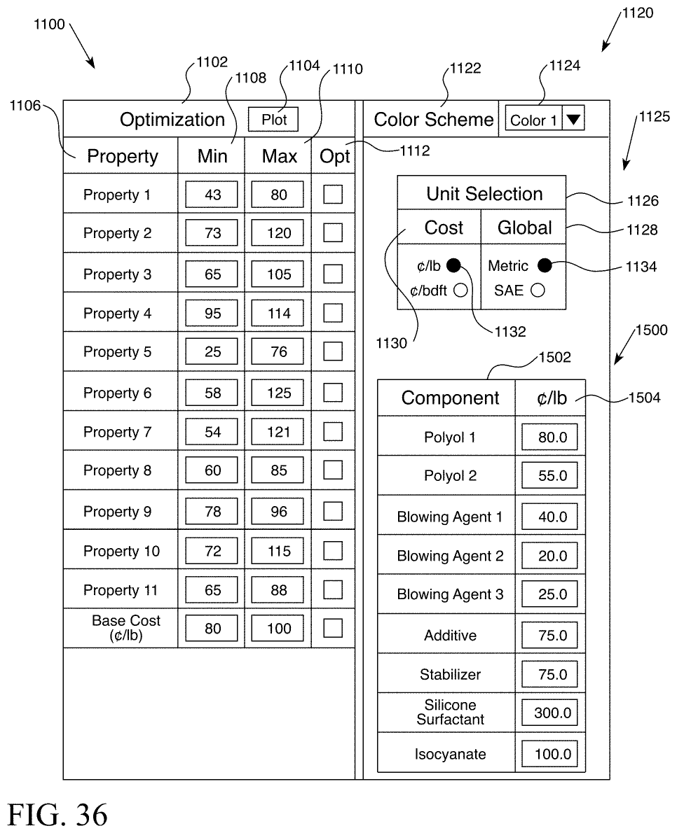

FIG. 36 is a graphical depiction of a cost table GUI window 1500 according to one aspect of this disclosure. The cost table GUI window 1500 includes a list of components 1502 and the unit cost in ¢/lb 1504 as selected in the unit selection GUI window 1125. If the price of a product changes, it can be updated in the cost table using the unit selection GUI window 1125. To recalculate the base cost square plot 1400 (FIGS. 34 and 35) with new price values, the user selects the “Plot” button 1104. It is worthy to note that the optimization GUI window 1100 includes a complete list of all eleven properties, as well as base cost 1130.

### Square Map GUI—Formulation Storage and Export

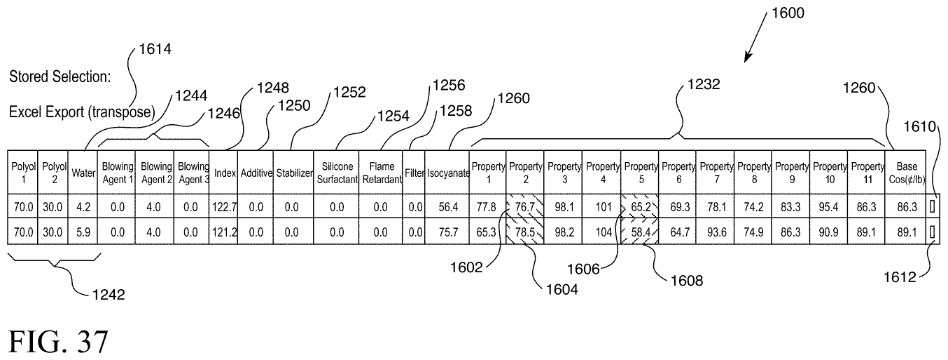

FIG. 37 is an example display of a stored formulations table 1600 according to one aspect of this disclosure. Once a formulation of interest has been discovered, the user may double click on the pointer or select the “Save” button 1236 located within the first cell of the “Current Selection” table 1230 shown in FIG. 25 to store the component details and their predicted properties for future use/reference. Stored formulations can be displayed in table form below the square plots. If a formulation is no longer of interest, the stored formulation can be deleted by clicking the blue “x” 1610, 1612 located at the far right end of the row. The user also has the option of exporting the component and predicted property values to Excel by selecting the “Excel Export” link 1614. If it is desired to view the data in transposed form, the transpose link is selected. The cells 1602, 1604, 1606 are highlighted in a first color to indicate that the pointer is located within the optimization region. The cell 1608 is highlighted in a second color to indicate that the pointer is located outside the optimization region. The cells shown in stored formulations table 1600 were previously defined in FIGS. 25 and 26 and will not be repeated here.

Foams currently related to the square plots 1020-1031 described with reference to FIGS. 19-37, are produced by reacting a polyisocyanate with a material that will react with that chemical to form a polyurethane in the presence of a blowing agent (resulting in the cellular nature of the foam). For example, the polyurethane foams may comprise the reaction product of (1) an aromatic polyisocyanate component, and (2) an isocyanate-reactive component comprising one or more polyoxyalkylene polyether polyols, in the presence of (3) one or more blowing agents, (4) one or more catalysts, and (5) one or more surfactants, among other possible materials. The relative amounts of NCO groups is often such that the Isocyanate Index is 75 to 140, such as 85 to 130.

The components include a polyisocyanate component and an isocyanate-reactive component that includes several ingredients such as polyols, monols, blowing agents, catalysts, surfactants, and other additives as described hereinbelow.

Suitable polyisocyanate components to be used as component (1) include, for example, aromatic polyisocyanates characterized by a functionality of greater than or equal to about 2.0. In particular, the suitable polyisocyanates and/or prepolymers thereof to be used as component (1) typically have NCO group contents of greater than about 20%. Suitable aromatic polyisocyanates include toluene diisocyanate including 2,4-toluene diisocyanate, 2,6-toluene diisocyanate and mixtures thereof, diphenylmethane diisocyanate including 2,2′-diphenylmethane diisocyanate, 2,4′-diphenylmethane diisocyanate, 4,4′-diphenylmethane diisocyanate, and isomeric mixtures thereof, polyphenylmethane polyisocyanates, etc. One suitable aromatic polyisocyanate component comprises a mixture of 80% by weight of 2,4-toluene diisocyanate and 20% by weight of 2,6-toluene diisocyanate.

Suitable polyoxyalkylene polyether polyols include those having a hydroxyl functionality of at least about 2. The hydroxyl functionality of the polyoxyalkylene polyether polyols is often less than or equal to about 8, such as less than or equal to about 6 or less than or equal to 4. Suitable polyoxyalkylene polyether polyols may also have functionalities ranging between any combination of these upper and lower values, inclusive, e.g., from at least 2 to no more than 8, such as from at least 2 to no more than 6 or from at least 2 to no more than 4. Typically, the average OH (hydroxyl) numbers of suitable polyoxyalkylene polyether polyols is at least about 20, such as at least 25. Polyoxyalkylene polyether polyols typically also have average OH numbers of less than or equal to 250, such as less than or equal to 150.

Suitable polyoxyalkylene polyether polyols for the isocyanate-reactive component (2) of the flexible foams are typically the reaction product of a suitable initiator or starter and one or more alkylene oxides. The polyoxyalkylene polyether polyols typically have less than or equal to about 85% by weight of copolymerized oxyethylene, based on 100% by weight of oxyalkylene present.

Thus, the isocyanate-reactive component (2) of the flexible foams comprises one or more polyoxyalkylene polyether polyols and is typically described in terms of their hydroxyl functionality, OH (hydroxyl) number, and the amount of copolymerized oxyethylene. Generally speaking, suitable polyoxyalkylene polyether polyols include those which contain from 2 to 8 hydroxyl groups per molecule, having an OH (hydroxyl) number of from 20 to 250, and containing less than equal to about 85% by weight of copolymerized oxyethylene, based on 100% by weight of oxyalkylene present in the polyether polyol.

As used herein, the hydroxyl number is defined as the number of milligrams of potassium hydroxide required for the complete hydrolysis of the fully phthalylated derivative prepared from 1 gram of polyol. The hydroxyl number can also be defined by the equation: OH=(56.1×1000/eq. wt.)=(56.1×1000)×(f/mol. wt.) where: OH: represents the hydroxyl number of the polyol; eq. wt.: weight per molar equivalents of contained OH groups; f: represents the nominal functionality of the polyol, i.e. the average number of active hydrogen groups on the initiator or initiator blend used in producing the polyol; and mol. wt.: represents the nominal number average molecular weight based on the measured hydroxyl number and the nominal functionality of the polyol.

Among the polyoxyalkylene polyols which can be used are the alkylene oxide adducts of a variety of suitable initiator molecules. Non-limiting examples include dihydric initiators such as ethylene glycol, diethylene glycol, triethylene glycol, propylene glycol, dipropylene glycol, tripropylene glycol, neopentyl glycol, 1,3-propanediol, 1,4-butanediol, 1,6-hexanediol, 1,4-cyclo-hexanediol, 1,4-cyclohexane-dimethanol, hydroquinone, hydroquinone bis(2-hydroxyethyl)ether, the various bisphenols, particularly bisphenol A and bisphenol F and their bis(hydroxyalkyl) ether derivatives, aniline, the various N—N-bis(hydroxyalkyl)anilines, primary alkyl amines and the various N—N-bis(hydroxyalkyl)amines; trihydric initiators such as glycerine, trimethylolpropane, trimethylolethane, the various alkanolamines such as ethanolamine, diethanolamine, triethanolamine, propanolamine, dipropanolamine, and tripropanolamine; tetrahydric initiators such as pentaerythritol, ethylene diamine, N,N, N′,N′-tetrakis[2-hydroxyalkyl]ethylenediamines, toulene diamine and N,N,N′,N′-tetrakis[hydroxyalkyl]toluene diamines; pentahydric initiators such as the various alkylglucosides, particularly α-methylglucoside; hexahydric initiators such as sorbitol, mannitol, hydroxyethylglucoside, and hydroxypropyl glucoside; octahydric initiators such as sucrose; and higher functionality initiators such as various starch and partially hydrolyzed starch-based products, and methylol group-containing resins and novolak resins such as those prepared from the reaction of as aldehyde, such as formaldehyde, with a phenol, cresol, or other aromatic hydroxyl-containing compound.

Such starters or initiators are typically copolymerized with one or more alkylene oxides to form polyether polyols. Examples of such alkylene oxides include ethylene oxide, propylene oxide, butylenes oxide, styrene oxide and mixtures thereof. Mixtures of these alkylene oxides can be added simultaneously or sequentially to provide internal blocks, terminal blocks or random distribution of the alkylene oxide groups in the polyether polyol. A suitable mixture comprises ethylene oxide and propylene oxide, provided the total amount of copolymerized oxyethylene in the resultant polyether polyol is less than 85% by weight.

The most common process for polymerizing such polyols is the base catalyzed addition of the oxide monomers to the active hydrogen groups of the polyhydric initiator and subsequently to the oligomeric polyol moities. Potassium hydroxide or sodium hydroxide are the most common basic catalyst used. Polyols produced by this process can contain significant quantities of unsaturated monols resulting from the isomerization of oxypropylene monomer to allyl alcohol under the conditions of the reaction. This monofunctional alcohol can then function as an active hydrogen site for further oxide addition.

One class of suitable polyoxyalkylene polyols are the low unsaturation (low monol) poly(oxypropylene/oxyethylene) polyols manufactured with double metal cyanide catalyst. The poly(oxypropylene/oxyethylene) low unsaturation polyols are prepared by oxyalkylating a suitably hydric initiator compound with propylene oxide and ethylene oxide in the presence of a double metal cyanide catalyst. The amount of ethylene oxide in the ethylene oxide/propylene oxide mixture may be increased during the latter stages of the polymerization to increase the primary hydroxyl content of the polyol. Alternatively, the low unsaturation polyol may be capped with ethylene oxide using non-DMC catalysts.

When the oxyalkylation is performed in the presence of double metal cyanide catalysts, it may be desirable that initiator molecules containing strongly basic groups such as primary and secondary amines be avoided. Further, when employing double metal cyanide complex catalysts, it is generally desirable to oxyalkylate an oligomer which comprises a previously oxyalkylated “monomeric” initiator molecule.

Polyol polymer dispersions represent another suitable class of polyoxyalkylene polyol compositions. Polyol polymer dispersions are dispersions of polymer solids in a polyol. Polyol polymer dispersions which are useful in the production of polyurethane foams include the “PHD” and “PIPA” polymer modified polyols as well as the “SAN” polymer polyols. Any “base polyol” known in the art can be suitable for production of polymer polyol dispersions, such as the poly(oxyalkylene) polyols described previously herein.

SAN polymer polyols are typically prepared by the in-situ polymerization of one or more vinyl monomers, such as acrylonitrile and styrene, in a polyol, such as a poly(oxyalkylene) polyol, having a minor amount of natural or induced unsaturation.

SAN polymer polyols typically have a polymer solids content within the range of from 3 to 60 wt. %, such as from 5 to 55 wt. %, based on the total weight of the SAN polymer polyol. As mentioned above, SAN polymer polyols are typically prepared by the in situ polymerization of a mixture of acrylonitrile and styrene in a polyol. When used, the ratio of styrene to acrylonitrile polymerized in-situ in the polyol is typically in the range of from about 100:0 to about 0:100 parts by weight, based on the total weight of the styrene/acrylonitrile mixture, such as from 80:20 to 0:100 parts by weight.

PHD polymer modified polyols are typically prepared by the in-situ polymerization of an isocyanate mixture with a diamine and/or hydrazine in a polyol, such as a polyether polyol. PIPA polymer modified polyols are typically prepared by the in situ polymerization of an isocyanate mixture with a glycol and/or glycol amine in a polyol.

PHD and PIPA polymer modified polyols typically have a polymer solids content within the range of from 3 to 30 wt. %, such as from 5 to 25 wt. %, based on the total weight of the PHD or PIPA polymer modified polyol. As mentioned above, PHD and PIPA polymer modified polyols are typically prepared by the in-situ polymerization of an isocyanate mixture, typically, a mixture which is composed of about 80 parts by weight, based on the total weight of the isocyanate mixture, of 2,4-toluene diisocyanate and about 20 parts by weight, based on the total weight of the isocyanate mixture, of 2,6-toluene diisocyanate, in a polyol, such as a poly(oxyalkylene) polyol.

By the term “polyoxyalkylene polyol or polyoxyalkylene polyol blend” is meant the total of all polyoxyalkylene polyether polyols, whether polyoxyalkylene polyether polyols containing no polymer dispersion or whether the base polyol(s) of one or more polymer dispersions.

It should also be appreciated that blends or mixtures of various useful polyoxyalkylene polyether polyols may be used if desired. It is possible that one of the polyether polyols has a functionality, OH number, etc. outside of the ranges identified above. In addition, the isocyanate-reactive component may comprise one or more polyoxyalkylene monols formed by addition of multiple equivalents of epoxide to low molecular weight monofunctional starters such as, for example, methanol, ethanol, phenols, allyl alcohol, longer chain alcohols, etc., and mixtures thereof. Suitable epoxides can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes, and many more. Suitable monofunctional starters can also be made, for example, by first producing a diol or triol and then converting all but one of the remaining hydroxyl groups to an ether, ester or other non-reactive group.

Suitable blowing agents to be used as component (3) include, for example, halogenated hydrocarbons, water, liquid carbon dioxide, low boiling solvents such as, for example, pentane, and other known blowing agents. Water may be used alone or in conjunction with other blowing agents such as, for example, pentane, acetone, cyclopentanone, cyclohexane, partially or completely fluorinated hydrocarbons, methylene chloride and liquid carbon dioxide. In some cases water is used as the sole blowing agent or water used in conjunction with liquid carbon dioxide. Generally, speaking, the quantity of blowing agent present is from 0.3 to 30 parts, such as from 0.5 to 20 parts by weight, based on 100 parts by weight of component (2) present in the formulation.

Suitable catalysts for component (4), include, for example, the various polyurethane catalysts which are known to be capable of promoting the reaction between the aromatic polyisocyanate component and the isocyanate-reactive components, including water. Examples of such catalysts include, but are not limited to, tertiary amines and metal compounds as are known and described in the art. Some examples of suitable tertiary amine catalysts include triethylamine, triethylenediamine, tributylamine, N-methylmorpholine, N-ethyl-morpholine, N,N,N′,N′-tetra-methylethylene diamine, pentamethyl-diethylene triamine, and higher homologs, 1,4-diazabicyclo[2.2.2]octane, N-methyl-N′(dimethylaminoethyl) piperazine, bis(dimethylaminoalkyl)-piperazines, N,N-dimethylbenzylamine, N,N-dimethylcyclohexylamine, N,N-diethylbenzylamine, bis(N,N-diethyl-aminoethyl) adipate, N,N,N′,N′-tetramethyl-1,3-butanediamine, N,N-dimethyl-β-phenylethylamine, 1,2-dimethylimidazole, 2-methylimidazole, monocyclic and bicyclic amidines, bis(dialkylamino)alkyl ethers (such as bis(N,N-dimethylaminoethyl) ether), and tertiary amines containing amide groups (such as formamide groups). The catalysts used may also be the known Mannich bases of secondary amines (such as dimethylamine) and aldehydes (such as formaldehyde) or ketones (such as acetone) and phenols.

Suitable catalysts also include certain tertiary amines containing isocyanate reactive hydrogen atoms. Examples of such catalysts include triethanolamine, triisopropanoamine, N-methyldiethanolamine, N-ethyl-diethanolamine, N,N-dimethylethanolamine, their reaction products with alkylene oxides (such as propylene oxide and/or ethylene oxide) and secondary-tertiary amines.

Other suitable catalysts include acid blocked amines (i.e. delayed action catalysts). The blocking agent can be an organic carboxylic acid having 1 to 20 carbon atoms, such as 1-2 carbon atoms. Examples of blocking agents include 2-ethyl-hexanoic acid and formic acid. Any stoichiometric ratio can be employed, such as one acid equivalent blocking one amine group equivalent. The tertiary amine salt of the organic carboxylic acid can be formed in situ, or it can be added to the polyol composition ingredients as a salt, such as a quaternary ammonium salt. Additional examples of suitable organic acid blocked amine gel catalysts which may be employed are the acid blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2-dimethyl imidazole, dimethyl cyclohexylamine. Further examples include DABCO® 8154 catalyst based on 1,4-diazabicyclo[2.2.2]octane and DABCO® BL-17 catalyst based on bis(N,N-dimethylaminoethyl) ether (available from Air Products and Chemicals, Inc., Allentown, Pa.) and POLYCAT® SA-1, POLYCAT® SA-102, and POLYCAT® SA-610/50 catalysts based on POLYCAT® DBU amine catalyst (available from Air Products and Chemicals, Inc.) as are known.

Other suitable catalysts include organic metal compounds, especially organic tin, bismuth, and zinc compounds. Suitable organic tin compounds include those containing sulfur, such as dioctyl tin mercaptide, and, such as tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates. Suitable zinc compounds include zinc neodecanoate and zinc versalate. Mixed metal salts containing more than one metal (such as carboxylic acid salts containing both zinc and bismuth) are also suitable catalysts.

The quantity of catalyst varies widely depending on the specific catalyst used. Generally speaking, suitable levels of catalyst would be readily determined by those skilled in the art of polyurethane chemistry.

Suitable surfactants to be used as component (5) include silicone surfactants such as, for example, polysiloxanes and siloxane/poly(alkylene oxide) copolymers of various structures and molecular weights. The structure of these compounds is generally such that a copolymer of ethylene oxide and propylene oxide is attached to a polydimethyl siloxane radical. In some cases, such surfactants are used in amounts of from 0.05 to 5% by weight, such as 0.2 to 3% by weight, based on the weight of component (2) present in the formulation.

In addition, other additives which may be used include, for example, release agents, pigments, cell regulators, flame retarding agents, foam modifiers, plasticizers, dyes, antistatic agents, antimicrobials, cross-linking agents, antioxidants, UV stabilizers, mineral oils, fillers (such as calcium carbonate and barium sulfate) and reinforcing agents such as glass in the form of fibers or flakes or carbon fibers.

### Alternative Plot Geometries

In various aspects, a plot defining a geometric shape may include a closed shape defining n-sided polygons such as pentagons, hexagons, heptagons, octagons, and so forth. In other aspects, the plot may define a geometric shape including a closed shape defining an ellipse or a circle. In other aspects, the shape may define either a two-dimensional space or a two-dimensional perspective projection of a three-dimensional shape.

The plot defines a geometric shape including a plurality of points arranged in a matrix. Each of the points defines a value for the at least two variables and a predicted value of a property of the material. The at least two variables may be independent variables (selection of elements that can be controlled) and/or dependent variables (elements that are plotted in the heat maps to be predicted).

Each of the points of the n-sided polygon defines a value for the n-variables, where each of the n-variables is a value for an amount of a component in a composition. In a constrained case, the amounts may be expressed as a percentage and a sum of the amounts is 100%. In one aspect, the composition may be specified with constrained independent variables and properties, such as thickness and cure time, may be specified as unconstrained independent variables. For clarity, the term constrained is used to indicate the interdependence of independent variables. The unconstrained independent variables also may have limits (e.g., thickness between 0.001″ and 0.003″ or cure temperature from 100° C. to 150° C., etc.). Table 3 tabulates the number of in dependent variables for the constrained case and Table 4 tabulates the number of independent variables for the unconstrained case.

TABLE 3
Constrained Independent Variables

| Number of | |
|---|---|
| Independent | |
| Variables | GUI Element(s) Needed |
| 1 | Constant 100% - out of scope |
| 2 | Split Slider 0-100% |
| 3 | 2D ternary triangle |
| | Or two sliders |
| 4 | 2D ternary triangle and 1 slider |
| | Or a 3D tetrahedron |
| | Or 3 sliders |
| 5 | 3D tetrahedron and 1 slider |
| | 2D ternary triangle and 2 sliders |

TABLE 4
Unconstrained Independent Variables

| Number of | |
|---|---|
| Independent | |
| Variables | GUI Element(s) Needed |
| 1 | Nothing, just making xy graphs |
| | with one x - out of scope |
| 2 | 2D heatmap |
| 3 | 2D heatmap and 1 slider |
| | Or a 3D cube |
| 4+ | 2D heatmap and (4+)-n sliders |
| | (our example) |

Accordingly, the present disclosure is not limited to generating heat maps of independent variables axes only and is not limited to only triangles or squares. For example, a ternary map may be generated where the composition may be varied by dragging the pointer over the heat map. In addition to ternary maps, a square map may be generated that maps all unique pairs of dependent variables. The mapping pointer could also be shown on the square maps as the pointer is dragged over the heat map and may appear in different relative x/y places as opposed to the square map example disclosed herein.

Furthermore, not all spaces on a heat map may be accessible by moving the composition pointer in the ternary plot(s). What may be mapped (e.g., red and green only) are possible dependent variable binary combinations attainable in the independent variable space of a ternary triangle. This scenario can be done with square map of dependent variables as well.

Furthermore, in one aspect, the closed shape defines a two-dimensional perspective projection of a three-dimensional (3D) shape. The 3D output may be accessed with virtual reality hardware. In one aspect, the 3D output may resemble a cube-like 3D shape made of individual smaller cubes (e.g., a Rubik's cube-like configuration) with a matrix of heat maps (either triangle maps or square maps) on each face of the smaller cube being a different set of independent variables levels. In another aspect, the 3D output may resemble a pyramid-like 3D shape made of individual smaller pyramids (e.g., a pyramid-like pyramid-like configuration) with a matrix of heat maps (either triangle maps or square maps) on each face of the smaller pyramid being a different set of independent variables levels.

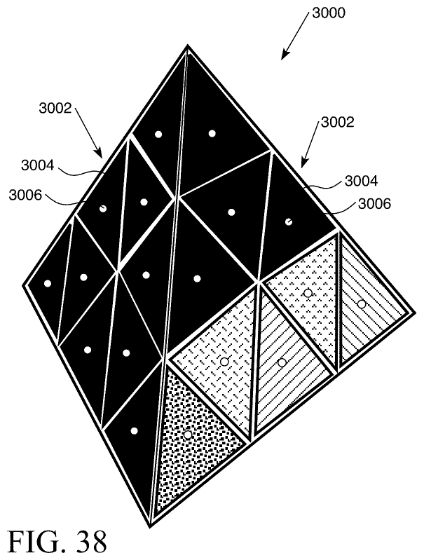

FIG. 38 is a graphical depiction of a two-dimensional perspective projection of a three-dimensional pyramid-like map 3000 according to one aspect of this disclosure. In one aspect, the pyramid-like map 3000 defines a closed shape in the form of a large pyramid made of individual smaller pyramids with a heat map 3004 defined on each face of the smaller pyramids to define a matrix of heat maps 3004. The pyramid-like map 3000 includes a plurality of ternary plots 3002 arranged in a three-dimensional projection. The ternary plots 3002 are similar in function to the ternary plots 210, 220, 230, 240, 250, 260 described in connection with the ternary map GUI 209 (FIG. 5), the ternary plot 300 described in connection with FIGS. 6 and 9, the ternary plot 500 described in connection with FIG. 11, the ternary plots 610, 620, 630, 640, 650, 660 described in connection with the ternary map GUI 600 (FIGS. 13-15). Each of the ternary plots 3002 includes a color heat map 3004 similar to the color heat maps 216, 226, 236, 246, 256, 266 described in connection with FIG. 5, the ternary heat map 326 described in connection with FIGS. 6 and 9, the ternary heat map 526 described in connection with FIG. 11, the ternary heat maps 616, 626, 636, 646, 656, 666 described in connection with FIGS. 13-15. A pointer 3006 is positioned over each of the heat maps 3004 and functions in a similar way as the pointers 212, 222, 232, 242, 252, 262 described in connection with FIG. 2, the pointer 302 described in connection with FIGS. 6 and 9, the pointer 502 described in connection with FIG. 11, the pointers 612, 622, 632, 642, 652, 662 described in connection with FIGS. 13-15. In one aspect, each face of the pyramid-like map 3000 may include an individual heat map for a total of four heat maps for a pyramid with a triangular base or five maps for a pyramid with a square base. As shown, the pyramid-like map 3000 includes nine individual heat maps on each face for a total of 36 heat maps for a pyramid with a triangular base or 45 for a pyramid with a square base. Additional or fewer heat maps may be illustrated on each face without departing from the scope of this disclosure.

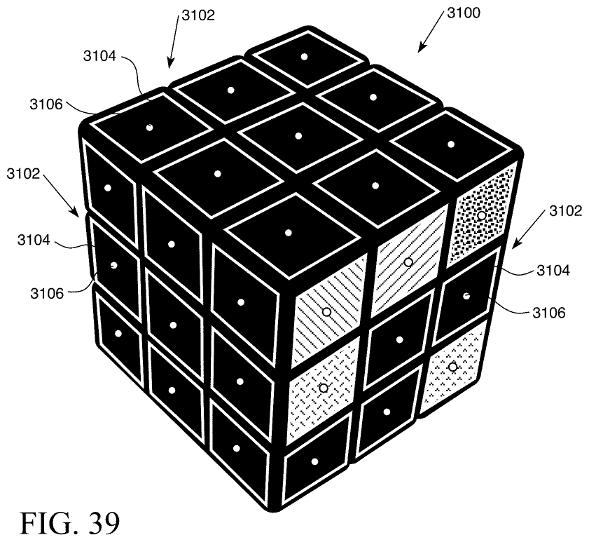

FIG. 39 is a graphical depiction of a two-dimensional perspective projection of a three-dimensional cube-like map 3100 made of individual smaller cubes according to one aspect of this disclosure. In one aspect, the cube-like map 3100 defines a closed shape in the form of a large cube made of individual smaller cubes with a heat map 3104 defined on each face of the smaller cubes to define a matrix of heat maps 3104. The cube-like map 3100 includes a plurality of square plots 3102 arranged in a three-dimensional projection. The square plots 3102 are similar in function to the square plots 1020-1031 described in connection with FIGS. 19, 21, 27, 29, 31-35. Each of the square plots 3102 includes a color heat map 3104 similar to the color heat maps 1068-1079. A pointer 3106 is positioned over each of the heat maps 3104 and functions in a similar way as the pointers 1056-1067 described in connection with FIGS. 19, 21, 27, 29, 31-35. In one aspect, each face of the cube-like map 3100 may include an individual heat map for a total of six heat maps. As shown, the cube-like map 3100 includes nine individual heat maps on each face for a total of 54 heat maps. Additional or fewer heat maps may be illustrated on each face without departing from the scope of this disclosure.

FIG. 40 illustrates an example computing environment 1700 wherein one or more of the provisions set forth herein may be implemented. FIG. 40 illustrates an example of a system 1700 comprising a computing device 1712 configured to implement one or more aspects provided herein. In one configuration, the computing device 1712 includes at least one processing unit 1716 and a memory 1718. Depending on the exact configuration and type of computing device, the memory 1718 may be volatile (such as RAM, for example), non-volatile (such as ROM, flash memory, etc., for example) or some combination of the two. This configuration is illustrated in FIG. 40 by a dashed line 1714.

In other aspects, the computing device 1712 may include additional features and/or functionality. For example, the computing device 1712 also may include additional storage (e.g., removable and/or non-removable) including, but not limited to, magnetic storage, optical storage, and the like. Such additional storage is illustrated in FIG. 40 by a storage 1720. In one aspect, computer readable instructions to implement one or more aspects provided herein may be stored in the storage 1720. The storage 1720 also may store other computer readable instructions to implement an operating system, an application program, and the like. Computer readable instructions may be loaded in the memory 1718 for execution by the processing unit 1716, for example.

The term “computer readable media” as used herein includes computer storage media. Computer storage media includes volatile and nonvolatile, removable and non-removable media implemented in any method or technology for storage of information such as computer readable instructions or other data. The memory 1718 and the storage 1720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by the computing device 1712. Computer storage media does not, however, include propagated signals. Rather, computer storage media excludes propagated signals. Any such computer storage media may be part of the computing device 1712.

The computing device 1712 also may include one or more communication connection(s) 1726 that allows the computing device 1712 to communicate with other devices such as the computing device 1730. The communication connection(s) 1726 may include, but is not limited to, a modem, a Network Interface Card (NIC), an integrated network interface, a radio frequency transmitter/receiver, an infrared port, a USB connection, or other interfaces for connecting the computing device 1712 to other computing devices. The communication connection(s) 1726 may include a wired connection or a wireless connection. The communication connection(s) 1726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

The computing device 1712 may include one or more input device(s) 1724 such as keyboard, mouse, pen, voice input device, touch input device, infrared cameras, video input devices, and/or any other input device. Output input device(s) 1722 such as one or more displays, speakers, printers, and/or any other output device may also be included in the computing device 1712. The one or more input device(s) 1724 and one or more output device(s) 1722 may be connected to the computing device 1712 via a wired connection, wireless connection, or any combination thereof. In one aspect, an input device or an output device from another computing device may be used as the input device(s) 1724 or the output device(s) 1722 for the computing device 1712.

Components of the computing device 1712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1712 may be interconnected by a network. For example, the memory 1718 may be comprised of multiple physical memory units located in different physical locations interconnected by a network.

Storage devices utilized to store computer readable instructions may be distributed across a network. For example, a computing device 1730 accessible via a network 1728 may store computer readable instructions to implement one or more aspects provided herein. The computing device 1712 may access the computing device 1730 and download a part or all of the computer readable instructions for execution. Alternatively, computing device 1712 may download pieces of the computer readable instructions, as needed, or some instructions may be executed at the computing device 1712 and some at the computing device 1730. The computing device 1730 may be coupled to a stored data table 1732. The contents of the data table 1732 can be accessed by both computing devices 1712, 1730. In one aspect, the data table 1732 stores the formulation data set that is used to generate the ternary plots and the square plots described herein. The data table 1732 may be employed to store the data tables described herein.

The computing device 1730 may include all or some of the components of the computing device 1712. For example, in one aspect the computing device 1730 includes at least one processing unit and a memory, e.g., a volatile memory (such as RAM, for example), a non-volatile memory (such as ROM, flash memory, etc., for example) or some combination of the two. In other aspects, the computing device 1730 may include additional storage (e.g., removable and/or non-removable) including, but not limited to, magnetic storage, optical storage, and the like. In one aspect, computer readable instructions to implement one or more aspects provided herein may be stored in the storage. The storage also may store other computer readable instructions to implement an operating system, an application program, and the like. Computer readable instructions may be loaded in the memory for execution by the processing unit, for example.

The computing device 1730 also may include one or more communication connection(s) that allows the computing device 1730 to communicate with other devices such as the computing device 1712. The communication connection(s) may include, but is not limited to, a modem, a Network Interface Card (NIC), an integrated network interface, a radio frequency transmitter/receiver, an infrared port, a USB connection, or other interfaces for connecting the computing device 1730 to other computing devices. The communication connection(s) may include a wired connection or a wireless connection. The communication connection(s) may transmit and/or receive communication media.

The computing device 1730 may include one or more input device(s) such as keyboard, mouse, pen, voice input device, touch input device, infrared cameras, video input devices, and/or any other input device. Output input device(s) such as one or more displays, speakers, printers, and/or any other output device may also be included in the computing device 1730. The one or more input device(s) and one or more output device(s) may be connected to the computing device via a wired connection, wireless connection, or any combination thereof. In one aspect, an input device or an output device from another computing device may be used as the input device(s) or the output device(s) for the computing device 1730.

Components of the computing device 1730 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1730 may be interconnected by a network. For example, the memory may be comprised of multiple physical memory units located in different physical locations interconnected by a network.

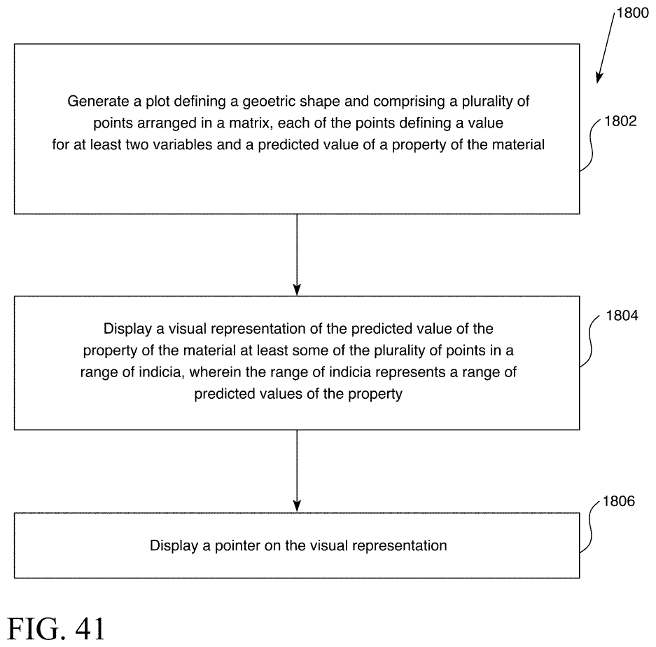

FIG. 41 is a logic flow diagram of a logic configuration or process 1800 of a method of producing a graphical depiction of a predicted value of a property of a material according to one aspect of this disclosure. The process 1800 may be executed in the computing environment 1700 described in connection with FIG. 40 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset. As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 1800, the processing unit 1716 generates 1802 a plot defining a geometric shape and comprising a plurality of points arranged in a matrix, each of the points defining a value for at least two variables and a predicted value of a property of the material. At least one of the at least two variables may be an independent variable and the other variables may be dependent variables. In one aspect, the processing unit 1716 may be configured to generate a predicted value of a property of a material that includes, without limitation, a foam, a coating, an adhesive, a sealant, an elastomer, a sheet, a film, a binder, or any organic polymer. In one aspect, the processing unit 1716 may be configured to generate a model for generating the plot. In one aspect, the processing unit 1716 generates the model based on design of experiments, regression analysis of a data set, an equation, machine learning, or artificial intelligence, and/or any combination thereof.

In one aspect, the processing unit 1716 may be configured to generate a geometric shape in the form of a closed shape in Euclidian space, either in a two-dimensional space or a two-dimensional perspective projection of a three-dimensional shape. The closed shape may define a polygon such as, for example, a triangle, a four-sided polygon, among other polygons, or an ellipse, a circle, among other single sided enclosed shapes. The triangle and each of the points may, for example, define a value for three variables, where each variable is a value for an amount of a component in a composition. The amounts may be expressed as a percentage and a sum of the amounts is 100%. The four-sided polygon and each of the points may, for example, define a value for two variables, where each variable is a value for an amount of a component in a composition, a processing condition, or a value representing an amount of two components of the composition relative to each other.

According to the process 1800, the processing unit 1716 displays 1804, on the output device 1722, a visual representation of the predicted value of the property of the material at each of the plurality of points in a range of indicia, wherein the range of indicia represents a range of predicted values of the property. In various aspects, the visual representation may be a heat map, a color heat map, or a contour map, and/or combinations thereof.

The processing unit 1716 may be configured to display, on the output device 1722, the value of the indicia and property of the material based on a position of a cursor on the visual representation. The processing unit 1716 further may be configured to dynamically update the location of the pointer and an element as the pointer is dragged over the visual representation. The element may be displayed in the form of a numeric value or a descriptor of the property. The element may be displayed in the form of indicia within the range of indicia that represents the predicted value or the descriptor of the property in the visual representation.

According to the process 1800, the processing unit 1716 displays 1806, on the output device 1722, a pointer on the visual representation. In one aspect, the processing unit 1716 may be configured to update a table with current values of the at least two variables and the predicted value of the property based on the location of the pointer on the visual representation. In one aspect, the processing unit 1716 may be configured to generate a set of instructions for producing a product that exhibits the predicted value of the property of the material at one of the plurality of points in the range of indicia.

In one aspect, the processing unit 1716 may be configured to formulate a composition based on the visual representation of the predicted value of the property of the material for at least some of the plurality of points in the range of indicia. In one aspect, the composition may be formulated based on a plurality of properties for at least some of the plurality of points in the range of indicia. In one aspect, the processing unit 1716 may be configured to optimize one or more than one property of the material within one or more than one defined range of indicia. The processing unit 1716 may be configured to display on the output device a gridded region to represent one or more than one optimized region based on the one or more than one defined range of indicia.

In one aspect, the processing unit 1716 may be configured to generate a plurality of plots each defining a geometric shape and each comprising a plurality of points arranged in a matrix, each of the points defining a value for at least two variables and a predicted value of the property of the material for each of the plurality of plots and to display, on the output device 1722, a visual representation of the predicted value of the property of the material for at least some of the plurality of points in a range of indicia, where the range of indicia represents a range of predicted values of the property and to display, on the output device 1722, a pointer on each of the plurality of plots.

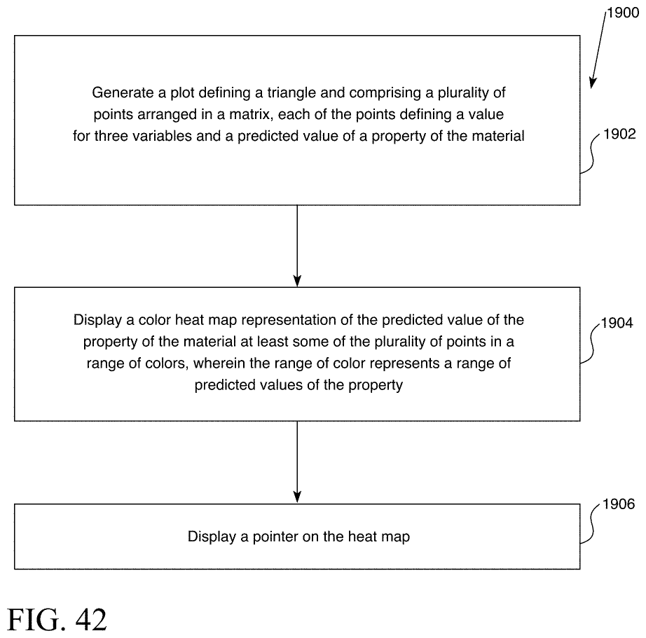

FIG. 42 is a logic flow diagram of a logic configuration or process 1900 of a method of producing a graphical depiction of a predicted value of a property of a material according to one aspect of this disclosure. The process 1900 may be executed in the computing environment 1700 described in connection with FIG. 40 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset.

As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 1900, the processing unit 1716 generates 1902 a plot defining a triangle and comprising a plurality of points arranged in a matrix, each of the points defining a value for three variables and a predicted value of a property of the material. (See FIGS. 1-5, 6, 9, 11, 13-15, 18, 19, 21, 27, 29, 31-35 and 38.) At least one of the three variables is an independent variable and the other variables are dependent variables. Each of the points of the triangle defines a value for the three variables, where each of the three variables is a value representing a relative amount of components in a composition to each other. The amounts may be expressed as a percentage and a sum of the amounts is 100%. In one aspect, the processing unit 1716 is configured to generate a predicted value of a property of a material, where the material is, without limitation, a coating, an adhesive, a sealant, an elastomer, a sheet, a film, a binder, or any organic polymer. In one aspect, the processing unit 1716 is configured to generate a model for generating the plot. The model may be generated based on design of experiments, regression analysis of a data set, an equation, machine learning, or artificial intelligence, and/or any combination thereof.

Examples of a plot defining a triangle include the ternary plots 210, 220, 230, 240, 250, 260 described in connection with the ternary map GUI 209 (FIG. 5), the ternary plot 300 described in connection with FIGS. 6 and 9, the ternary plot 500 described in connection with FIG. 11, the ternary plots 610, 620, 630, 640, 650, 660 described in connection with the ternary map GUI 600 (FIGS. 13-15), and/or the ternary plots 3002 described in connection with FIG. 38. The ternary plots 210, 220, 230, 240, 250, 260, 500, 610, 620, 630, 640, 650, 660, 3002 represent variables defining a material comprising a combination of components such as, for example, resins PUD A, PUD B, PUD C as described herein in connection with FIGS. 5, 6, 9, 11, 13-15, 18 and 38.

According to the process 1900, the processing unit 1716 displays 1904, on the output device 1722, a color heat map representation of the predicted value of the property of the material for at least some of the plurality of points in a range of colors, wherein the range of colors represents a range of predicted values of the property. Examples of color heat maps include the ternary heat maps 216, 226, 236, 246, 256, 266 described in connection with FIG. 5, the ternary heat map 326 described in connection with FIGS. 6 and 9, the ternary heat map 526 described in connection with FIG. 11, the ternary heat maps 616, 626, 636, 646, 656, 666 described in connection with FIGS. 13-15, and the ternary heat maps 3004 of the pyramid-like pyramid-like GUI 3000 described in connection with FIG. 38.

In one aspect, the processing unit 1716 is configured to display, on the output device 1722, the variables and predicted property of the material based on a position of a cursor on the heat map 216, 226, 236, 246, 256, 266, 526, 616, 626, 636, 646, 656, 666, and 3004. In one aspect, the processing unit 1716 is configured to dynamically update the location of a pointer and an element as the pointer is dragged over the heat map. The element may be displayed in the form of a numeric value or a descriptor of the property. The element may be displayed in the form of a color within the range of colors that represents the predicted value of the property in the heat map.

According to the process 1900, the processing unit 1716 displays 1906, on the output device 1722, a pointer on the heat map 216, 226, 236, 246, 256, 266, 526, 616, 626, 636, 646, 656, 666, and 3004. An example of a pointer includes the pointers 212, 222, 232, 242, 252, 262 described in connection with FIG. 2, the pointer 302 described in connection with FIGS. 6 and 9, the pointer 502 described in connection with FIG. 11, the pointers 612, 622, 632, 642, 652, 662 described in connection with FIGS. 13-15, and the pointer 3006 described in connection with FIG. 38. In one aspect, the processing unit 1716 may be configured to update a table with current values of the three variables and the predicted value of the property based on a location of the pointer on the heat map. The processing unit 1716 may be configured to generate a set of instructions for producing a product that exhibits the predicted value of the property of the material at one of the plurality of points in the range of colors.

In one aspect, the processing unit 1716 may be configured to formulate a composition based on the color heat map representation of the predicted value of the property of the material for at least some of the plurality of points in the range of colors. The processing unit 1716 may be configured to optimize one or more than one property of the material within one or more than one defined range of colors. The processing unit 1716 may be configured to display, on the output device 1722, a gridded region that represents one or more than one optimized region based on the one or more than one defined range of colors.

In one aspect, the processing unit 1716 is configured to generate a plurality of plots each defining a triangle shape and each comprising a plurality of points arranged in a matrix, each of the points defining a value for at least two variables and a predicted value of the property of the material for each of the plurality of plots; display, on the output device 1722, a visual representation of the predicted value of the property of the material for at least some of the plurality of points in a range of colors, where the range of colors represents a range of predicted values of the property; and display a pointer on each of the plurality of plots.

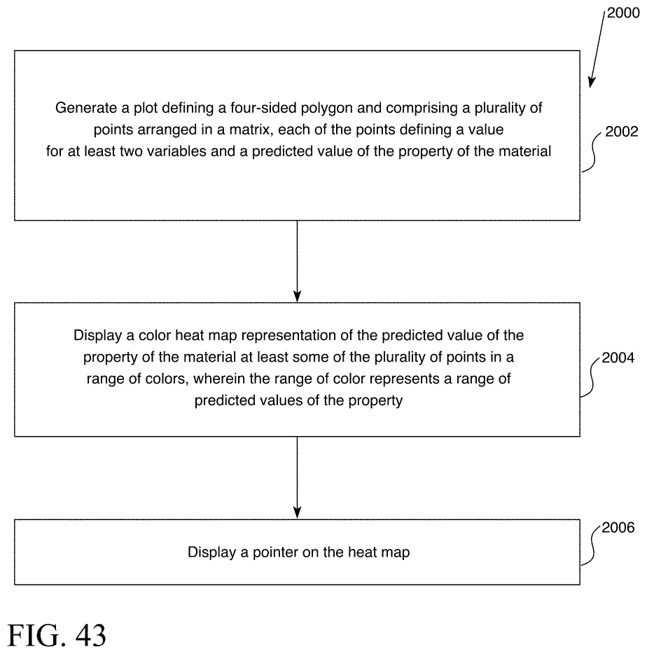

FIG. 43 is a logic flow diagram of a logic configuration or process 2000 of a method of producing a graphical depiction of a predicted value of a property of a material according to one aspect of this disclosure. The process 2000 may be executed in the computing environment 1700 described in connection with FIG. 40 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset.

As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 2000, the processing unit 1716 generates 2002 a plot defining a four-sided polygon and comprising a plurality of points arranged in a matrix, each of the points defining a value for at least two variables and a predicted value of the property of the material. (See FIGS. 19, 21, 27, 29, 31-35, and 39.) At least one of the two variables is an independent variable and the other variable is a dependent variable. At least two variables is a value for an amount of a component in a composition, a processing condition, or a value representing an amount of two components of the composition relative to each other. In one aspect, the processing unit 1716 is configured to generate a predicted value of a property of a material, such as a flexible polyurethane foam. In one aspect, the processing unit 1716 is configured to generate a model for generating the plot. The model may be generated based design of experiments, regression analysis of a data set, an equation, machine learning, or artificial intelligence, and/or any combination thereof.

Examples of a plot defining a four-sided polygon include the square plots 1020-1031, 3102 described in connection with FIGS. 19, 21, 27, 29, 31-35, and 39. Each axis of the four-sided polygon represents a variable, for example, water, blowing agents, solids, additives, stabilizers, silicone surfactants, flame retardants, fillers, atmospheric pressure, temperature, relative humidity, and/or mutual temperature as described in connection with FIGS. 19, 21, 27, 29, 31-35, and 39.

According to the process 2000, the processing unit 1716 displays 2004, on the output device 1722, a color heat map representation of the predicted value of the property of the material for at least some of the plurality of points in a range of colors, wherein the range of colors represents a range of predicted values of the property. Examples of color heat maps include the square plot heat maps 1068-1079, 3104 described in connection with FIGS. 19, 21, 27, 29, 31-35, and 39.

In one aspect, the processing unit 1716 is configured to display, on the output device 1722, the value of the predicted property of the material based on a position of a cursor on the heat map 1068-1079, 3104. In one aspect, the processing unit 1716 is configured to dynamically update the location of the pointer and an element as the pointer is dragged over the heat map 1068-1079, 3104. The element may be displayed in the form of numeric value or a descriptor of the property. The element may be displayed in the form of a color within the range of colors that represents the predicted value of the property in the heat map 1068-1079, 3104.

According to the process 2000, the processing unit 1716 displays 2006, on the output device 1722, a pointer on the heat map 1068-1079, 3104. An example of a pointer includes the pointers 1056-1067, 3106 described in connection with FIGS. 19, 21, 27, 29, 31-35, and 39. In one aspect, the processing unit 1716 may be configured to update a table with current values of the at least two variables and the predicted value of the property based on a location of the pointer 1056-1067, 3106 on the heat map 1068-1079, 3104. The processing unit 1716 may be configured to generate a set of instructions for producing a product that exhibits the predicted value of the property of the material at one of the plurality of points in the range of colors.

In one aspect, the processing unit 1716 may be configured to formulate a composition based on the color heat map 1068-1079, 3104 representation of the predicted value of the property of the material for at least some of the plurality of points in the range of colors. The processing unit 1761 may be configured to optimize one or more than one property of the material within one or more than one defined range of colors. The processing unit 1761 may be configured to display, on the output device 1722, a gridded region that represents one or more than one optimized region based on the one or more than one defined range of colors.

In one aspect, the processing unit 1716 is configured to generate a plurality of plots each defining a four-sided polygon shape and each comprising a plurality of points arranged in a matrix, each of the points defining a value for at least two variables and a predicted value of the property of the material for each of the plurality of plots; display, on the output device, a visual representation of the predicted value of the property of the material for at least some of the plurality of points in a range of colors, where the range of colors represents a range of predicted values of the property; and display a pointer on each of the plurality of plots.

### Optimization Modules

In some aspects, a digital formulation service is provided for generating optimized material configurations, both in types of materials and cost. A computerized system may be configured to provide a digital formulation service module that allows a user to generate a custom material configuration based on a specified constraint, such as cost or performance. The digital formulation service may provide a recommended material configuration that satisfies the specified constraint. The digital formulation service module may be an augmented or supplemental service with the other user interfaces described herein, such as those described in FIGS. 1-43. For example, the digital formulation service may be configured to transmit a custom formulation to one or more entities that facilitate supplying the materials and sending the materials to the customer. Examples of these models for completing the customer order will be described more, below.

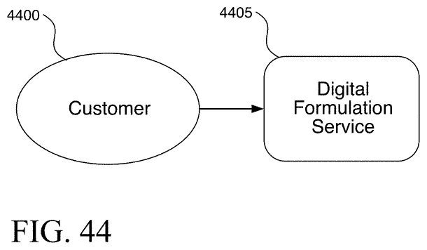

FIG. 44 shows a basic block diagram of a user or customer 4400 interfacing with the digital formulation service 4405, which may be manifested in a computerized module. In this context, the digital formulation service 4405 may provide custom material configurations in a wide variety of ways. In some aspects, the digital formulation service 4405 is configured to generate a material configuration by optimizing based on cost of the ingredients to make the material. For example, to generate a custom coating, the customer 4400 may specify to the digital formulation service module 4405 to provide a recommended coating recipe that gives the best performance at a specified cost, or in other cases, at the lowest cost. In some aspects, the digital formulation service module 4405 may provide the recommended recipe at the specified cost using default ingredients, since no other constraints may be specified.

In some aspects, the digital formulation service module 4405 may be configured to generate a material configuration, such as a custom coating, by optimizing coating formulation based on performance. In this example, the user or customer 4400 may specify one or more criteria that one or more of the particular qualities of a coating must satisfy. For example, the user may specify that the custom coating must possess at least a minimum amount of smoothness, or must resist DEET at a particular minimum level. The digital formulation service module 4405 is then configured to analyze all known recipes, in some cases using just default ingredients that satisfy the performance constraint(s). The module 4405 then may provide a recommendation at the least expensive cost. The known recipes may be based on empirical research and tabulation that are stored in a database.

In some aspects, the digital formulation service module 4405 may also be configured to provide optimization configurations using substitute ingredients. For example, if a user 4400 instructs the service module 4405 to generate a custom coating by optimizing the formulation based on performance, the user 4400 may also specify to analyze all known recipes to satisfy the performance constraint using default ingredients as well as all permutations of substitute ingredients. The substitute ingredients may be based on empirical research and knowledge of physical properties that are stored in a database.

In other cases, the customer 4400 may simply supply to the digital formulation service module 4405 the specifications for performance with the full recipe and workup information for how to generate the desired custom coating. From here, the digital formulation service module 4405 may determine the most efficient or effective method for obtaining the materials. For example, the ingredients may come from one or more sources, and it may not be relevant to the customer 4400 what the sources are, so long as the proper ingredients are obtained. Alternatively, the digital formulation service 4405 may allow for the customer to specify the sources for obtaining the ingredients.

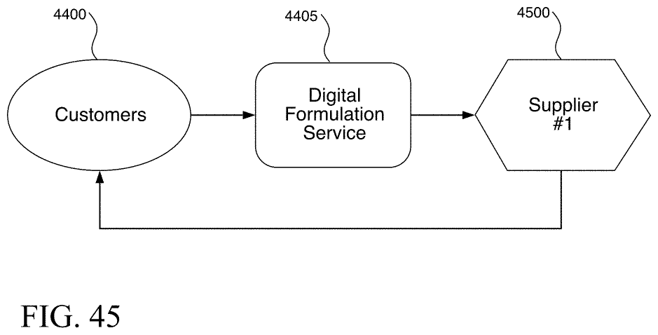

Referring to FIG. 45, shown is one model for how the digital formulation service 4405 may complete a custom order, such as a custom coating order, according to some aspects. In the case where the customer 4400 specifies the coating performance by supplying the particular desired recipe, the digital formulation service module 4405 may instruct a supplier 4500 to obtain the specific ingredients for the recipe. The digital formulation service module 4405 may be able to access current inventory information from the supplier 4500 in order to determine if the order can be immediately fulfilled or if more efforts need to be taken to obtain particular ingredients. Ultimately, to complete the order, the supplier 4500 may be sent the customer shipping information and may send the raw materials (ingredients) to the customer 4400 directly.

In another scenario, in the case where the customer 4400 may specify the performance of a coating but where the recipe information for the exact type of materials or ingredients is not specified, the digital formulation service module 4405 may complete the order by performing optimization calculations to determine the best types of materials that satisfy the performance constraints. The interfaces described in FIGS. 1-39 may be some examples of how the performance constraints may be specified and then the types of materials may be determined thereafter. The digital formulation service module 4405 may pass on a recipe based on this to the supplier 4500. The supplier 4500 may then fulfill the order and send to the customer 4400 the raw materials and/or blends to the customer 4400. The supplier 4500 may also send full coating systems to the customer 4400, based on the received recipe from the digital formulation service 4405.

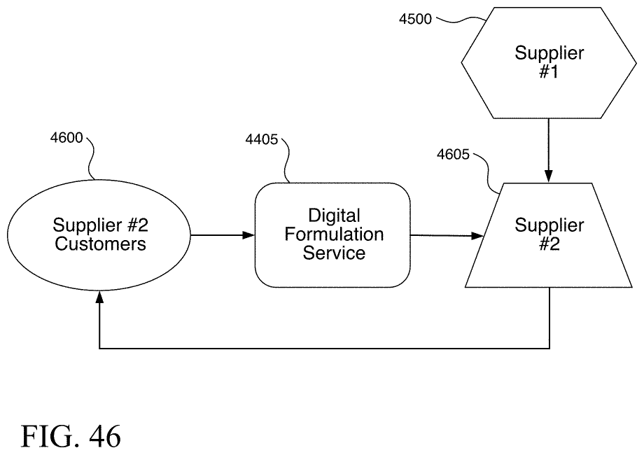

Referring to FIG. 46, shown is a second model in a variation of how the digital formulation service module 4405 may complete a custom order, such as a custom coating order, according to some aspects. In this example, customers 4600 of a second supplier may also use the digital formulation service 4405, and may expect to receive orders fulfilled by the second supplier 4605 (supplier #2), such as a system house. The digital formulation service module 4405 may be controlled and/or owned by the first supplier 4500 (supplier #1), but may be utilized by the second supplier 4605, such as through a partnership or collaboration that shares information and software capability. In addition, the first supplier 4500 may supply the raw materials to the second supplier 4605 so that the second supplier 4605 can complete the order to their customers 4600, as their customers expect. Thus, the second supplier 4605 may send the custom raw materials and/or blends to the customer 4600 directly. The second supplier 4605 may also supply full coating systems to the customer 4600. This type of model enables the digital formulation service 4405 to be utilized by other entities that do not control or own the digital formulation service, so that more customers can still have access to the digital formulation service's capabilities.

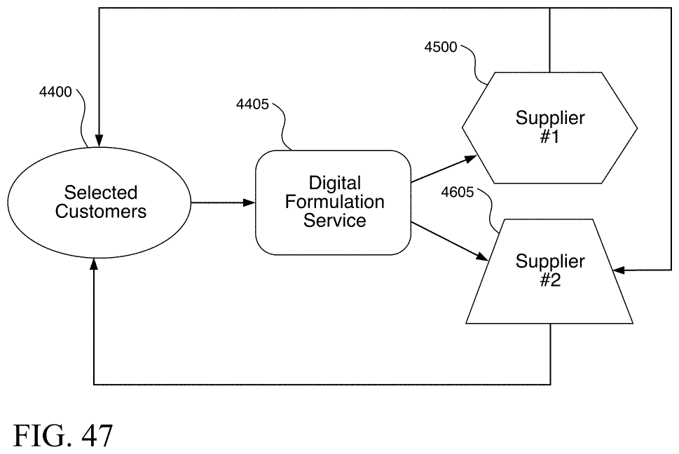

Referring to FIG. 47, shown is another model in another variation of how the digital formulation service may complete a custom order, such as a customer coating order, according to some aspects. In this example, the digital formulation service 4405 may act as a neutral or hybrid platform that can send orders to different suppliers, depending on the need. For example, the digital formulation service 4405 may send custom coating recipes for high volume orders to the first supplier 4500, while low volume orders may be sent to the second supplier 4605. This may be most efficient because the first supplier 4500 may be larger and have more capacity to handle large orders, while the second supplier 4605 may be more specialized and/or have the supplies to handle smaller or more individualized orders. In some aspects, the second supplier 4605 may still lack certain materials or ingredients to fulfill even the small orders, and the first supplier 4500 may be configured to send the missing supplies to the second supplier 4605 to complete the order. Once the orders can be fulfilled, the first supplier 4500 may send the raw materials to the customer 4400 directly, and similarly the second supplier 4605 may also send the raw materials and/or blends to the customer 4400 directly. Full coatings systems may also be supplied to the customer 4400 by the second or first suppliers 4605 and 4500.

In some aspects, in another variation of the neutral or hybrid platform, the digital formulation service 4405 may be configured to send orders to either the first or second supplier 4500 and 4605 based on a competitive bidding process undertaken by the first and second (and possibly additional) suppliers 4500 and 4605. The bidding system may be setup as an automatic bidding system, where analysts from the different suppliers may input automatic bidding rules for various types of recipes or materials. The bidding process may be resolved automatically as part of the process to complete the customer order. In other cases, the bidding process may be conducted more manually, and the digital formulation service 4405 may be configured to provide the forum to conduct this process. The winning bid may be the bid that offers to fulfill the order with the lowest cost to the customer.

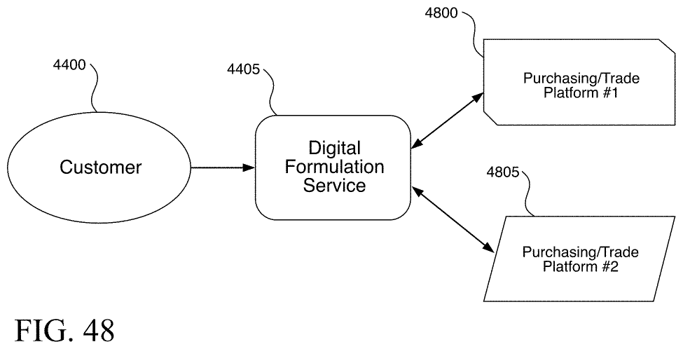

Referring to FIG. 48, in another variation, after generating a recommended material configuration that satisfies the user specified constraint(s), the digital formulation service module 4405 may be configured to interface with one or more purchasing/trade platforms that supply the ingredients needed to generate the recommended formulation, according to some aspects. The digital formulation service module 4405 may conduct a comparison of prices for the ingredients offered by the purchasing/trade platforms, such as first purchasing/trade platform 4800 and second purchasing/trade platform 4805, either individually or collectively, in order to obtain the lowest price for the customer 4400. This function may be applied to both small and large volume purchases, but the process for conducting these purchases may differ. For example, the digital formulation service module 4405 may be configured to analyze different vendors that offer large volume purchases, or may initiate negotiations with a purchase/trade platform to obtain better prices for large volume purchases. In addition, customers who specify looking for large volume purchases may be offered advanced options for finding the best prices, such as examining sales, coupons, and specialized discounts based on the customer's status or other known advantages.

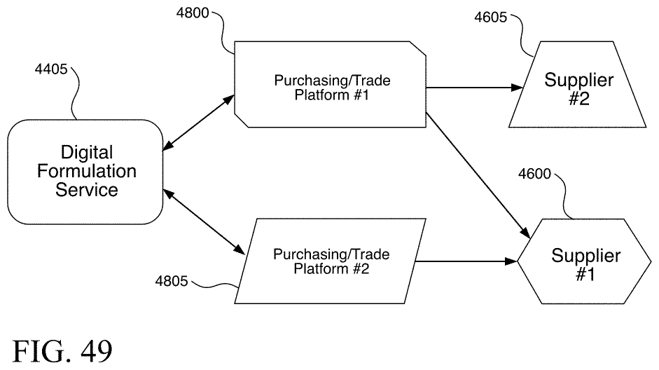

Referring to FIG. 49, in some aspects, the purchase mechanisms can be extended to include convenient and more streamlined features that can automatically connect to appropriate suppliers. After determining pricing, and depending on the purchasing/trade platform that will be used to purchase from for the desired order, one or more suppliers may be chosen from to fulfill the order, such as first supplier 4600 and second supplier 4605. In some aspects, a purchasing/trade platform 4800 may be in contact with more than one supplier, such as Supplier #1 4600 and Supplier #2 4605 as shown, in order to handle different sizes of orders or address orders that have unique types of ingredients or parts. On the other hand, a second purchasing/trade platform 4805 may be in contact with only one supplier 4600, as that single supplier may be sufficient to handle the types of orders that the purchasing/trade platform 4805 is equipped to accept. In some aspects, the digital formulation service 4405 may allow for a “touchless” order where there is a default purchasing platform and supplier used to fulfill orders by default.

Various operations of aspects are provided herein. In one aspect, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each aspect provided herein. Also, it will be understood that not all operations are necessary in some aspects.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

Various aspects of the subject matter described herein are set out in the following numbered examples:

Example 1. A method of producing a graphical depiction of a predicted value of a property of a material, the method comprising: generating, by a processing unit, a plot defining a geometric shape and comprising a plurality of points arranged in a matrix, each of the points defining a value for at least two variables and a predicted value of a property of the material; displaying, on an output device, a visual representation of the predicted value of the property of the material for at least some of the plurality of points in a range of indicia, wherein the range of indicia represents a range of predicted values of the property; and displaying, on the output device, a pointer on the visual representation.

Example 2. The method of Example 1, wherein displaying, on the output device, comprises displaying, on the output device, the visual representation of the predicted value of the property of the material at each of the plurality of points in the range of indicia.

Example 3. The method of one or more of Example 1 to Example 2, further comprising displaying, on the output device, the value of the indicia and the predicted value of the property of the material based on a position of a cursor on the visual representation.

Example 4. The method of one or more of Example 1 to Example 3, further comprising dynamically updating the location of the pointer and an element as the pointer is dragged over the visual representation.

Example 5. The method of Example 4, wherein the element comprises a numeric value or a descriptor of the property.

Example 6. The method of Example 5, wherein the element comprises indicia within the range of indicia that represents the predicted value or the descriptor of the property in the visual representation.

Example 7. The method of one or more of Example 1 to Example 6, wherein at least one of the at least two variables is an independent variable.

Example 8. The method of one or more of Example 1 to Example 7, wherein the geometric shape defines a closed shape in Euclidian space.

Example 9. The method of Example 8, wherein the closed shape defines a polygon.

Example 10. The method of Example 9, wherein the polygon is a triangle or a four-sided polygon.

Example 11. The method of Example 10, wherein the polygon is a triangle and each of the points defines a value for three variables, wherein each variable represents a value for an amount of a component in a composition.

Example 12. The method of Example 11, wherein the amounts are expressed as a percentage and a sum of the amounts is 100%.

Example 13. The method of one or more of Example 10 to Example 12, wherein the polygon is a four-sided polygon and each of the points defines a value for two variables, wherein each variable is a value representing an amount of a component in a composition, a value for a processing condition, or a value representing an amount of two components of the composition relative to each other.

Example 14. The method of one or more of Example 8 to Example 13, wherein the closed shape defines an ellipse or a circle.

Example 15. The method of one or more of Example 8 to Example 14, wherein the closed shape defines either a two-dimensional space or a two-dimensional perspective projection of a three-dimensional shape.

Example 16. The method of one or more of Example 1 to Example 15, further comprising formulating, by the processing unit, a composition based on the visual representation.

Example 17. The method of Example 16, further comprising formulating, by the processing unit, the composition based on a plurality of predicted values of a property.

Example 18. The method of one or more of Example 16 to Example 17, further comprising optimizing, by the processing unit, one or more than one predicted property of the material within one or more than one defined range of indicia.

Example 19. The method of Example 18, further comprising displaying, on the output device, a gridded region that represents one or more than one optimized region based on the one or more than one defined range of indicia.

Example 20. The method of one or more of Example 1 to Example 19, further comprising updating, by the processing unit, a table with current values of the at least two variables and the predicted value of the property based on the location of the pointer on the visual representation.

Example 21. The method of Example 20, further comprising generating, by the processing unit, a set of instructions for producing a product based on the predicted value of the property of the material at one of the plurality of points in the range of indicia.

Example 22. The method of one or more of Example 1 to Example 21, wherein the material is a foam, a coating, an adhesive, a sealant, an elastomer, a sheet, a film, a binder, or any organic polymer.

Example 23. The method of one or more of Example 1 to Example 22, further comprising: generating, by the processing unit, a plurality of plots each defining a geometric shape and each comprising a plurality of points arranged in a matrix, each of the points defining a value for at least two variables and a predicted value of the property of the material for each of the plurality of plots; displaying, on the output device, a visual representation of the predicted value of the property of the material for at least some of the plurality of points in a range of indicia, wherein the range of indicia represents a range of predicted values of the property; and displaying a pointer on each of the plurality of plots.

Example 24. The method of Example 23, further comprising generating, by the processing unit, a plot based on a model.

Example 25. The method of Example 24, wherein the model is generated based on design of experiments, regression analysis of a data set, an equation, machine learning, or artificial intelligence, and/or any combination thereof.

Example 26. The method of one or more of Example 1 to Example 25, wherein the visual representation is a heat map, a color heat map, or a contour map.

Example 27. The method of Example 16, further comprising: generating, by the processing unit, a recipe for producing the composition that satisfies a specified user constraint; and transmitting the recipe to one or more suppliers to obtain ingredients sufficient to produce the material and satisfy the specified user constraint.

Example 28. The method of Example 27, wherein transmitting the recipe to the one or more suppliers is based on determining a supplier that can obtain the ingredients at the lowest total cost.

Example 29. The method of Example 27, wherein transmitting the recipe to the one or more suppliers is based on conducting a competitive bidding process between two or more suppliers.

Example 30. The method of Example 27, wherein transmitting the recipe to the one or more suppliers is based on determining which suppliers are capable of obtaining the ingredients sufficient to fulfill the recipe.

Example 31. A method of producing a graphical depiction of a predicted value of a property of a material, the method comprising: generating, by a processing unit, a plot defining a triangle and comprising a plurality of points arranged in a matrix, each of the points defining a value for three variables and a predicted value of a property of the material; displaying, on an output device, a color heat map representation of the predicted value of the property of the material for at least some of the plurality of points in a range of colors, wherein the range of colors represents a range of predicted values of the property; and displaying, on the output device, a pointer on the heat map.

Example 32. The method of Example 31, wherein displaying, on the output device, comprises displaying, on the output device, the color heat map representation of the predicted value of the property of the material at each of the plurality of points in the range of colors.

Example 33. The method of Example 32, further comprising displaying, on the output device, the value of the variables and the predicted value of the property of the material based on a position of a cursor on the heat map.

Example 34. The method of one or more of Example 32 to Example 3, further comprising dynamically updating the location of the pointer and an element as the pointer is dragged over the heat map.

Example 35. The method of Example 34, wherein the element comprises a numeric value or a descriptor of the property.

Example 36. The method of one or more of Example 34 to Example 35, wherein the element comprises a color within the range of colors that represents the predicted value of the property in the heat map.

Example 37. The method of one or more of Example 32 to Example 36, wherein at least one of the three variables is an independent variable.

Example 38. The method of one or more of Example 32 to Example 37, wherein each of the points of the triangle defines a value for the three variables, wherein each of the three variables represents a value for an amount of a component in a composition.

Example 39. The method of Example 38, wherein the amounts are expressed as a percentage and a sum of the amounts is 100%.

Example 40. The method of one or more of Example 32 to Example 39, further comprising formulating, by the processing unit, a composition based on the color heat map representation.

Example 41. The method of Example 40, further comprising optimizing, by the processing unit, one or more than one property of the material within one or more than one defined range of colors.

Example 42. The method of Example 41, further comprising displaying, on the output device, a gridded region that represents one or more than one optimized region based on the one or more than one defined range of colors.

Example 43. The method of one or more of Example 32 to Example 42, further comprising updating, by the processing unit, a table with current values of the three variables and the predicted value of the property based on a location of the pointer on the heat map.

Example 44. The method of Example 41, further comprising generating, by the processing unit, a set of instructions for producing a product based on the predicted value of the property of the material at one of the plurality of points in the range of colors.

Example 45. The method of one or more of Example 32 to Example 44, wherein the material is a coating, an adhesive, a sealant, an elastomer, a sheet, a film, a binder, or any organic polymer.

Example 46. The method of one or more of Example 32 to Example 45, further comprising: generating, by the processing unit, a plurality of plots each defining a triangle and each comprising a plurality of points arranged in a matrix, each of the points defining a value for at least two variables and a predicted value of the property of the material for each of the plurality of plots; displaying, on the output device, a visual representation of the predicted value of the property of the material for at least some of the plurality of points in a range of colors, wherein the range of colors represents a range of predicted values of the property; and displaying a pointer on each of the plurality of plots.

Example 47. The method of one or more of Example 32 to Example 46, further comprising generating, by the processing unit, a plot based on a model.

Example 48. The method of Example 47, wherein the model is generated based design of experiments, regression analysis of a data set, an equation, machine learning, or artificial intelligence, and/or any combination thereof.

Example 49. The method of Example 40, further comprising: generating, by the processing unit, a recipe for producing the composition that satisfies a specified user constraint; and transmitting the recipe to one or more suppliers to obtain ingredients sufficient to produce the material and satisfy the specified user constraint.

Example 50. The method of Example 49, wherein transmitting the recipe to the one or more suppliers is based on determining a supplier that can obtain the ingredients at the lowest total cost.

Example 51. The method of Example 49, wherein transmitting the recipe to the one or more suppliers is based on conducting a competitive bidding process between two or more suppliers.

Example 52. The method of Example 49, wherein transmitting the recipe to the one or more suppliers is based on determining which suppliers are capable of obtaining the ingredients sufficient to fulfill the recipe.

Example 53. A method of producing a graphical depiction of a predicted value of a property of a material, the method comprising: generating, by a processing unit, a plot defining a four-sided polygon and comprising a plurality of points arranged in a matrix, each of the points defining a value for at least two variables and a predicted value of the property of the material; displaying, on an output device, a color heat map representation of the predicted value of the property of the material for at least some of the plurality of points in a range of colors, wherein the range of colors represents a range of predicted values of the property; and displaying, on the output device, a pointer on the heat map.

Example 54. The method of Example 53, wherein displaying, on the output devices, comprises displaying, on the output device, the color heat map representation of the predicted value of the property of the material at each of the plurality of points in the range of colors.

Example 55. The method of Example 54, further comprising displaying, on the output device, the predicted value of the property of the material based on a position of a cursor on the heat map.

Example 56. The method of one or more of Example 54 to Example 55, further comprising dynamically updating the location of the pointer and an element as the pointer is dragged over the heat map.

Example 57. The method of Example 56, wherein the element comprises a numeric value or a descriptor of the property.

Example 58. The method of one or more of Example 56 to Example 57, wherein the element comprises a color within the range of colors that represents the predicted value of the property in the heat map.

Example 59. The method of one or more of Example 54 to Example 58, wherein at least one of the two variables is an independent variable.

Example 60. The method of one or more of Example 54 to Example 59, wherein each of the at least two variables is a value for an amount of a component in a composition, a value for a processing condition, or a value representing an amount of two components of the composition relative to each other.

Example 61. The method of one or more of Example 54 to Example 60, further comprising formulating, by the processing unit, a composition based on the color heat map representation.

Example 62. The method of Example 61, further comprising optimizing, by the processing unit, one or more than one property of the material within one or more than one defined range of colors.

Example 63. The method of Example 62, further comprising displaying, on the output device, a gridded region that represents one or more than one optimized region based on the one or more than one defined range of colors.

Example 64. The method of one or more of Example 54 to Example 63, further comprising updating, by the processing unit, a table with current values of the at least two variables and the predicted value of the property based on a location of the pointer on the heat map.

Example 65. The method of Example 64, further comprising generating, by the processing unit, a set of instructions for producing a product based on the predicted value of the property of the material at one of the plurality of points in the range of colors.

Example 66. The method of one or more of Example 54 to Example 65, wherein the material is a polyurethane foam.

Example 67. The method of Example 54, further comprising: generating, by the processing unit, a plurality of plots each defining a four-sided polygon shape and each comprising a plurality of points arranged in a matrix, each of the points defining a value for at least two variables and a predicted value of the property of the material for each of the plurality of plots; displaying, on the output device, a visual representation of the predicted value of the property of the material for at least some of the plurality of points in a range of colors, wherein the range of colors represents a range of predicted values of the property; and displaying a pointer on each of the plurality of plots.

Example 68. The method of one or more of Example 54 to Example 67, further comprising generating, by the processing unit, a plot based on a model.

Example 69. The method of Example 68, wherein the model is generated based design of experiments, regression analysis of a data set, an equation, machine learning, or artificial intelligence, and/or any combination thereof.

Example 70. The method of Example 61, further comprising: generating, by the processing unit, a recipe for producing the composition that satisfies a specified user constraint; and transmitting the recipe to one or more suppliers to obtain ingredients sufficient to produce the material and satisfy the specified user constraint.

Example 71. The method of Example 70, wherein transmitting the recipe to the one or more suppliers is based on determining a supplier that can obtain the ingredients at the lowest total cost.

Example 72. The method of Example 70, wherein transmitting the recipe to the one or more suppliers is based on conducting a competitive bidding process between two or more suppliers.

Example 73. The method of Example 70, wherein transmitting the recipe to the one or more suppliers is based on determining which suppliers are capable of obtaining the ingredients sufficient to fulfill the recipe.

Example 74 is at least one computer readable medium comprising instructions that, when executed, implement a method as described in one or more of Example 1 to Example 30.

Example 75 is at least one computer readable medium comprising instructions that, when executed, implement a method as described in one or more of Example 31 to Example 52.

Example 76 is at least one computer readable medium comprising instructions that, when executed, implement a method as described in one or more of Example 53 to Example 72.

1. A method of producing a graphical depiction of a predicted value of a property of a material, the method comprising:
generating, by a processing unit, a plot defining a geometric shape and comprising a plurality of points arranged in a matrix, each of the points defining a value for at least two variables and a predicted value of a property of the material;
displaying, on an output device, a visual representation of the predicted value of the property of the material for at least some of the plurality of points in a range of indicia, wherein the range of indicia represents a range of predicted values of the property; and
displaying, on the output device, a pointer on the visual representation.

2. The method of claim 1, wherein displaying, on the output device, comprises displaying, on the output device, the visual representation of the predicted value of the property of the material at each of the plurality of points in the range of indicia.

3. The method of claim 1, further comprising displaying, on the output device, the value of the indicia and the predicted value of the property of the material based on a position of a cursor on the visual representation.

4. The method of claim 1, further comprising dynamically updating the location of the pointer and an element as the pointer is dragged over the visual representation.

5. The method of claim 4, wherein the element comprises a numeric value or a descriptor of the property.

6. The method of claim 5, wherein the element comprises indicia within the range of indicia that represents the predicted value or the descriptor of the property in the visual representation.

7. The method of claim 1, wherein at least one of the at least two variables is an independent variable.

8. The method of claim 1, wherein the geometric shape defines a polygon.

9. (canceled)

10. The method of claim 8, wherein the polygon is a triangle or a four-sided polygon.

11. The method of claim 10, wherein the polygon is a triangle and each of the points defines a value for three variables, wherein each variable represents a value for an amount of a component in a composition.

12. (canceled)

13. The method of claim 10, wherein the polygon is a four-sided polygon and each of the points defines a value for two variables, wherein each variable is a value representing an amount of a component in a composition, a value for a processing condition, or a value representing an amount of two components of the composition relative to each other.

14-15. (canceled)

16. The method of claim 1, further comprising formulating, by the processing unit, a composition based on the visual representation.

17. The method of claim 16, further comprising formulating, by the processing unit, the composition based on a plurality of predicted values of a property.

18. The method of claim 16, further comprising optimizing, by the processing unit, one or more than one predicted property of the material within one or more than one defined range of indicia.

19. The method of claim 18, further comprising displaying, on the output device, a gridded region that represents one or more than one optimized region based on the one or more than one defined range of indicia.

20. The method of claim 1, further comprising updating, by the processing unit, a table with current values of the at least two variables and the predicted value of the property based on the location of the pointer on the visual representation.

21. The method of claim 20, further comprising generating, by the processing unit, a set of instructions for producing a product based on the predicted value of the property of the material at one of the plurality of points in the range of indicia.

22. The method of claim 1, wherein the material is a foam, a coating, an adhesive, a sealant, an elastomer, a sheet, a film, a binder, or any organic polymer.

23. The method of claim 1, further comprising:
generating, by the processing unit, a plurality of plots each defining a geometric shape and each comprising a plurality of points arranged in a matrix, each of the points defining a value for at least two variables and a predicted value of the property of the material for each of the plurality of plots;
displaying, on the output device, a visual representation of the predicted value of the property of the material for at least some of the plurality of points in a range of indicia, wherein the range of indicia represents a range of predicted values of the property; and
displaying a pointer on each of the plurality of plots.

24. The method of claim 23, further comprising generating, by the processing unit, a plot based on a model.

25-26. (canceled)

27. The method of claim 16, further comprising:
generating, by the processing unit, a recipe for producing the composition that satisfies a specified user constraint; and
transmitting the recipe to one or more suppliers to obtain ingredients sufficient to produce the material and satisfy the specified user constraint.

28-29. (canceled)

30. The method of claim 27, wherein transmitting the recipe to the one or more suppliers is based on determining which suppliers are capable of obtaining the ingredients sufficient to fulfill the recipe.

31-73. (canceled)
